(19) United States
(12) Patent Application Publication
(10) Pub. No.: US 2007/0231741 A1
(43) Pub. Date: Oct. 4, 2007

(54) Resist composition and patterning process

(75) Inventors: Tsunehiro Nishi, Joetsu-shi (JP); Motohide Yamazaki, Joetsu-shi (JP); Junji Tsuchiya, Joetsu-shi (JP); Takeru Watanabe, Joetsu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SHIN-ETSU CHEMICAL CO., LTD., Tokyo (JP)

(21) Appl. No.: 11/730,427

(22) Filed: Apr. 2, 2007

(30) Foreign Application Priority Data
Apr. 4, 2006 (JP) 2006-103336

(51) Int. Cl. G03C 1/00

(52) U.S. Cl. 430/270.1

(57) ABSTRACT

A positive resist composition comprising a resin component having a solubility in an alkaline developer that increases under the action of an acid, a compound capable of generating an acid in response to actinic radiation, and an acidic organic compound having a molecular weight of at least 150 exhibits a high resolution and is effective in minimizing defects when processed by the photolithography. The composition is thus quite effective for precise micropatterning.

### CROSS-REFERENCE TO RELATED APPLICATION

This non-provisional application claims priority under 35 U.S.C. §119(a) on Patent Application No. 2006-103336 filed in Japan on Apr. 4, 2006, the entire contents of which are hereby incorporated by reference.

### TECHNICAL FIELD

This invention relates to a resist composition for the micropatterning technology which is effective for restraining the occurrence of defects on the substrate after development, and a patterning process using the same.

### BACKGROUND ART

In the recent drive for higher integration and operating speeds in LSI devices, it is desired to miniaturize the pattern rule. Great efforts have been devoted for the development of the micropatterning technology using deep-ultraviolet (deep-UV) or vacuum-ultraviolet (VUV) lithography. The photolithography using KrF excimer laser (wavelength 248 nm) as the light source has already established the main role in the commercial manufacture of semiconductor devices. The lithography using ArF excimer laser (wavelength 193 nm) is under investigation to enable further miniaturization and has reached the stage of prototype manufacture experiments. However, the ArF excimer laser lithography has not matured so that many problems must be overcome before the technology can be applied to an industrial scale of semiconductor manufacture.

The requisite properties for the resist materials complying with the ArF excimer laser lithography include transparency at wavelength 193 nm and dry etch resistance. Resist materials comprising as a base resin poly(meth)acrylic acid derivatives having bulky acid-labile protective groups as typified by 2-ethyl-2-adamantyl and 2-methyl-2-adamantyl groups were proposed as having both the properties (JP-A 9-73173 and JP-A 9-90637). Since then, a variety of materials have been proposed. They are common in that resins having a highly transparent backbone and a bulky partial structure are used.

Among problems associated with these materials, the most serious problem is that defects arise from the bulky hydrophobic structure. In general, a resist film undergoes decomposition reaction through exposure and heat treatment, converting to a structure which is dissolvable in an alkaline developer. If the resist material is highly hydrophobic, the resist film once becomes dissolved in an alkaline developer, but precipitates upon subsequent rinsing with non-alkaline water such as deionized water. These precipitates deposit on the substrate, becoming defects. The defects on the substrate form an etching protective coating, incurring a performance penalty to semiconductor devices.

### DISCLOSURE OF THE INVENTION

An object of the invention is to provide a resist composition which has a high resolution and minimized defects when processed by the photolithography using high-energy radiation such as ArF excimer laser light as a light source, and a patterning process using the same.

The inventor has found that a positive resist composition comprising a resin component having a solubility in an alkaline developer that increases under the action of an acid, a compound capable of generating an acid in response to actinic light or radiation, and an acidic organic compound having a molecular weight of at least 150 exhibits a high resolution and is effective in minimizing defects when processed by the photolithography. The composition is thus quite effective for precise micropatterning.

In one aspect, the invention provides a positive resist composition comprising (A) a resin component having a solubility in an alkaline developer that increases under the action of an acid, (B) a compound capable of generating an acid in response to actinic light or radiation, and (C) at least one acidic organic compound having a molecular weight of at least 150.

In a preferred embodiment, the acidic organic compound (C) has the general formula (1):

R¹—X (1)

wherein R¹ is a straight or branched monovalent organic group which is free of double bonds and atoms other than carbon, hydrogen and oxygen in its structure, and X is —SO₃H or —CO₂H. In another preferred embodiment, the acidic organic compound (C) has the general formula (2):

CH₃(A)ₙCH₂—X (2)

wherein A is a methylene group, some of the number “n” of methylene groups may be replaced by oxygen atoms, with the proviso that when some methylene groups are replaced by oxygen atoms, a structure in which two oxygen atoms adjoin is excluded, n is an integer from 3 to 100, and X is —SO₃H or —CO₂H. In a preferred embodiment, the resin component (A) comprises acidic recurring units.

In another aspect, the invention provides a process for forming a pattern, comprising the steps of applying the positive resist composition defined above onto a substrate to form a resist coating; heat treating the resist coating and exposing it to high-energy radiation or electron beam through a photomask; and heat treating the exposed resist coating and developing it with a developer. In one embodiment, the exposing step is effected by the immersion lithography wherein a high refractive index liquid having a refractive index of at least 1.0 intervenes between the resist coating and a projection lens. In another embodiment, the process further comprises the step of coating a protective film on the resist coating, and the exposing step is effected by the immersion lithography wherein a high refractive index liquid having a refractive index of at least 1.0 intervenes between the protective film and a projection lens.

### BENEFITS OF THE INVENTION

When processed by the micropatterning process, the resist composition of the invention exhibits a high resolution and is successful in minimizing defects. The composition is thus quite effective for precise micropatterning, especially by the ArF lithography.

### PREFERRED EMBODIMENTS OF THE INVENTION

The singular forms “a,” “an” and “the” include plural referents unless the context clearly dictates otherwise. The notation (Cn-Cm) means a group containing from n to m carbon atoms per group.

The resist material of the invention is a positive resist composition comprising (A) a resin component having a solubility in an alkaline developer that increases under the action of an acid, as a base polymer, (B) a compound capable of generating an acid in response to actinic light or radiation, and (C) an acidic organic compound having a molecular weight of at least 150.

### Component A

The resin component (A) used herein includes, but is not limited to, those polymers comprising units of the following formula (R1) and/or (R2) and having a weight average molecular weight of about 1,000 to about 100,000, especially about 3,000 to about 30,000. Notably, the weight average molecular weight (Mw) of a polymer is measured by gel permeation chromatography (GPC) using polystyrene standards.

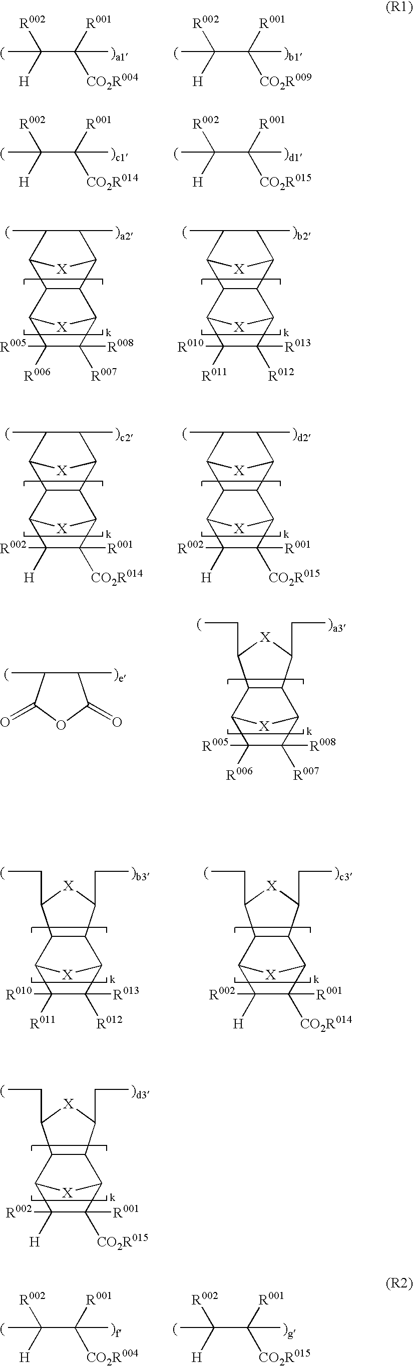

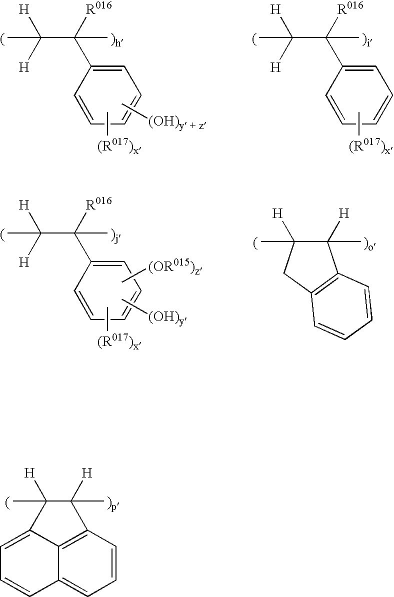

Herein, R⁰⁰¹ is hydrogen, methyl or CH₂CO₂R⁰⁰³.

R⁰⁰² is hydrogen, methyl or CO₂R⁰⁰³.

R⁰⁰³ is a straight, branched or cyclic C₁-C₁₅ alkyl group, for example, methyl, ethyl, propyl, isopropyl, n-butyl, sec-butyl, tert-butyl, tert-amyl, n-pentyl, n-hexyl, cyclopentyl, cyclohexyl, ethylcyclopentyl, butylcyclopentyl, ethylcyclohexyl, butylcyclohexyl, adamantyl, ethyladamantyl, and butyladamantyl.

R⁰⁰⁴ is hydrogen or a monovalent C₁-C₁₅ hydrocarbon group having at least one of fluorinated substituent groups, carboxyl groups and hydroxyl groups, for example, hydrogen, carboxyethyl, carboxybutyl, carboxycyclopentyl, carboxycyclohexyl, carboxynorbornyl, carboxyadamantyl, hydroxyethyl, hydroxybutyl, hydroxycyclopentyl, hydroxycyclohexyl, hydroxynorbornyl, hydroxyadamantyl, [2,2,2-trifluoro-1-hydroxy-1-(trifluoromethyl)ethyl]cyclohexyl, and bis[2,2,2-trifluoro-1-hydroxy-1-(trifluoromethyl)ethyl]-cyclohexyl.

At least one of R⁰⁰⁵ to R⁰⁰⁸ represents a carboxyl group or a monovalent C₁-C₁₅ hydrocarbon group having at least one of fluorinated substituent groups, carboxyl groups and hydroxyl groups while the remaining R's independently represent hydrogen or straight, branched or cyclic C₁-C₁₅ alkyl groups. Examples of the monovalent C₁-C₁₅ hydrocarbon group having at least one of fluorinated substituent groups, carboxyl groups and hydroxyl groups include carboxy, carboxymethyl, carboxyethyl, carboxybutyl, hydroxymethyl, hydroxyethyl, hydroxybutyl, 2-carboxyethoxycarbonyl, 4-carboxybutoxycarbonyl, 2-hydroxyethoxycarbonyl, 4-hydroxybutoxycarbonyl, carboxycyclopentyloxycarbonyl, carboxycyclohexyloxycarbonyl, carboxynorbornyloxycarbonyl, carboxyadamantyloxycarbonyl, hydroxycyclopentyloxycarbonyl, hydroxycyclohexyloxycarbonyl, hydroxynorbornyloxycarbonyl, hydroxyadamantyloxycarbonyl, [2,2,2-trifluoro-1-hydroxy-1-(trifluoromethyl)ethyl]cyclohexyloxycarbonyl, bis[2,2,2-trifluoro-1-hydroxy-1-(trifluoromethyl)ethyl]-cyclohexyloxycarbonyl. Examples of the straight, branched or cyclic C₁-C₁₅ alkyl group are the same as exemplified for R⁰⁰³.

Alternatively, any two of R⁰⁰⁵ to R⁰⁰⁸ (e.g., a pair of R⁰⁰⁵ and R⁰⁰⁶, R⁰⁰⁶ and R⁰⁰⁷, or R⁰⁰⁷ and R⁰⁰⁸) may bond together to form a ring with the carbon atom(s) to which they are attached. In that event, one of ring-forming R's is a divalent C₁-C₁₅ hydrocarbon group having at least one of fluorinated substituent groups, carboxyl groups and hydroxyl groups, and the other is a divalent hydrocarbon group as just described or a single bond, while the remaining R's are independently hydrogen or straight, branched or cyclic C₁-C₁₅ alkyl groups. Examples of the divalent C₁-C₁₅ hydrocarbon group having at least one of fluorinated substituent groups, carboxyl groups and hydroxyl groups include the groups exemplified as the monovalent hydrocarbon group having at least one of fluorinated substituent groups, carboxyl groups and hydroxyl groups, with one hydrogen atom eliminated therefrom. Examples of the straight, branched or cyclic C₁-C₁₅ alkyl groups include the groups exemplified for R⁰⁰³.

R⁰⁰⁹ is a monovalent C₃-C₁₅ hydrocarbon group containing a —CO₂— partial structure, for example, 2-oxooxolan-3-yl, 4,4-dimethyl-2-oxooxolan-3-yl, 4-methyl-2-oxooxan-4-yl, 2-oxo-1,3-dioxolan-4-ylmethyl, and 5-methyl-2-oxooxolan-5-yl.

At least one of R⁰¹⁰ to R⁰¹³ is a monovalent C₂-C₁₅ hydrocarbon group containing a —CO₂— partial structure, while the remaining R's are independently hydrogen or straight, branched or cyclic C₁-C₁₅ alkyl groups. Examples of the monovalent C₂-C₁₅ hydrocarbon group containing a —CO₂— partial structure include 2-oxooxolan-3-yloxycarbonyl, 4,4-dimethyl-2-oxooxolan-3-yloxycarbonyl, 4-methyl-2-oxooxan-4-yloxycarbonyl, 2-oxo-1,3-dioxolan-4-ylmethyloxycarbonyl, and 5-methyl-2-oxooxolan-5-yloxycarbonyl. Examples of the straight, branched or cyclic C₁-C₁₅ alkyl groups are the same as exemplified for R⁰⁰³.

Alternatively, any two of R⁰¹⁰ to R⁰¹³ (e.g., a pair of R⁰¹⁰ and R⁰¹¹, R⁰¹¹ and R⁰¹², or R⁰¹² and R⁰¹³) may bond together to form a ring with the carbon atom(s) to which they are attached. In that event, one of ring-forming R's is a divalent C₂-C₁₅ hydrocarbon group containing a —CO₂— partial structure, and the other is a divalent hydrocarbon group as just described or a single bond, while the remaining R's are independently hydrogen or straight, branched or cyclic C₁-C₁₅ alkyl groups. Examples of the divalent C₂-C₁₅ hydrocarbon group containing a —CO₂— partial structure include 1-oxo-2-oxapropane-1,3-diyl, 1,3-dioxo-2-oxapropane-1,3-diyl, 1-oxo-2-oxabutane-1,4-diyl, and 1,3-dioxo-2-oxabutane-1,4-diyl, as well as the groups exemplified as the monovalent hydrocarbon group containing a —CO₂— partial structure, with one hydrogen atom eliminated therefrom. Examples of the straight, branched or cyclic C₁-C₁₅ alkyl groups include the groups exemplified for R⁰⁰³.

R⁰¹⁴ is a polycyclic C₇-C₁₅ hydrocarbon group or an alkyl group containing a polycyclic hydrocarbon group, for example, norbornyl, bicyclo[3.3.1]nonyl, tricyclo[5.2.1.0^{2,6}]decyl, adamantyl, ethyladamantyl, butyladamantyl, norbornylmethyl, and adamantylmethyl, and alkyl- or cycloalkyl-substituted forms thereof.

R⁰¹⁵ is an acid labile group, which will be described later.

R⁰¹⁶ is hydrogen or methyl.

R⁰¹⁷ is a straight, branched or cyclic C₁-C₈ alkyl group, examples of which include methyl, ethyl, propyl, isopropyl, n-butyl, sec-butyl, tert-butyl, tert-amyl, n-pentyl, n-hexyl, cyclopentyl and cyclohexyl.

X is CH₂ or an oxygen atom.

The subscript k is 0 or 1.

The acid labile groups represented by R⁰¹⁵ may be selected from a variety of such groups. The acid labile group, which is deprotected with the acid generated by the photoacid generator to be described later, may be any of well-known acid labile groups commonly used in resist compositions, especially chemically amplified resist compositions. Examples of the acid labile group are groups of the following general formulae (L1) to (L4), tertiary alkyl groups of 4 to 20 carbon atoms, preferably 4 to 15 carbon atoms, trialkylsilyl groups in which each alkyl moiety has 1 to 6 carbon atoms, and oxoalkyl groups of 4 to 20 carbon atoms.

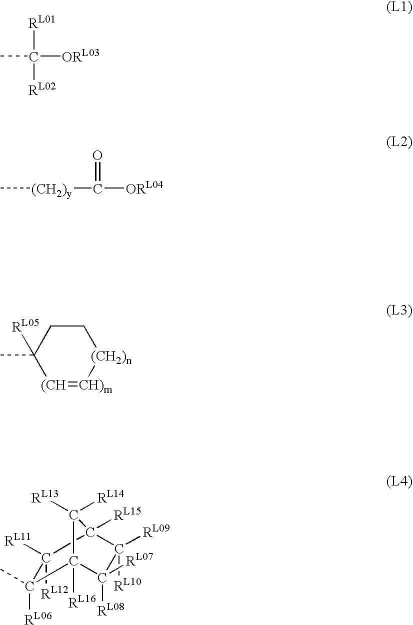

The broken line indicates a valence bond.

In formula (L1), R^{L01} and R^{L02} are hydrogen or straight, branched or cyclic alkyl groups of 1 to 18 carbon atoms, preferably 1 to 10 carbon atoms. Examples include hydrogen, methyl, ethyl, propyl, isopropyl, n-butyl, sec-butyl, tert-butyl, cyclopentyl, cyclohexyl, 2-ethylhexyl, n-octyl, and adamantyl. R^{L03} is a monovalent hydrocarbon group of 1 to 18 carbon atoms, preferably 1 to 10 carbon atoms, which may contain a hetero atom such as oxygen, examples of which include unsubstituted straight, branched or cyclic alkyl groups and straight, branched or cyclic alkyl groups in which some hydrogen atoms are replaced by hydroxyl, alkoxy, oxo, amino, alkylamino or the like. Examples of the straight, branched or cyclic alkyl groups are as exemplified above for R^{L01} and R^{L002}, and examples of the substituted alkyl groups are shown below.

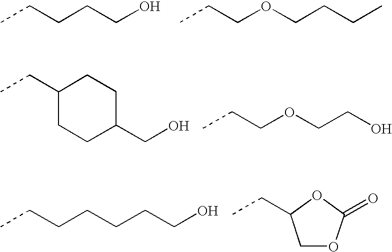

A pair of R^{L001} and R^{L02}, R^{L01} and R^{L03}, or R^{L02} and R^{L03} may bond together to form a ring with the carbon and oxygen atoms to which they are attached. Each of R^{L01}, R^{L02} and R^{L003} is a straight or branched alkylene group of 1 to 18 carbon atoms, preferably 1 to 10 carbon atoms when they form a ring.

In formula (L2), R^{L04} is a tertiary alkyl group of 4 to 20 carbon atoms, preferably 4 to 15 carbon atoms, a trialkylsilyl group in which each alkyl moiety has 1 to 6 carbon atoms, an oxoalkyl group of 4 to 20 carbon atoms, or a group of formula (L1). Exemplary tertiary alkyl groups are tert-butyl, tert-amyl, 1,1-diethylpropyl, 2-cyclopentylpropan-2-yl, 2-cyclohexylpropan-2-yl, 2-(bicyclo[2.2.1]heptan-2-yl)propan-2-yl, 2-(adamantan-1-yl)propan-2-yl, 2-(tricyclo[5.2.1.0^{2,6}]decan-8-yl)propan-2-yl, 2-(tetracyclo[4.4.0.1^{2,5}.1^{7,10}]dodecan-3-yl)propan-2-yl, 1-ethylcyclopentyl, 1-butylcyclopentyl, 1-ethylcyclohexyl, 1-butylcyclohexyl, 1-ethyl-2-cyclopentenyl, 1-ethyl-2-cyclohexenyl, 2-methyl-2-adamantyl, 2-ethyl-2-adamantyl, 8-methyl-8-tricyclo[5.2.1.0^{2,6}]decyl, 8-ethyl-8-tricyclo[5.2.1.0^{2,6}]decyl, 3-methyl-3-tetracyclo[4.4.0.1^{2,5}.1^{7,10} dodecyl, and 3-ethyl-3-tetracyclo[4.4.0.1^{2,5}.1^{7,10}]dodecyl. Exemplary trialkylsilyl groups are trimethylsilyl, triethylsilyl, and dimethyl-tert-butylsilyl. Exemplary oxoalkyl groups are 3-oxocyclohexyl, 4-methyl-2-oxooxan-4-yl, and 5-methyl-2-oxooxolan-5-yl. In formula (L2), y is an integer of 0 to 6.

In formula (L3), R^{L05} is a substituted or unsubstituted, C₁-C₁₀ straight, branched or cyclic alkyl group or a substituted or unsubstituted C₆-C₂₀ aryl group. Examples of the substituted or unsubstituted alkyl groups include straight, branched or cyclic ones such as methyl, ethyl, propyl, isopropyl, n-butyl, sec-butyl, tert-butyl, tert-amyl, n-pentyl, n-hexyl, cyclopentyl, cyclohexyl and bicyclo[2.2.1]heptyl; substituted forms of the foregoing in which some hydrogen atoms are replaced by hydroxyl, alkoxy, carboxy, alkoxycarbonyl, oxo, amino, alkylamino, cyano, mercapto, alkylthio, sulfo or other groups; and substituted forms of the foregoing in which some of the methylene groups are replaced by oxygen or sulfur atoms. Exemplary substituted or unsubstituted aryl groups are phenyl, methylphenyl, naphthyl, anthryl, phenanthryl, and pyrenyl. In formula (L3), m is 0 or 1, n is 0, 1, 2 or 3, and 2m+n is equal to 2 or 3.

In formula (L4), R^{L06} is a substituted or unsubstituted, C₁-C₁₀ straight, branched or cyclic alkyl group or a substituted or unsubstituted C₆-C₂₀ aryl group. Examples of these groups are the same as exemplified for R^{L05}. R^{L07} to R^{L16} independently represent hydrogen or monovalent C₁-C₁₅ hydrocarbon groups. Exemplary hydrocarbon groups are straight, branched or cyclic alkyl groups such as methyl, ethyl, propyl, isopropyl, n-butyl, sec-butyl, tert-butyl, tert-amyl, n-pentyl, n-hexyl, n-octyl, n-nonyl, n-decyl, cyclopentyl, cyclohexyl, cyclopentylmethyl, cyclopentylethyl, cyclopentylbutyl, cyclohexylmethyl, cyclohexylethyl and cyclohexylbutyl, and substituted forms of the foregoing in which some hydrogen atoms are replaced by hydroxyl, alkoxy, carboxy, alkoxycarbonyl, oxo amino, alkylamino, cyano, mercapto, alkylthio, sulfo or other groups. Alternatively, any two of R^{L07} to R^{L16} may bond together to form a ring with the carbon atom(s) to which they are attached (for example, a pair of R^{L07} and R^{L08}, R^{L07} and R^{L09}, R^{L08} and R^{L10}, R^{L09} and R^{L10}, R^{L11} and R^{L12}, R^{L13} and R^{L14}, or a similar pair form a ring). Each of R^{L07} to R^{L16} represents a divalent C₁-C₁₅ hydrocarbon group when they form a ring, examples of which are the ones exemplified above for the monovalent hydrocarbon groups, with one hydrogen atom being eliminated. Two of R^{L07} to R^{L16} which are attached to adjoining carbon atoms (for example, a pair of R^{L07} and R^{L09}, R^{L09} and R^{L15}, R^{L13} and R^{L15}, or a similar pair) may bond together directly to form a double bond.

Of the acid labile groups of formula (L1), the straight and branched ones are exemplified by the following groups.

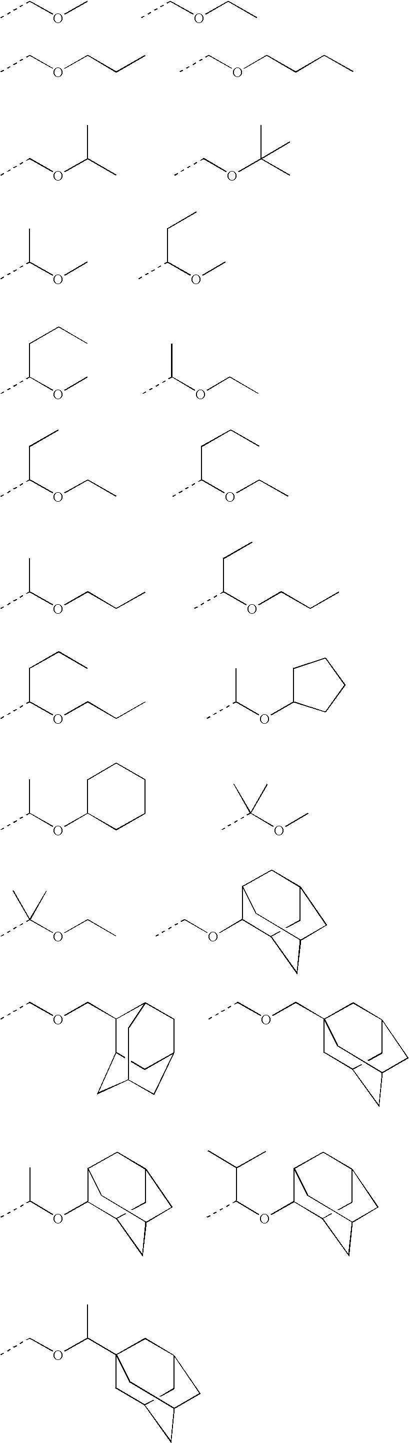

Of the acid labile groups of formula (L1), the cyclic ones are, for example, tetrahydrofuran-2-yl, 2-methyltetrahydrofuran-2-yl, tetrahydropyran-2-yl, and 2-methyltetrahydropyran-2-yl.

Examples of the acid labile groups of formula (L2) include tert-butoxycarbonyl, tert-butoxycarbonylmethyl, tert-amyloxycarbonyl, tert-amyloxycarbonylmethyl, 1,1-diethylpropyloxycarbonyl, 1,1-diethylpropyloxycarbonylmethyl, 1-ethylcyclopentyloxycarbonyl, 1-ethylcyclopentyloxycarbonylmethyl, 1-ethyl-2-cyclopentenyloxycarbonyl, 1-ethyl-2-cyclopentenyloxycarbonylmethyl, 1-ethoxyethoxycarbonylmethyl, 2-tetrahydropyranyloxycarbonylmethyl, and 2-tetrahydrofuranyloxycarbonylmethyl groups.

Examples of the acid labile groups of formula (L3) include 1-methylcyclopentyl, 1-ethylcyclopentyl, 1-n-propylcyclopentyl, 1-isopropylcyclopentyl, 1-n-butylcyclopentyl, 1-sec-butylcyclopentyl, 1-cyclohexylcyclopentyl, 1-(4-methoxybutyl)cyclopentyl, 1-(bicyclo[2.2.1]heptan-2-yl)cyclopentyl, 1-(7-oxabicyclo[2.2.1]heptan-2-yl)cyclopentyl, 1-methylcyclohexyl, 1-ethylcyclohexyl, 1-methyl-2-cyclopentenyl, 1-ethyl-2-cyclopentenyl, 1-methyl-2-cyclohexenyl, and 1-ethyl-2-cyclohexenyl groups.

The acid labile groups of formula (L4) are preferably groups of the following formulae (L4-1) to (L4-4).

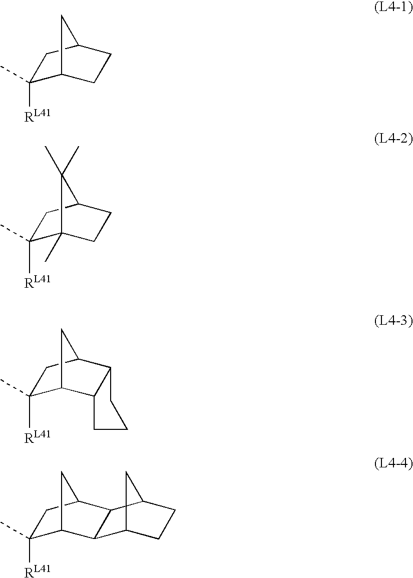

In formulae (L4-1) to (L4-4), the broken line indicates a bonding site and direction. R^{L41} is each independently selected from monovalent hydrocarbon groups, typically straight, branched or cyclic C₁-C₁₀ alkyl groups, for example, methyl, ethyl, propyl, isopropyl, n-butyl, sec-butyl, tert-butyl, tert-amyl, n-pentyl, n-hexyl, cyclopentyl, and cyclohexyl.

For formulas (L4-1) to (L4-4), there can exist enantiomers and diastereomers. Each of formulae (L4-1) to (L4-4) collectively represents all such stereoisomers. Such stereoisomers may be used alone or in admixture.

For example, the general formula (L4-3) represents one or a mixture of two selected from groups having the following general formulas (L4-3-1) and (L4-3-2).

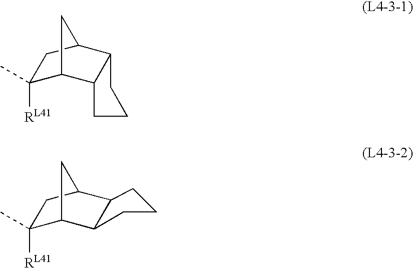

Similarly, the general formula (L4-4) represents one or a mixture of two or more selected from groups having the following general formulas (L4-4-1) to (L4-4-4).

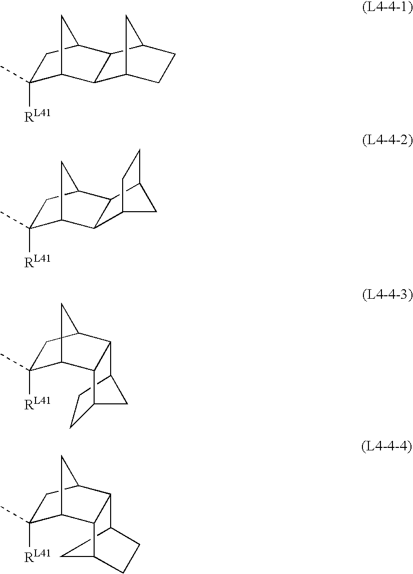

Each of formulas (L4-1) to (L4-4), (L4-3-1) and (L4-3-2), and (L4-4-1) to (L4-4-4) collectively represents an enantiomer thereof and a mixture of enantiomers.

It is noted that in the above formulas (L4-1) to (L4-4), (L4-3-1) and (L4-3-2), and (L4-4-1) to (L4-4-4), the bond direction is on the exo side relative to the bicyclo[2.2.1]heptane ring, which ensures high reactivity for acid catalyzed elimination reaction (see JP-A 2000-336121). In preparing these monomers having a tertiary exo-alkyl group of bicyclo[2.2.1]heptane skeleton as a substituent group, there may be contained monomers substituted with an endo-alkyl group as represented by the following formulas (L4-1-endo) to (L4-4-endo). For good reactivity, an exo proportion of at least 50 mol % is preferred, with an exo proportion of at least 80 mol % being more preferred.

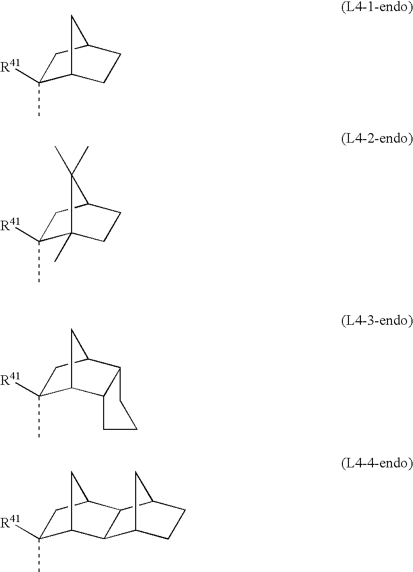

Illustrative examples of the acid labile group of formula (L4) are given below

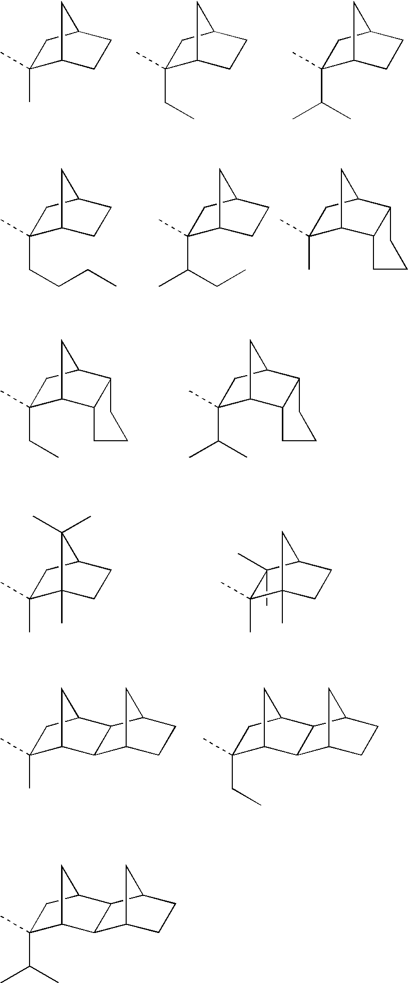

Examples of the tertiary C₄-C₂₀ alkyl, tri(C₁-C₆-alkyl)silyl and C₄-C₂₀ oxoalkyl groups included in the acid labile groups represented by R⁰¹⁵ are as exemplified above for R^{L04}.

R⁰¹⁶ is hydrogen or methyl. R⁰¹⁷ is a straight, branched or cyclic C₁-C₈ alkyl group.

In formulae (R1) and (R2), the subscripts a1′, a2′, a3′, b1′, b2′, b3′, c1′, c2′, c3′, d1′, d2′, d3′, and e′ are numbers from 0 to less than 1, satisfying a1′+a2′+a3′+b1′+b21+b3′+c1′+c2′+c3′+d1′+d2′+d3′+e′=1; f′, g′, h′, i′, j′, o′ and p′ are numbers from 0 to less than 1, satisfying f′+g′+h′+i′+j′+o′+p′=1; x′, y′ and z′ are each an integer of 0 to 3, satisfying 1≦x′+y′+z′≦5 and 1≦y′+z′≦3.

In recurring units of formula (R1) or (R2), two or more types may be incorporated at the same time. The use of plural recurring units of different type allows for easy adjustment of resist properties. Notably, the sum of recurring units is equal to unity (1), which means that in a polymer comprising recurring units, the total of these recurring units is 100 mol % based on the total of overall recurring units.

Examples of the recurring units incorporated at compositional ratio a1′ in formula (R1) and the recurring units incorporated at compositional ratio f′ in formula (R2) are shown below, though not limited thereto.

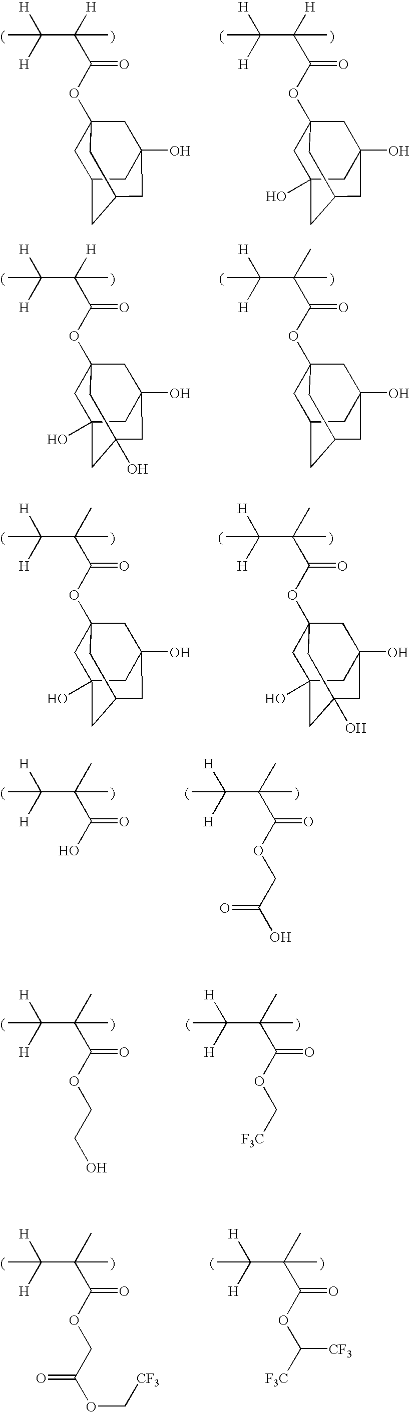

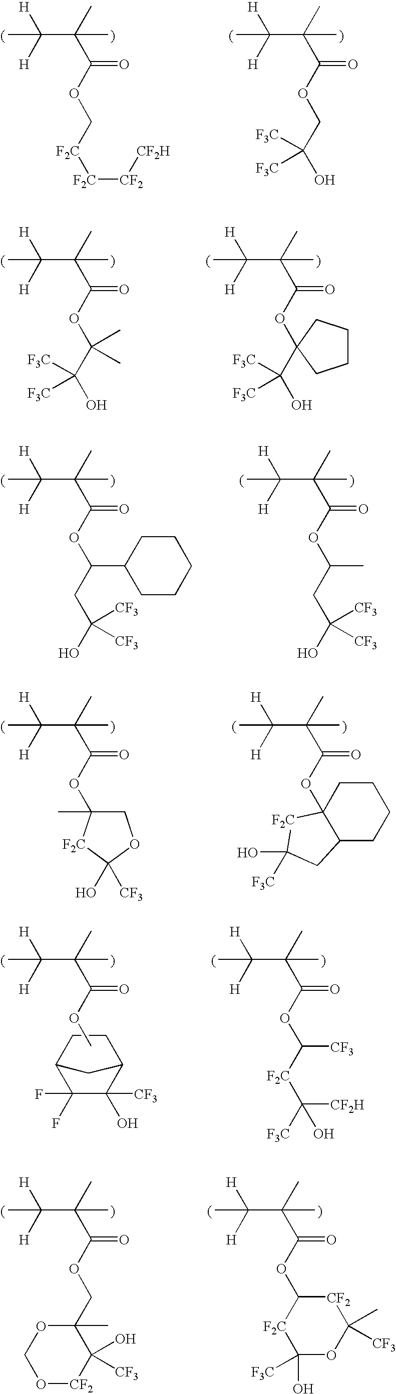

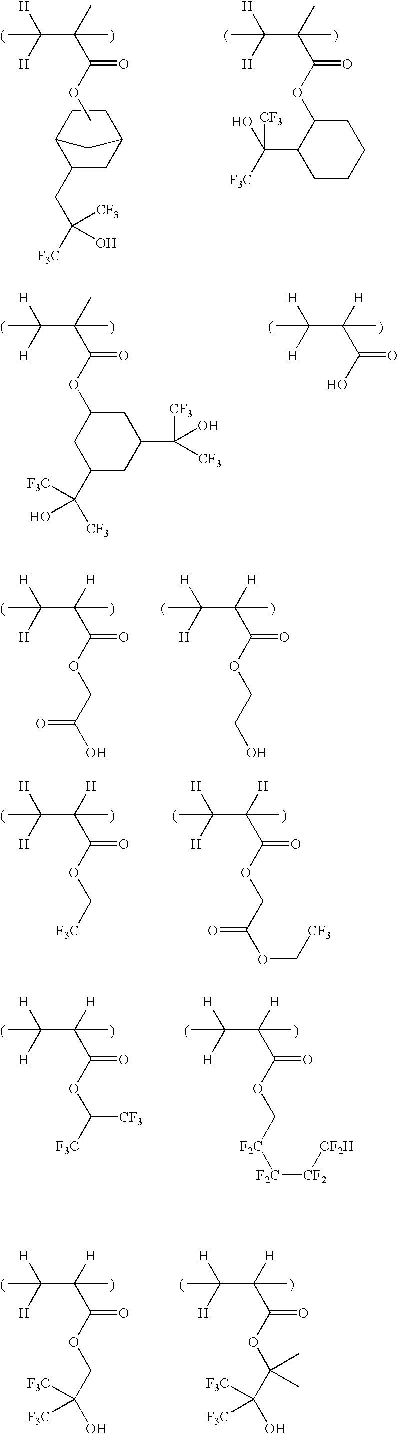

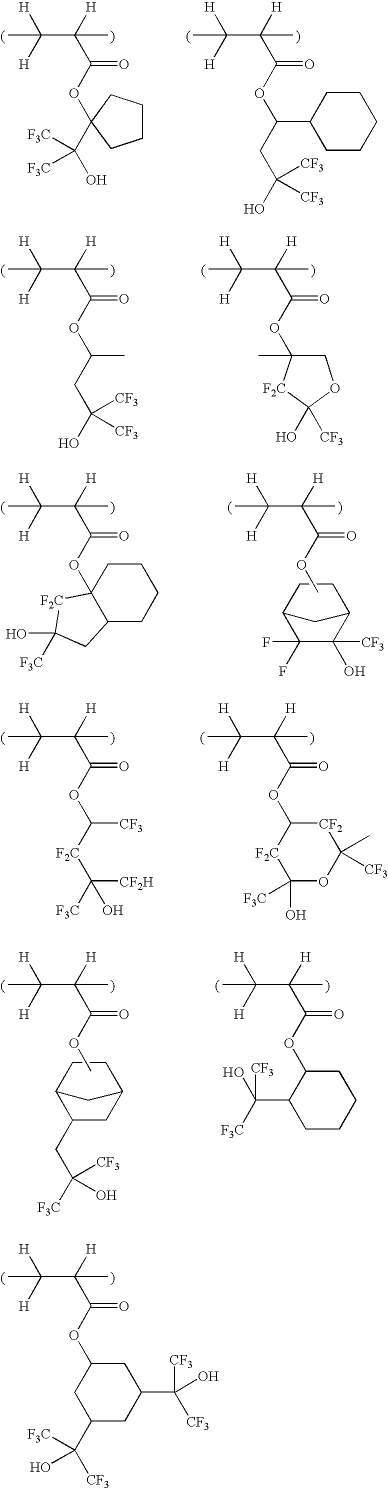

Examples of the recurring units incorporated at compositional ratio b1′ in formula (R1) are shown below, though not limited thereto.

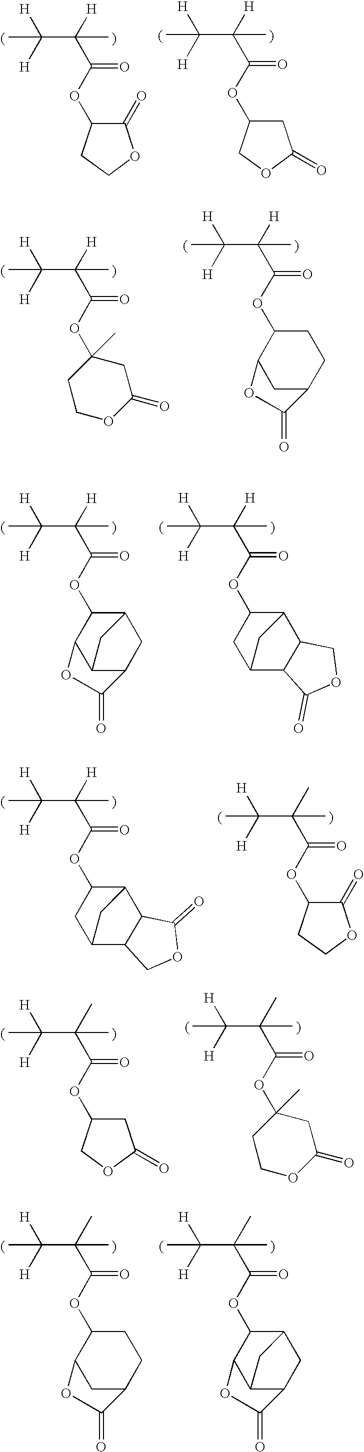

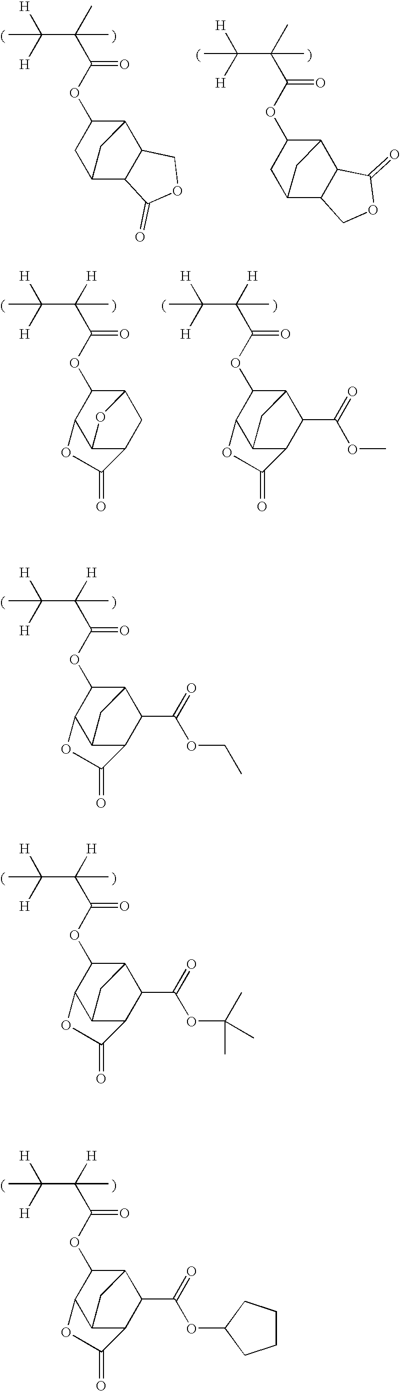

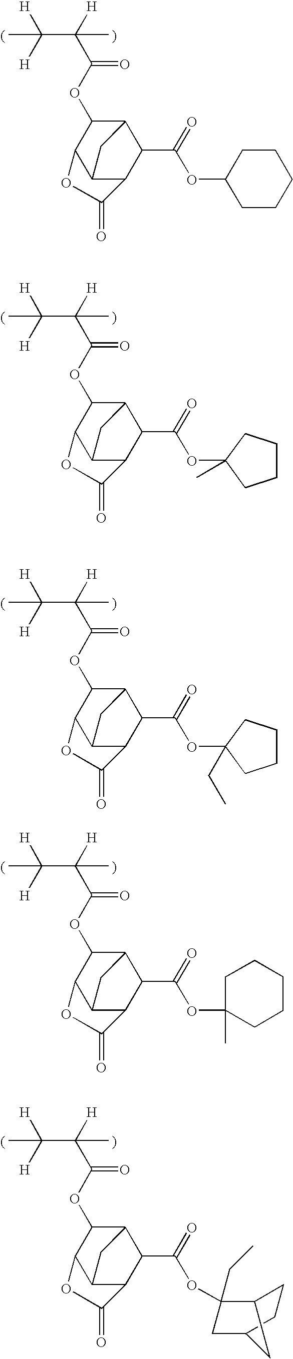

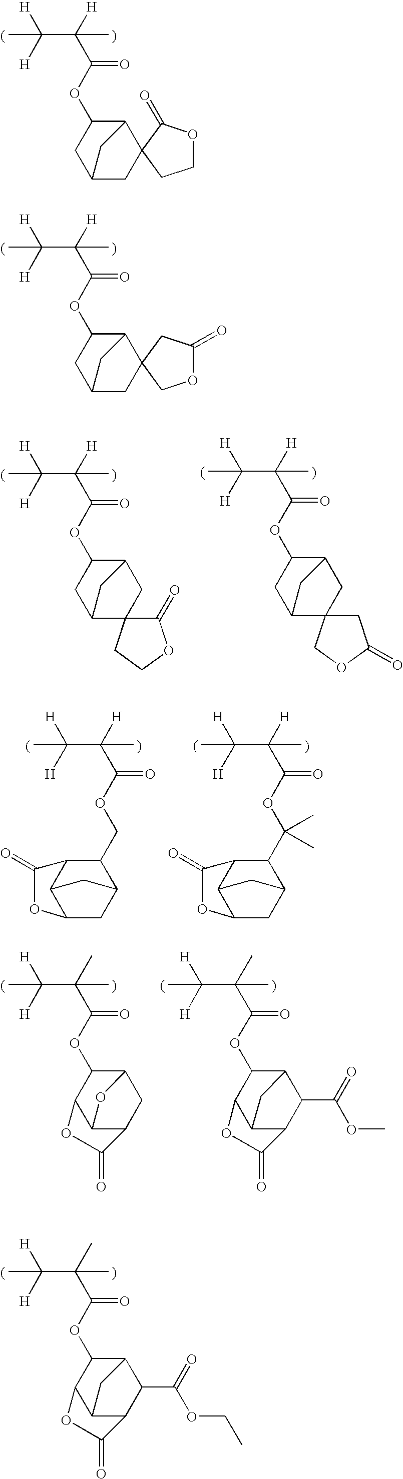

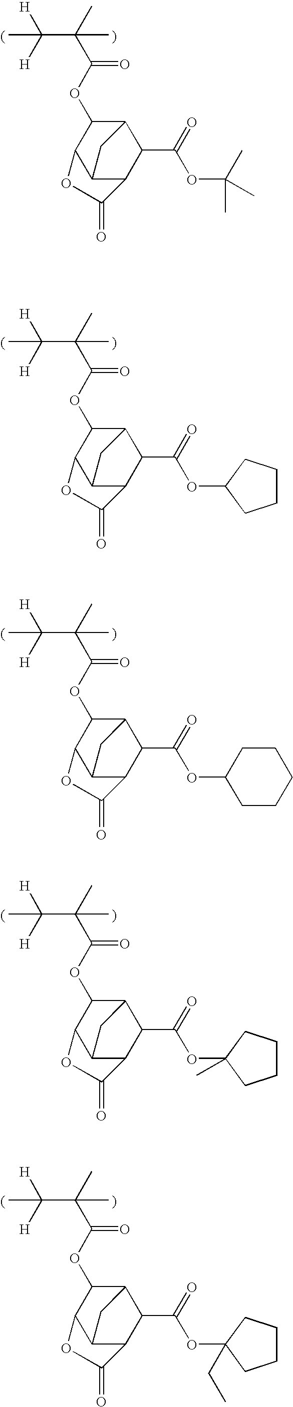

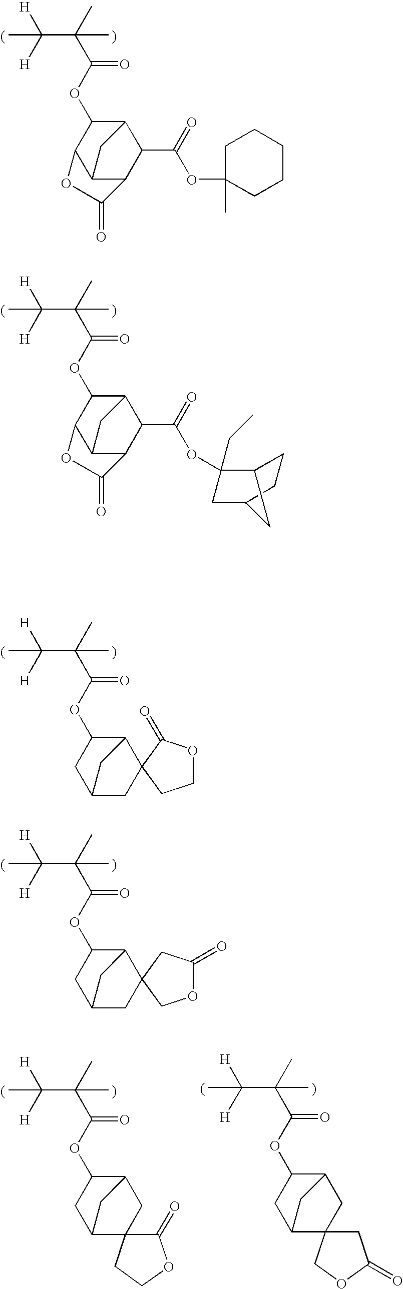

Examples of the recurring units incorporated at compositional ratio d1′ in formula (R1) and the recurring units incorporated at compositional ratio g′ in formula (R2) are shown below, though not limited thereto.

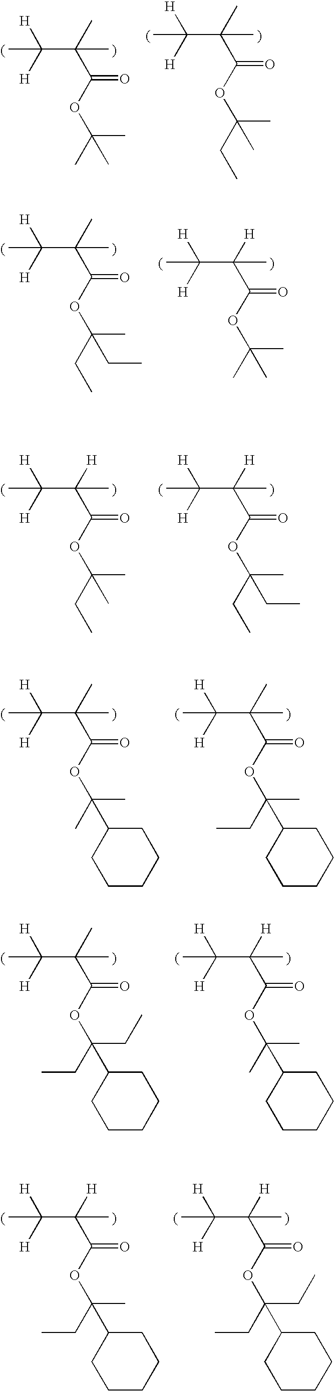

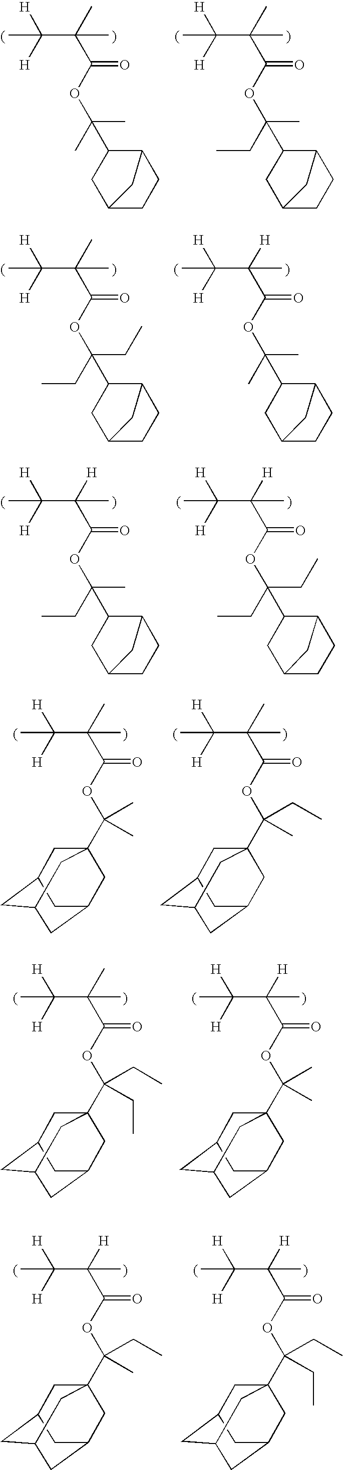

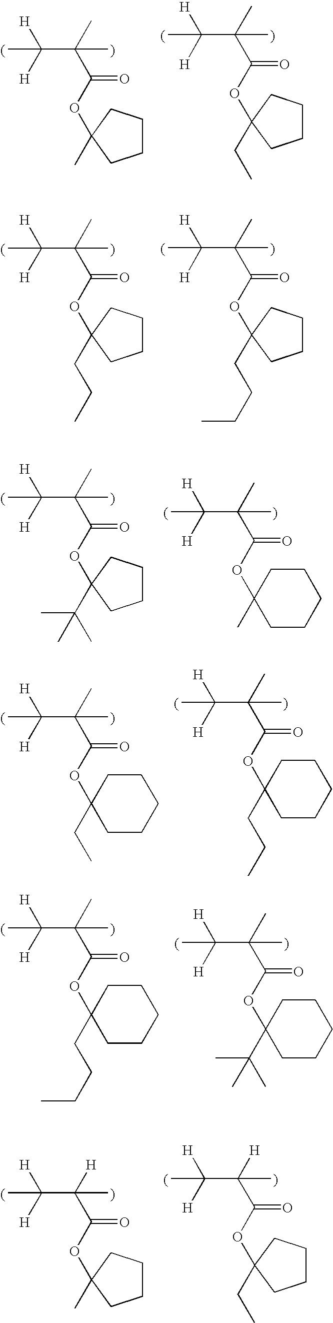

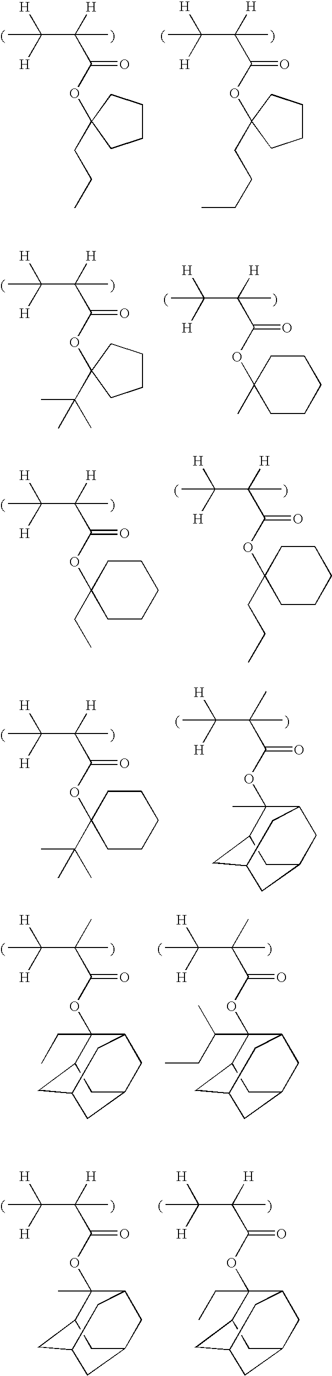

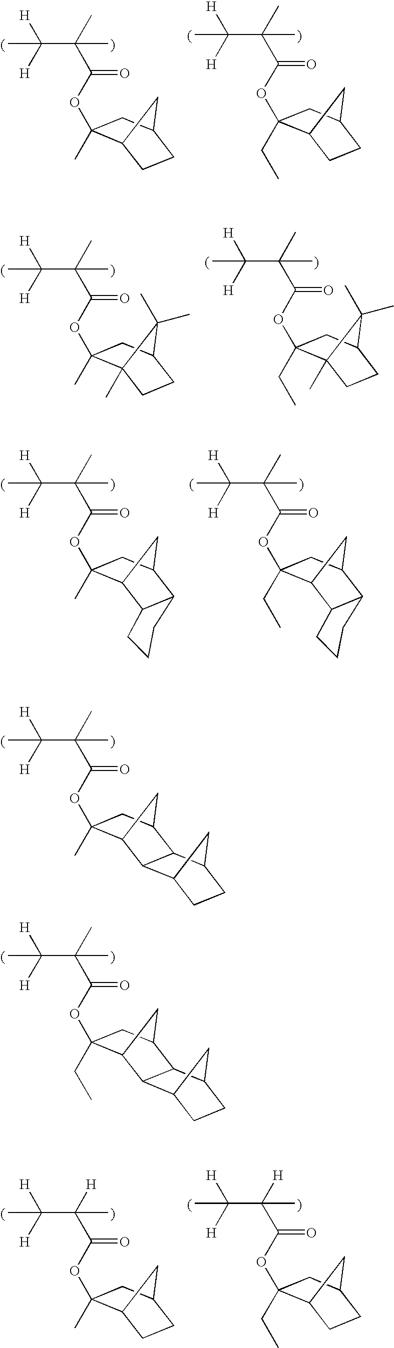

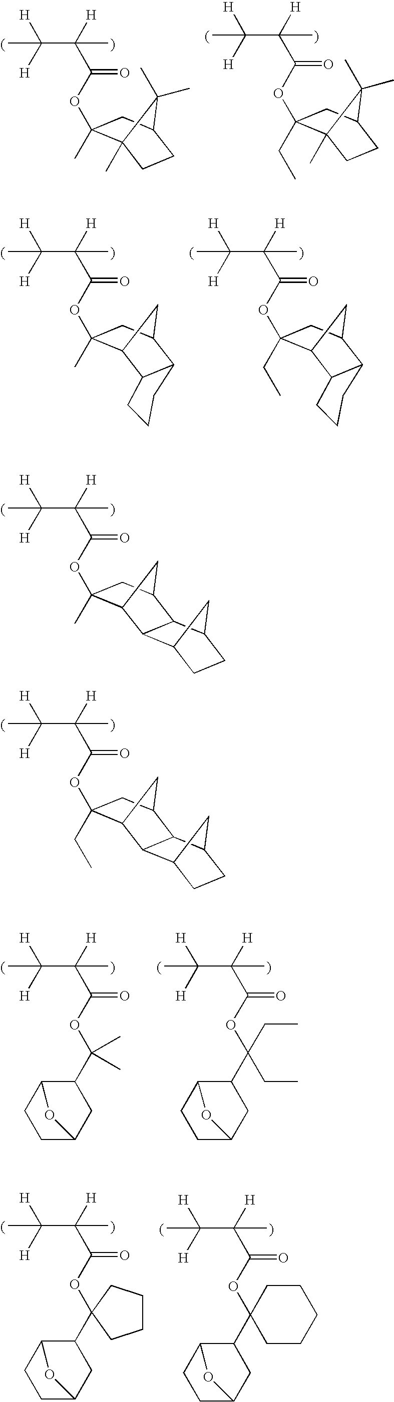

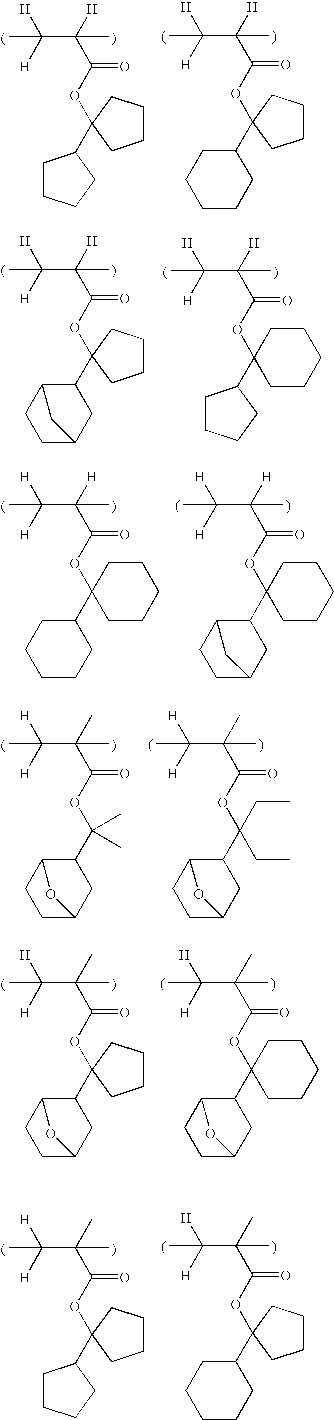

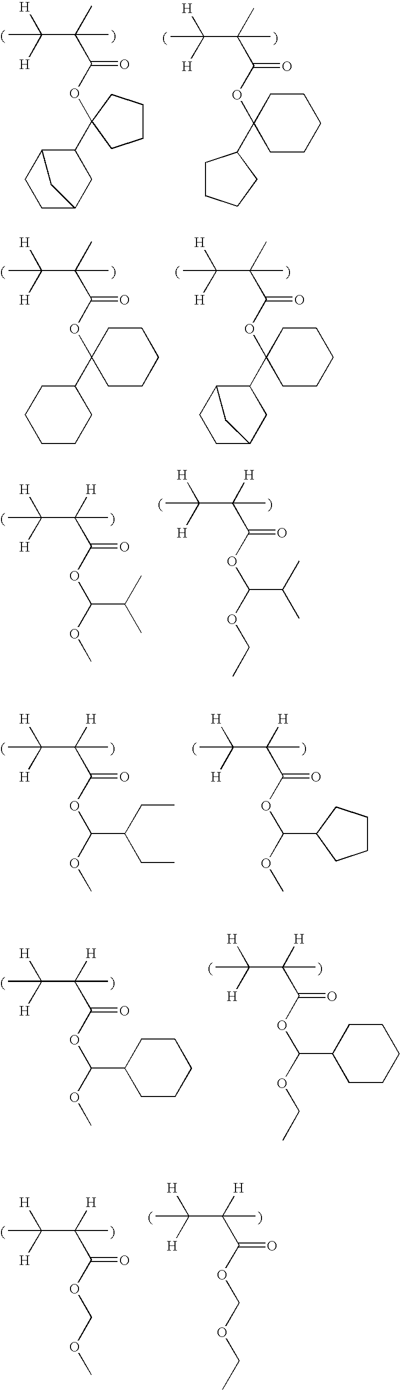

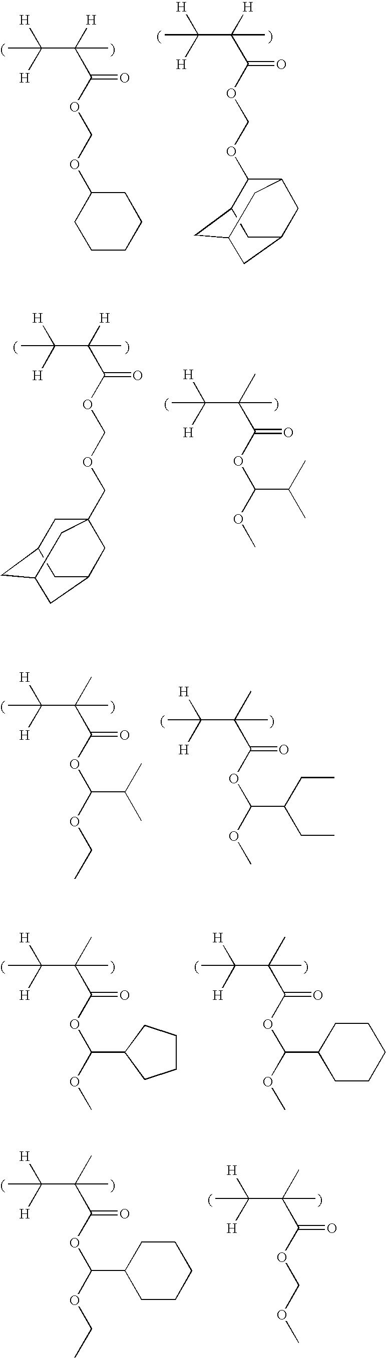

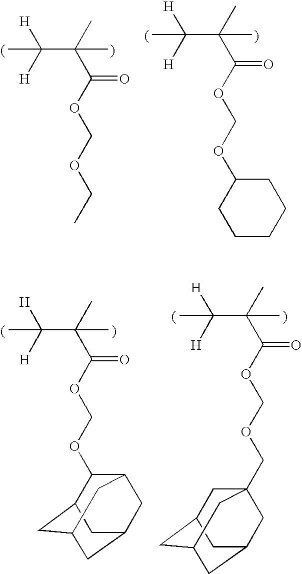

Examples of polymers comprising recurring units in compositional ratios a1′, b1′, c1′ and d1′ in formula (R1) are shown below, though not limited thereto.

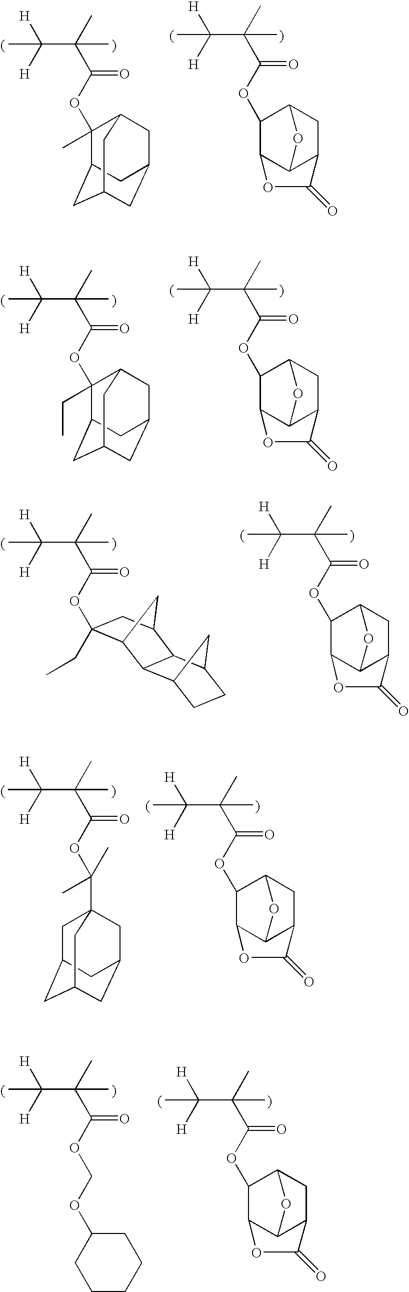

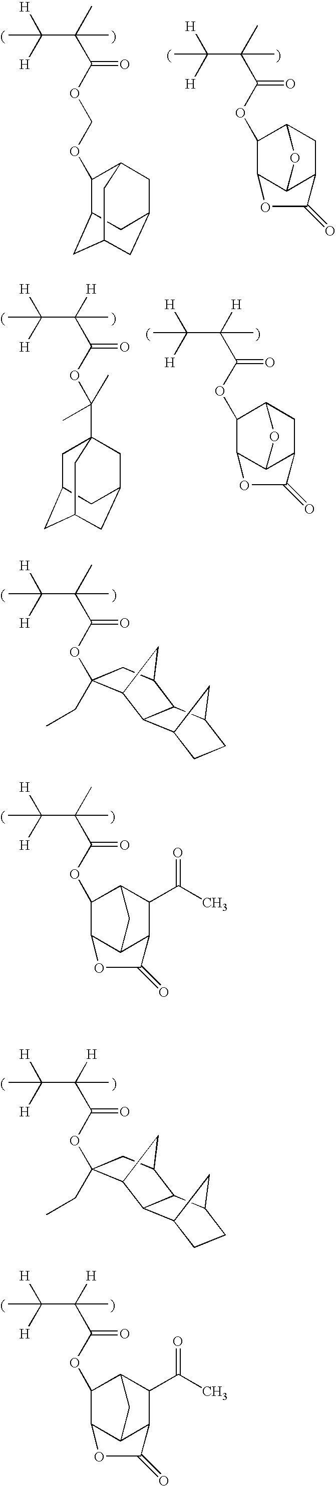

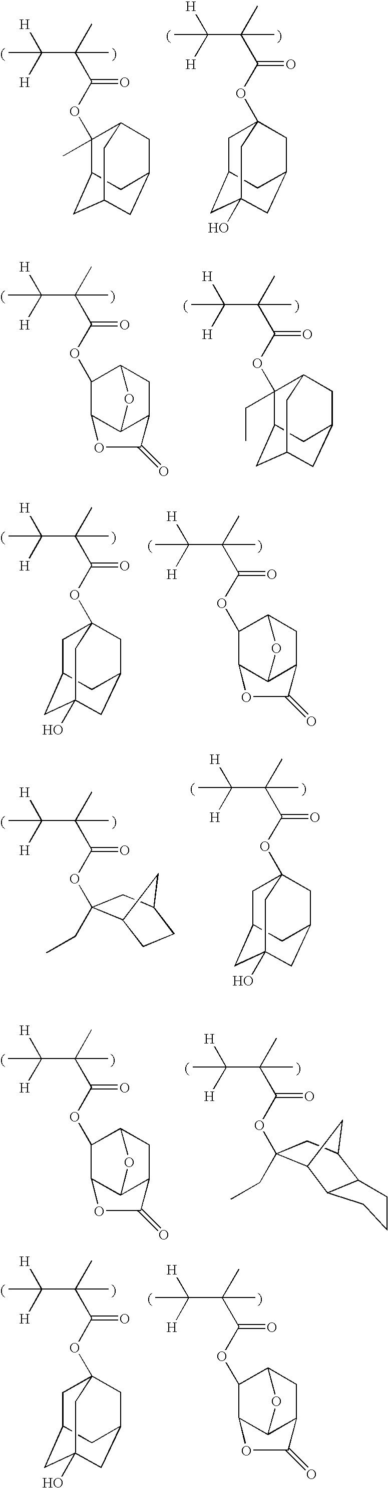

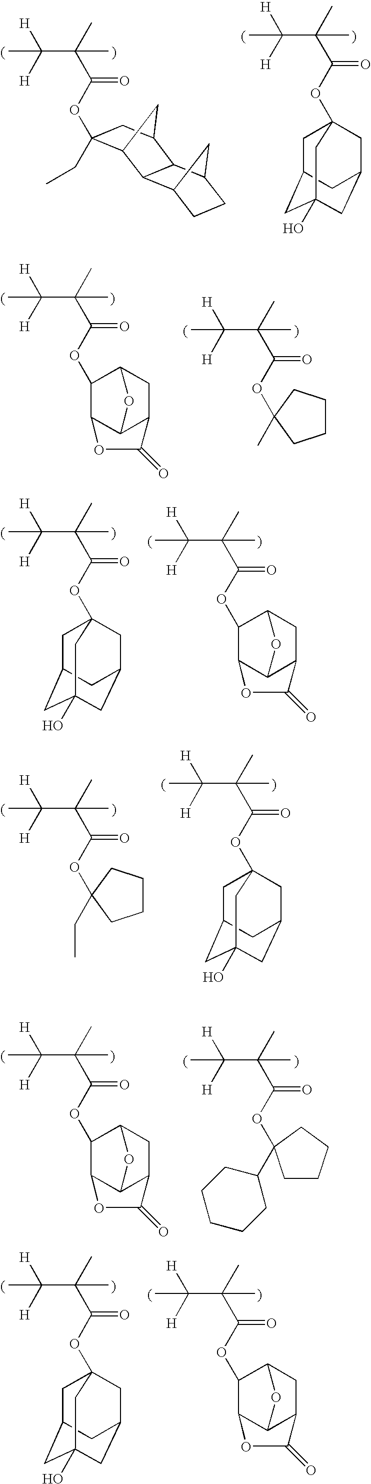

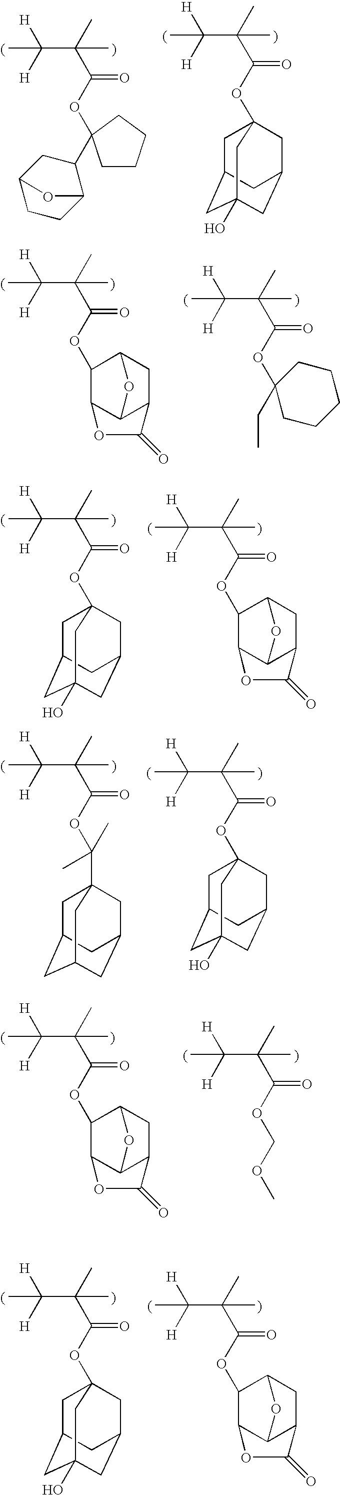

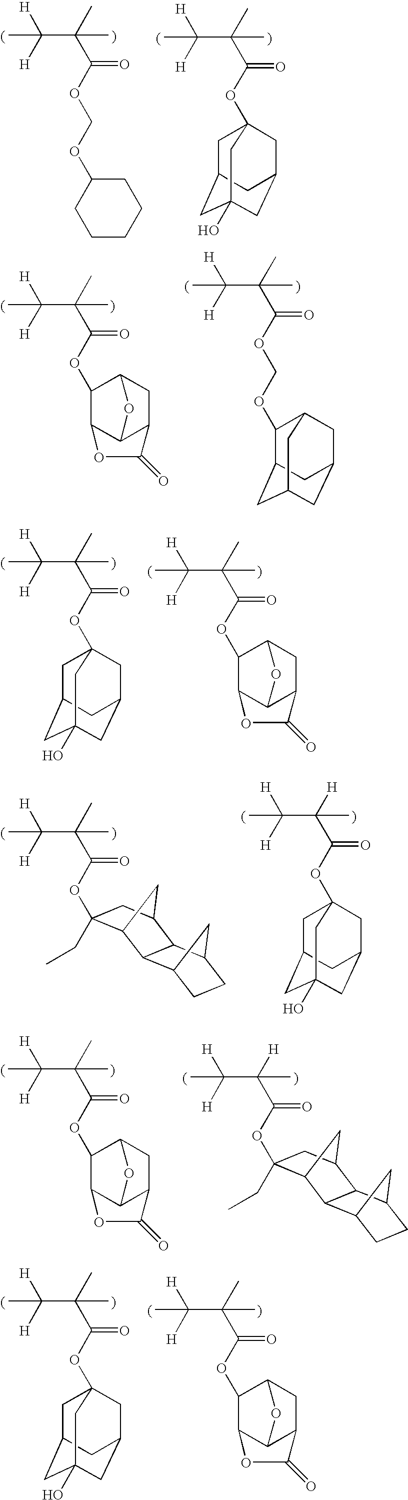

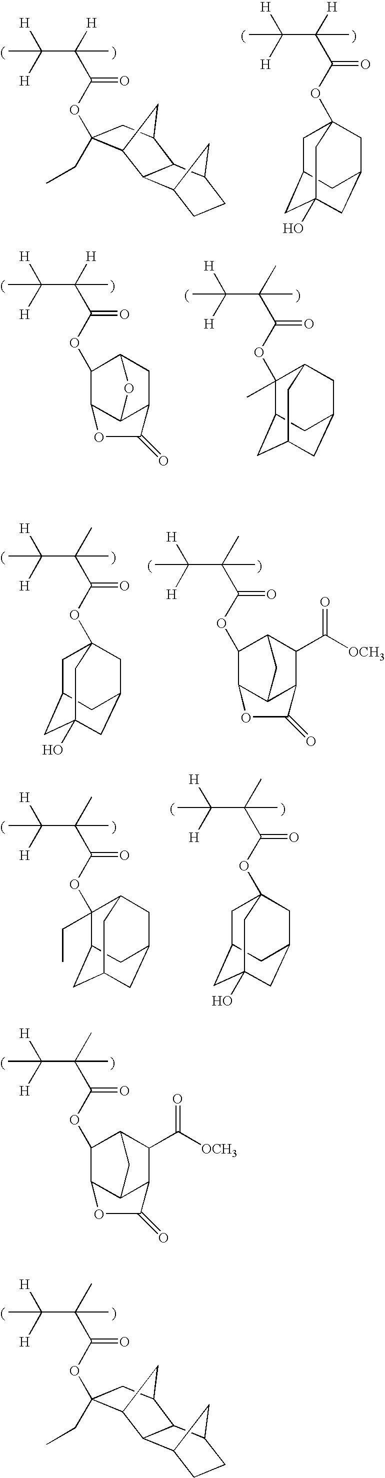

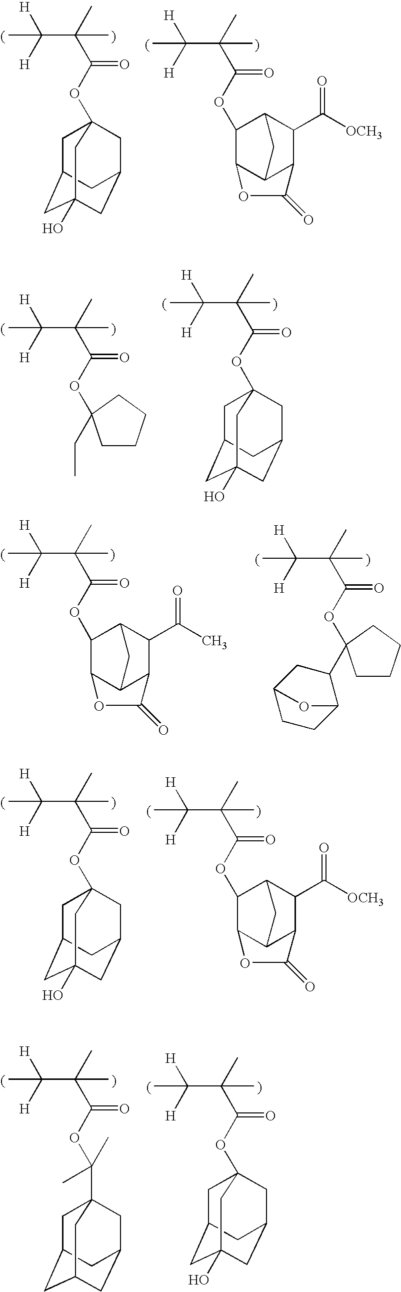

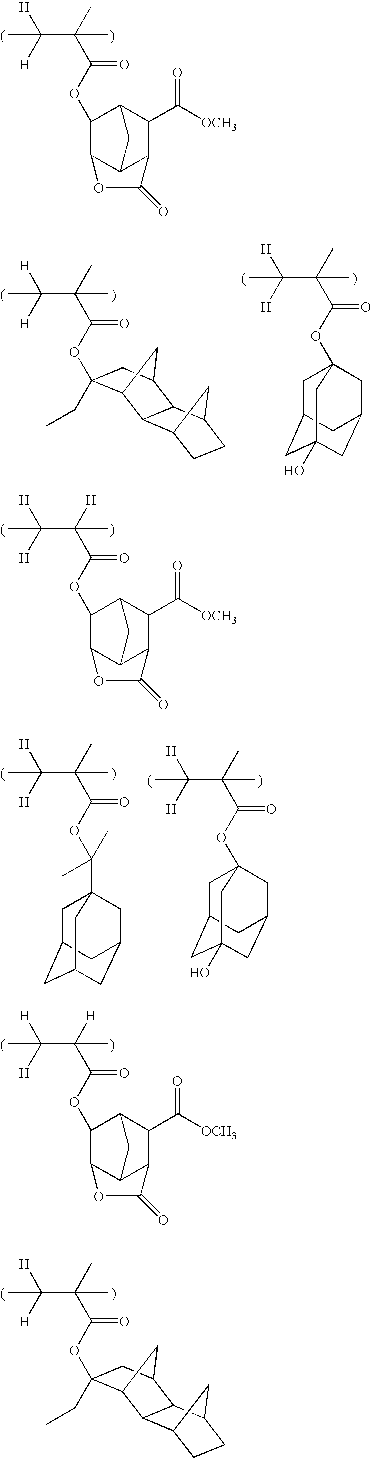

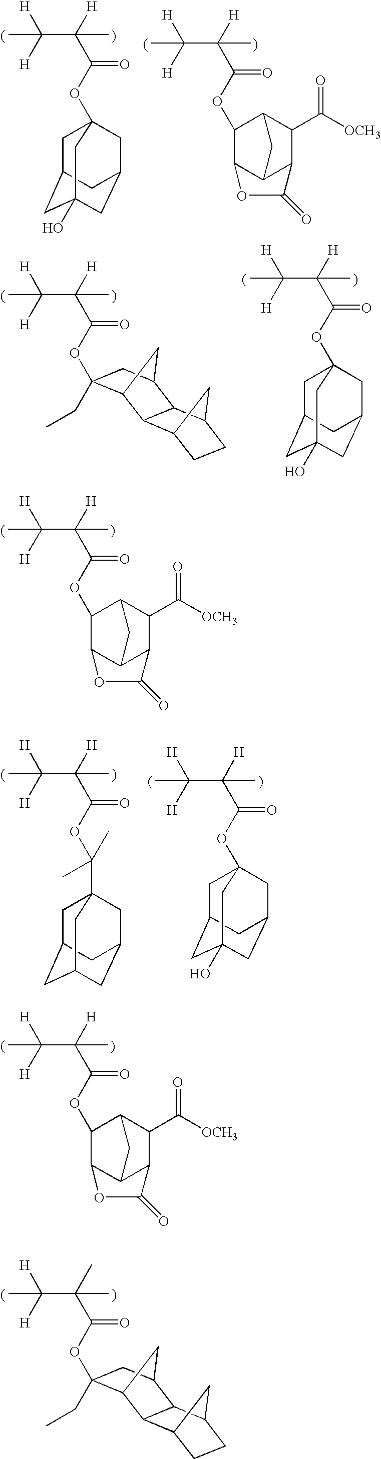

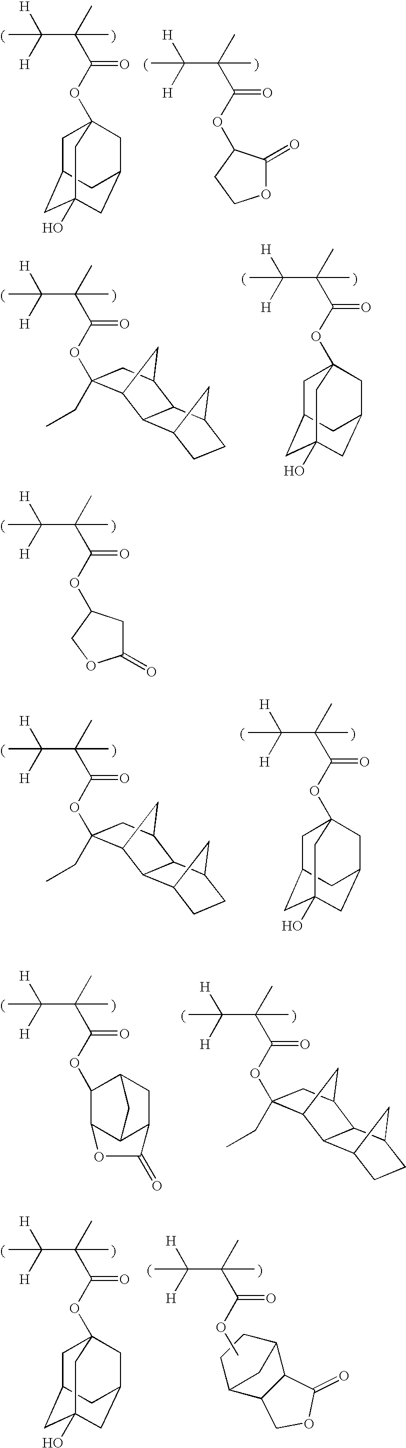

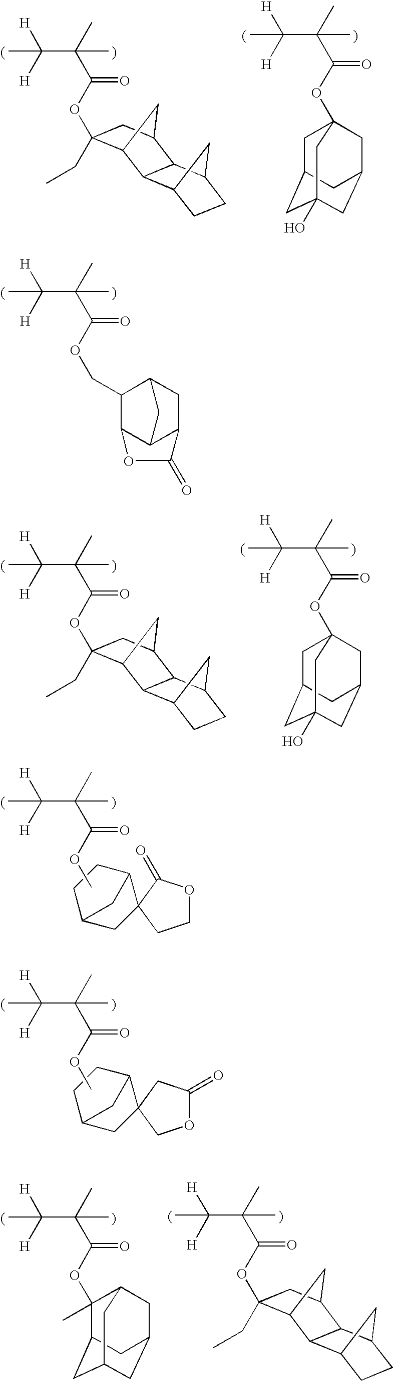

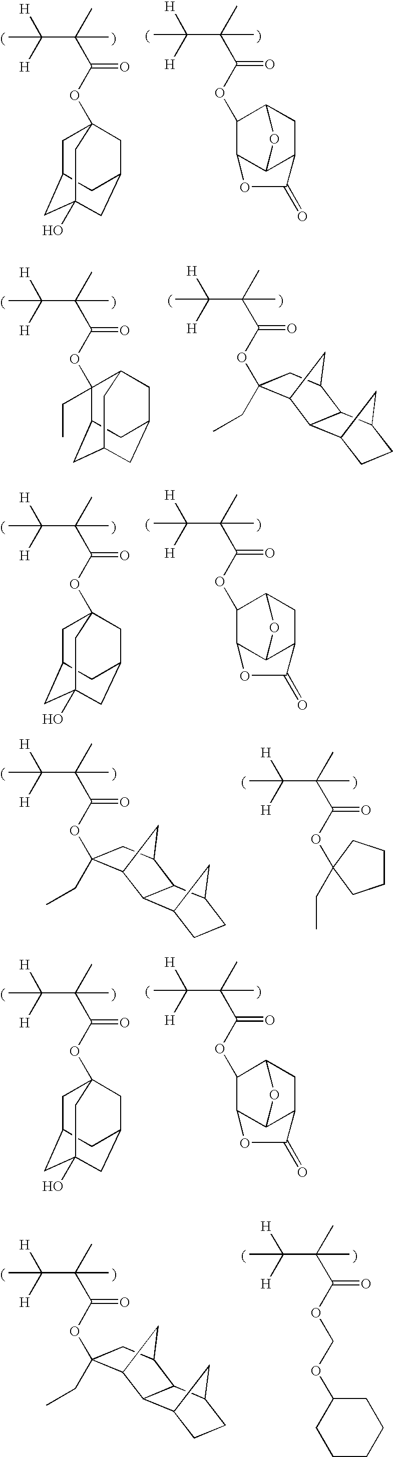

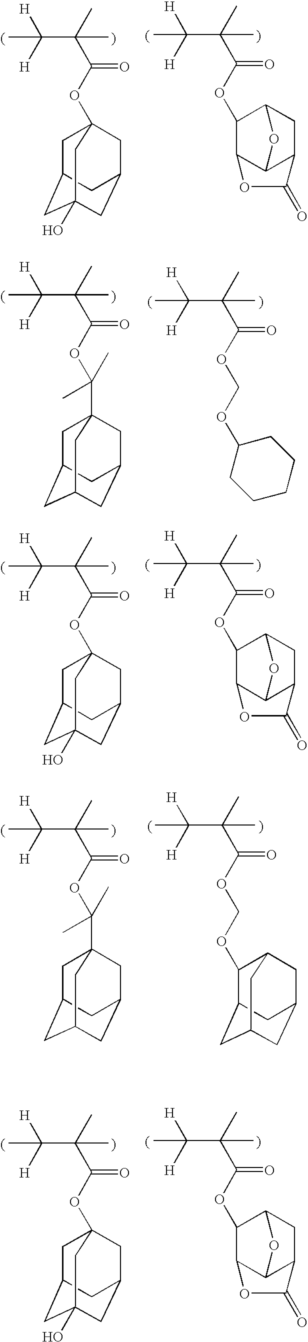

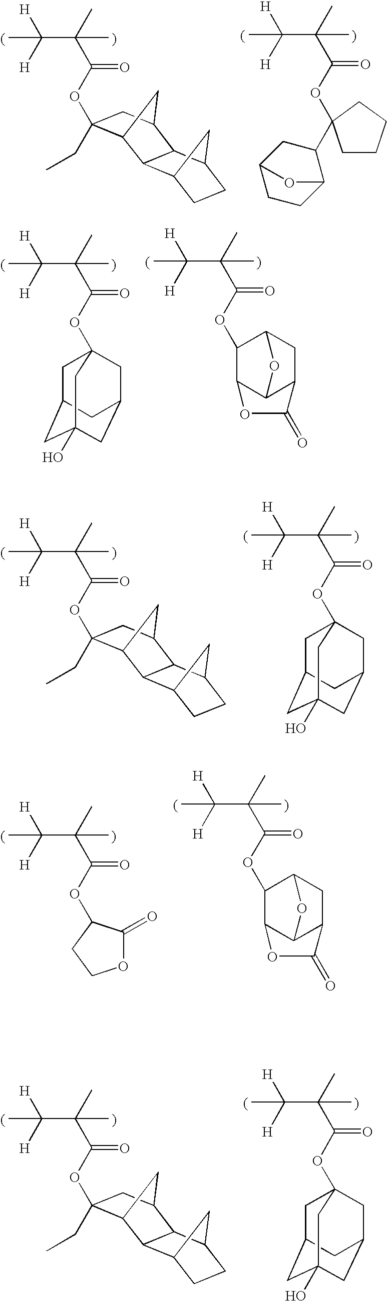

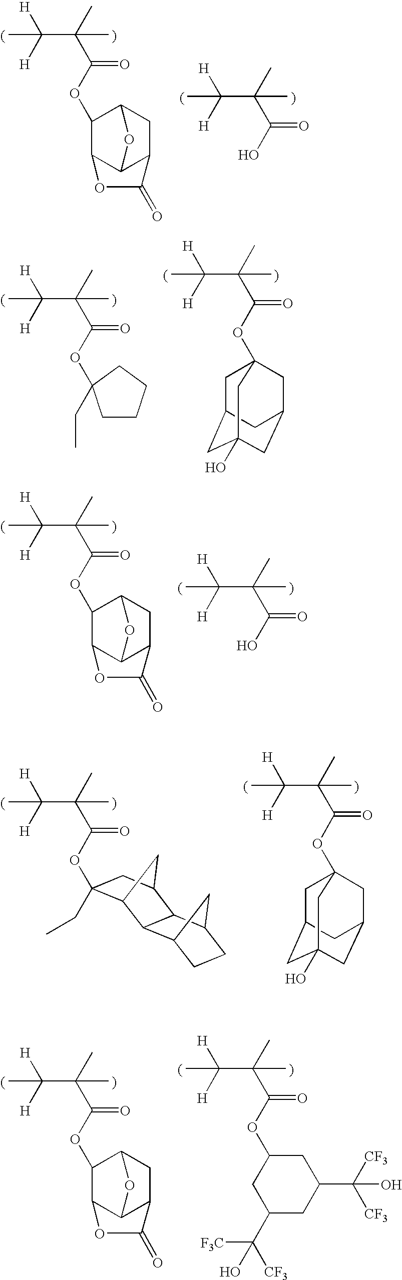

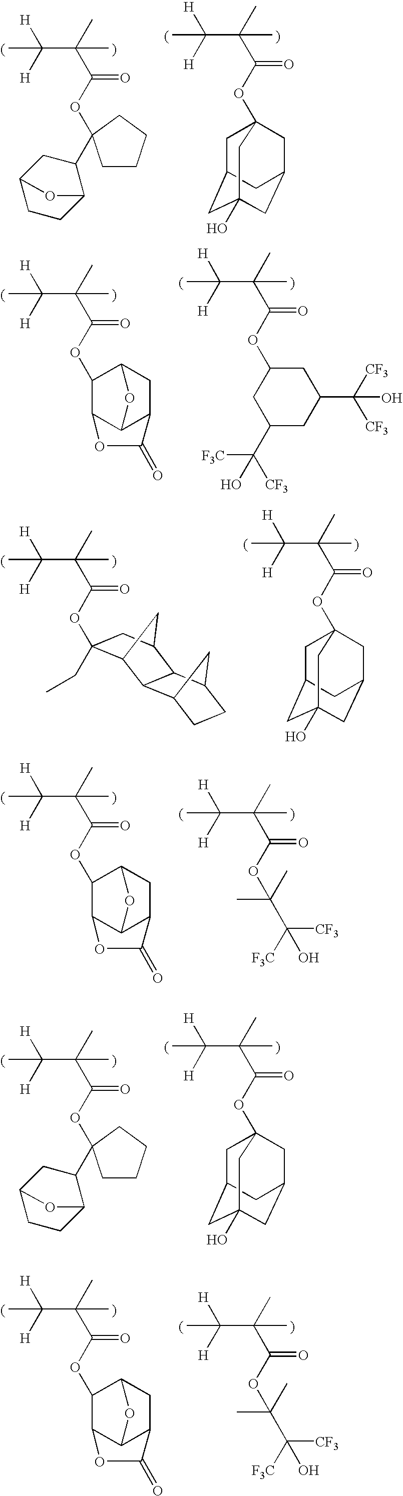

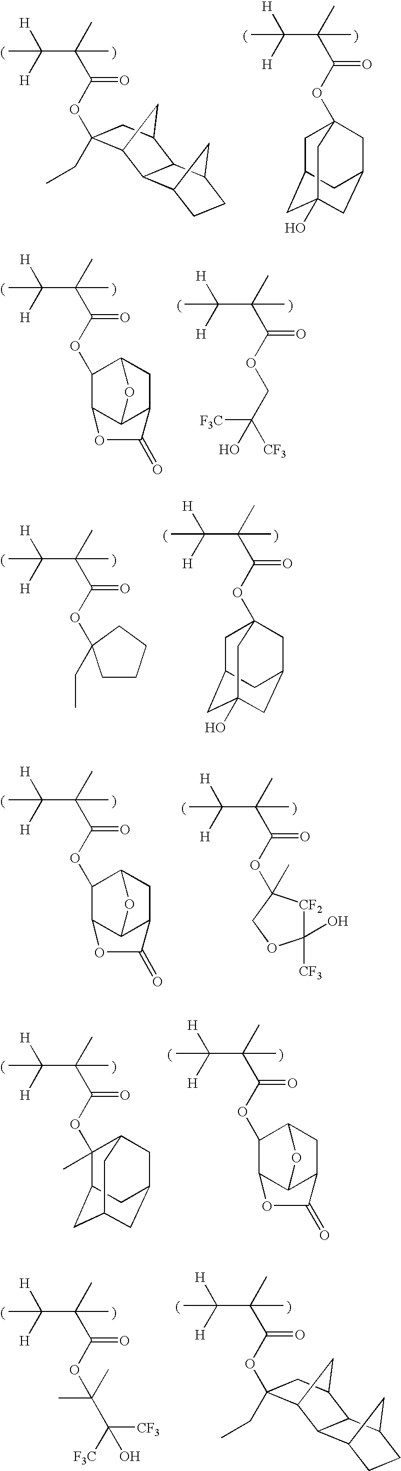

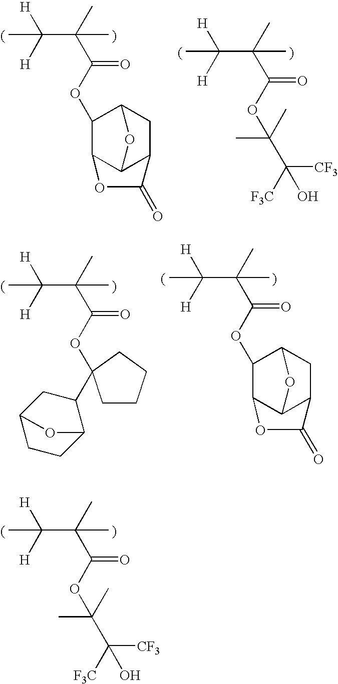

Examples of polymers comprising recurring units in compositional ratios a2′, b2′, c2′, d2′ and e′ in formula (R1) are shown below, though not limited thereto.

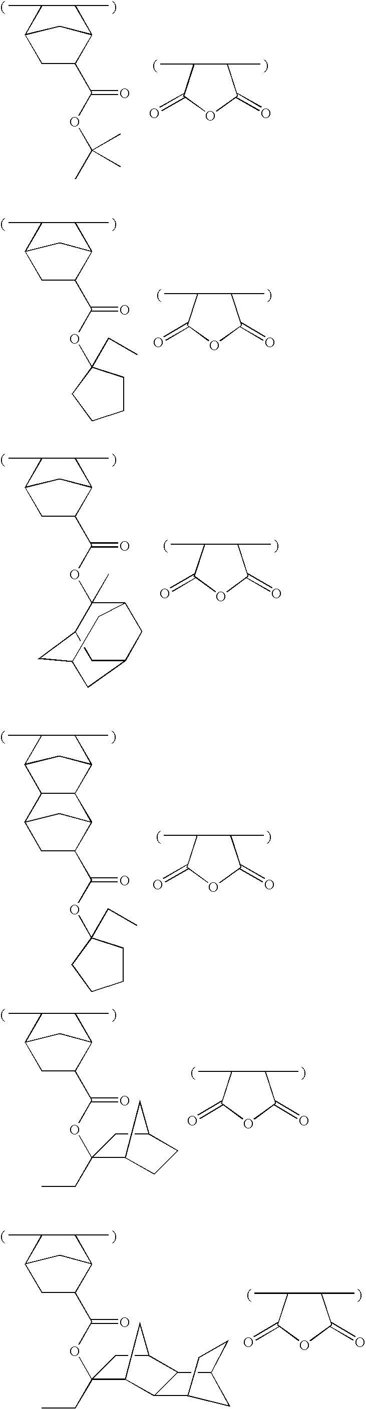

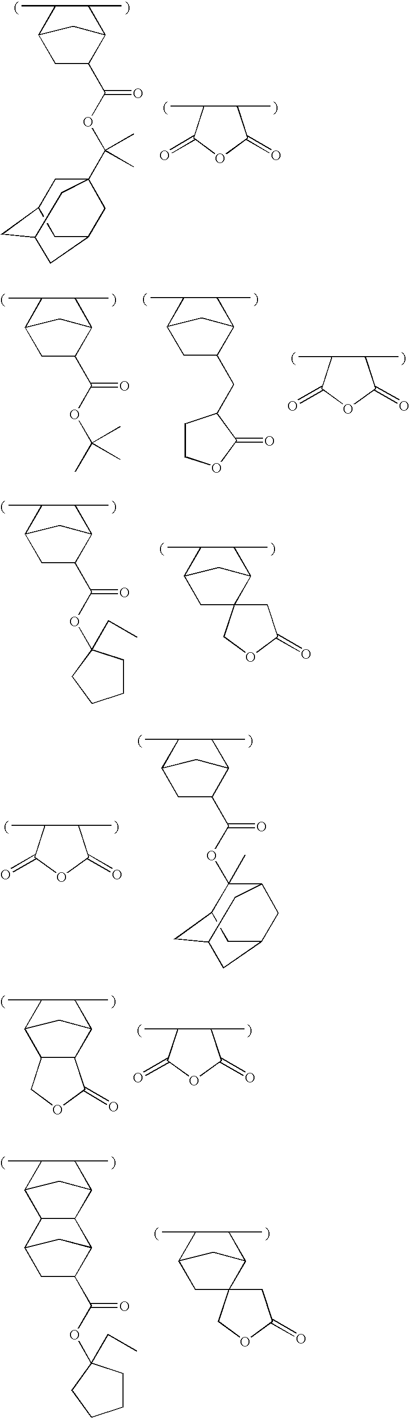

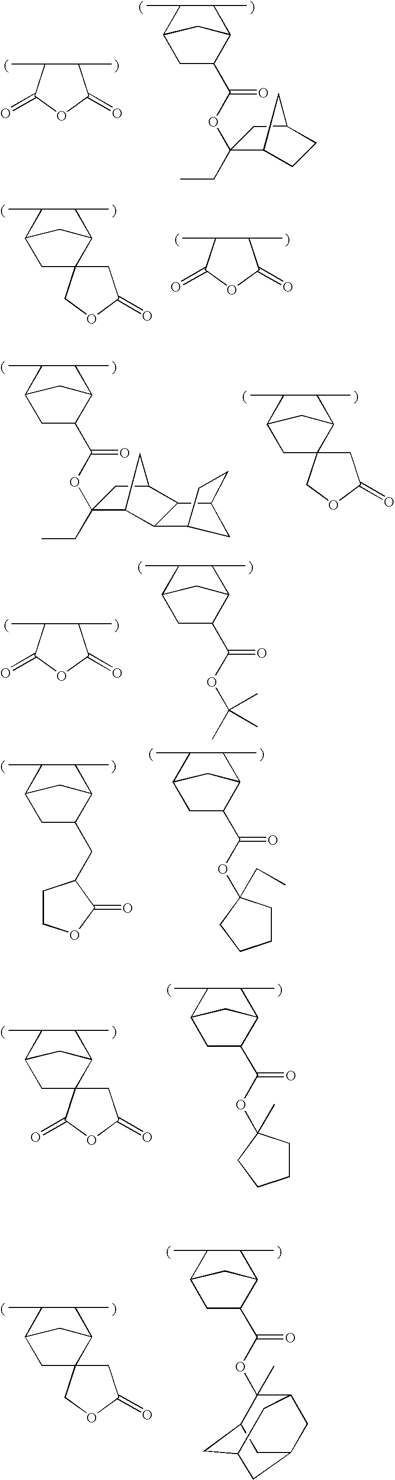

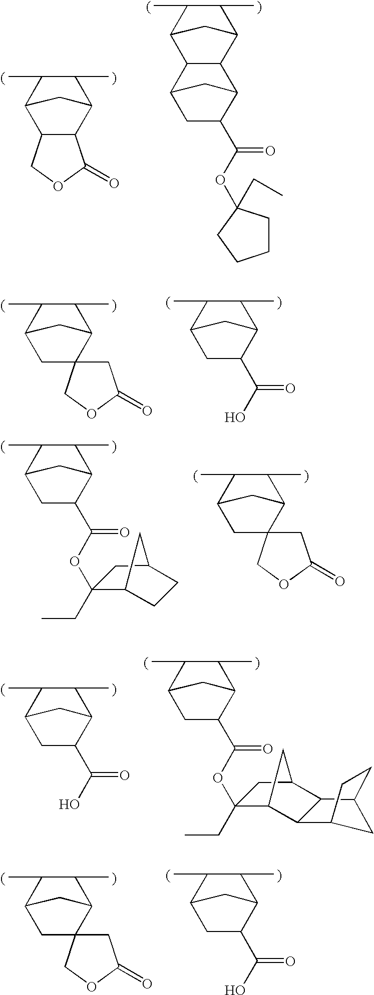

Examples of polymers comprising recurring units in compositional ratios a3′, b3′, c3′ and d3′ in formula (R1) are shown below, though not limited thereto.

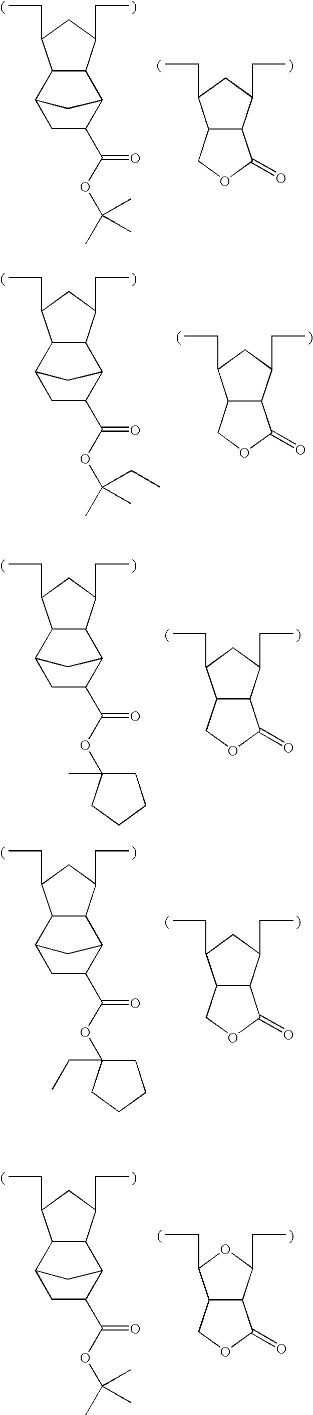

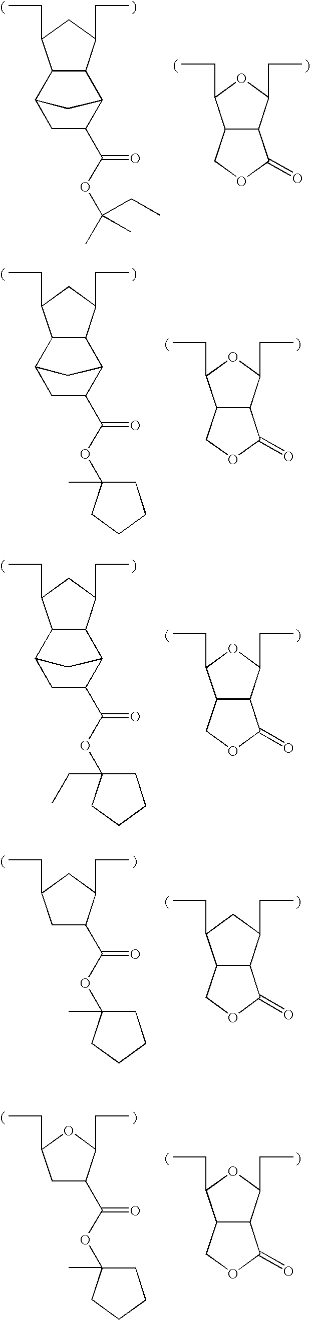

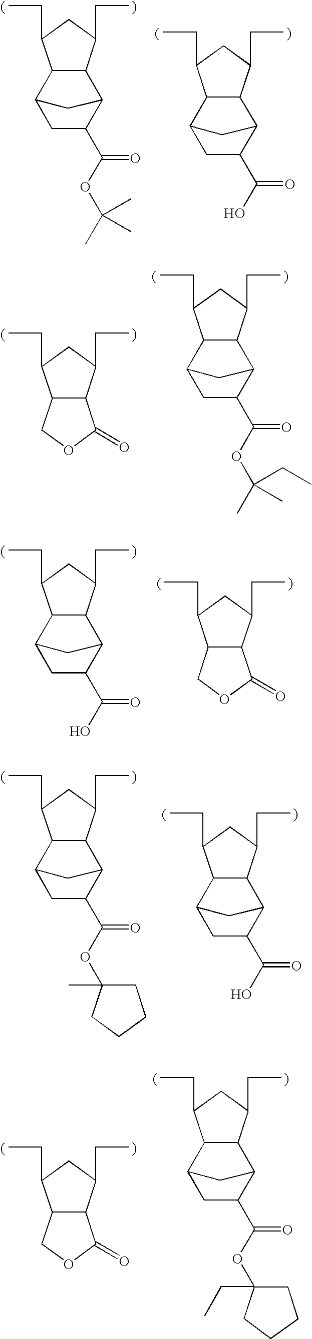

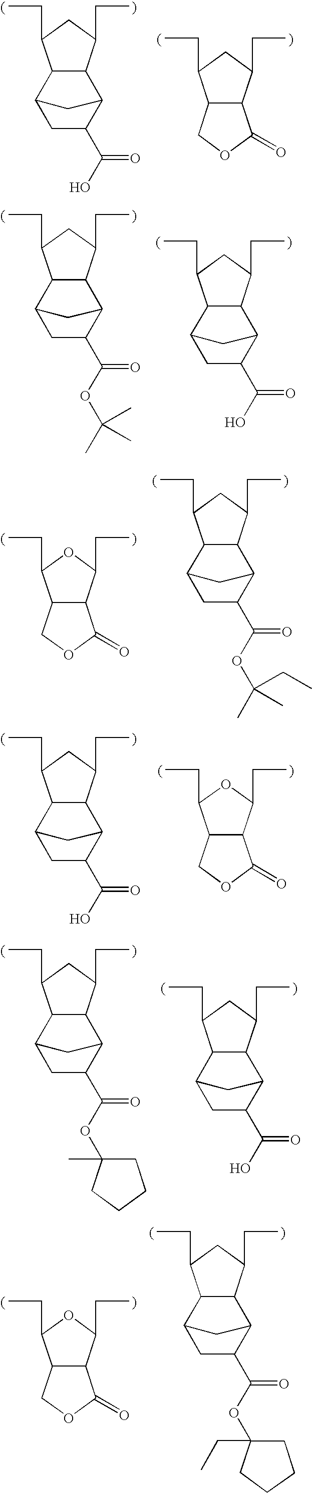

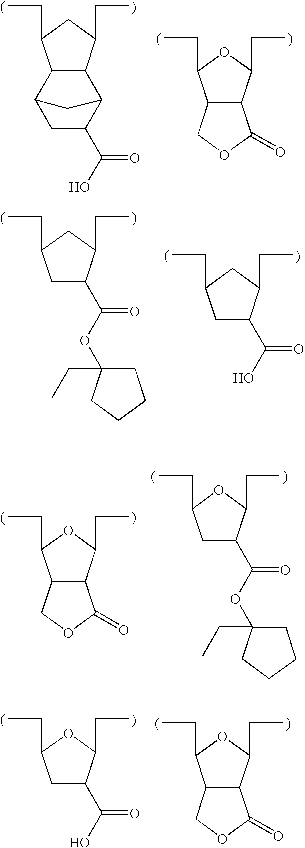

Examples of polymers having formula (R2) are shown below, though not limited thereto.

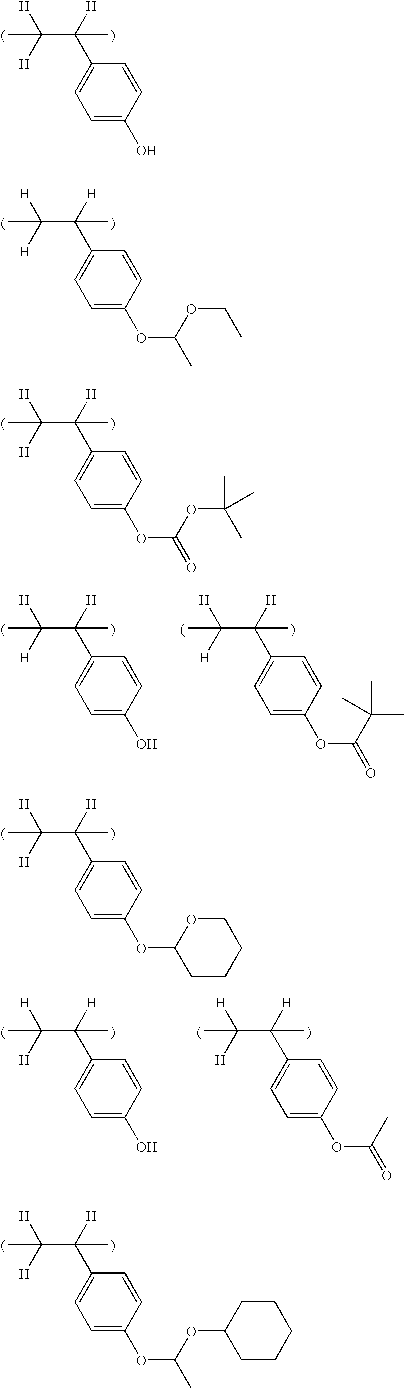

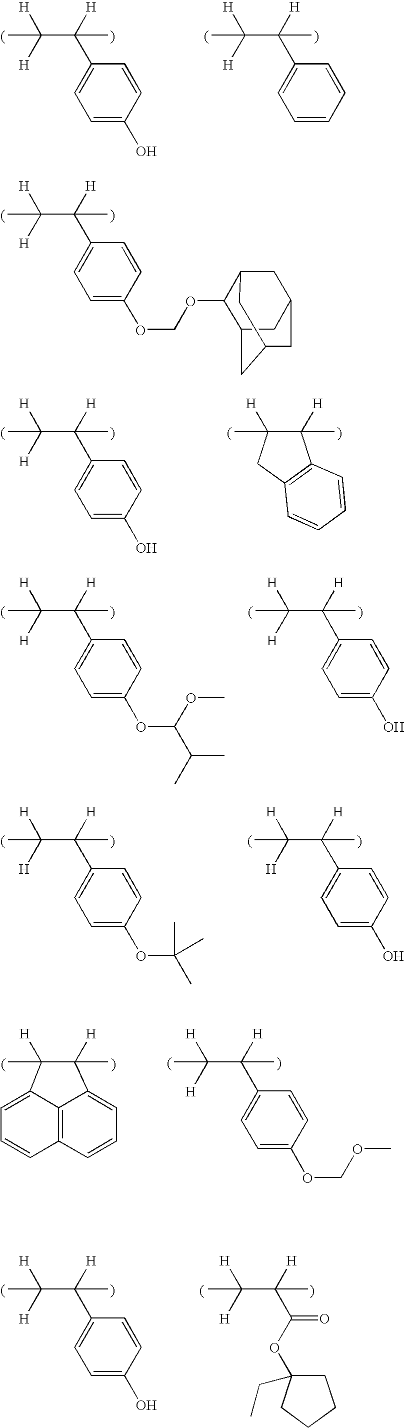

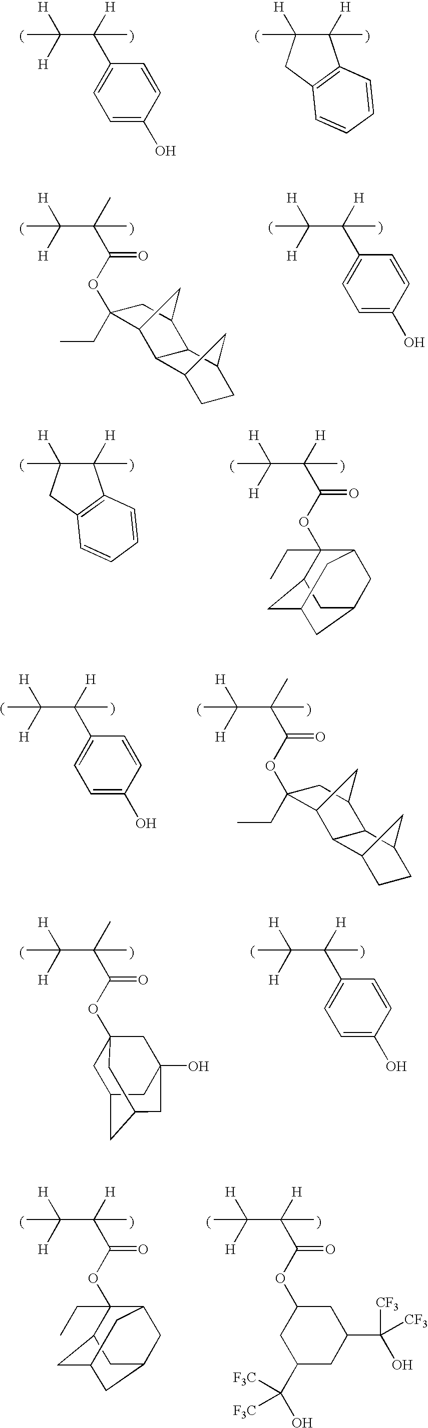

The polymer is not limited to one type and a mixture of two or more polymers may be added. The use of plural polymers allows for easy adjustment of resist properties.

### Component B

Also included in the resist composition of the invention is (B) a compound capable of generating an acid in response to actinic light or radiation. Component (B) may be any compound capable of generating an acid upon exposure of high-energy radiation, which is generally referred to as “photoacid generator,” that is, any of well-known photoacid generators commonly used in resist compositions, especially chemically amplified resist compositions. Suitable photoacid generators include sulfonium salts, iodonium salts, sulfonyldiazomethane, N-sulfonyloxyimide, and oxime-O-sulfonate acid generators. Exemplary acid generators are given below while they may be used alone or in admixture of two or more.

Sulfonium salts are salts of sulfonium cations with sulfonates, bis(substituted alkylsulfonyl)imides and tris(substituted alkylsulfonyl)methides. Exemplary sulfonium cations include triphenylsulfonium, (4-tert-butoxyphenyl)diphenylsulfonium, bis(4-tert-butoxyphenyl)phenylsulfonium, tris(4-tert-butoxyphenyl)sulfonium, (3-tert-butoxyphenyl)diphenylsulfonium, bis(3-tert-butoxyphenyl)phenylsulfonium, tris(3-tert-butoxyphenyl)sulfonium, (3,4-di-tert-butoxyphenyl)diphenylsulfonium, bis(3,4-di-tert-butoxyphenyl)phenylsulfonium, tris(3,4-di-tert-butoxyphenyl)sulfonium, diphenyl(4-thiophenoxyphenyl)sulfonium, (4-tert-butoxycarbonylmethyloxyphenyl)diphenylsulfonium, tris(4-tert-butoxycarbonylmethyloxyphenyl)sulfonium, (4-tert-butoxyphenyl)bis(4-dimethylaminophenyl)sulfonium, tris(4-dimethylaminophenyl)sulfonium, 2-naphthyldiphenylsulfonium, dimethyl-2-naphthylsulfonium, 4-hydroxyphenyldimethylsulfonium, 4-methoxyphenyldimethylsulfonium, trimethylsulfonium, 2-oxocyclohexylcyclohexylmethylsulfonium, trinaphthylsulfonium, tribenzylsulfonium, diphenylmethylsulfonium, dimethylphenylsulfonium, 2-oxo-2-phenylethylthiacyclopentanium, 4-n-butoxynaphthyl-1-thiacyclopentanium, and 2-n-butoxynaphthyl-1-thiacyclopentanium. Exemplary sulfonates include trifluoromethanesulfonate, pentafluoroethanesulfonate, nonafluorobutanesulfonate, dodecafluorohexanesulfonate, pentafluoroethylperfluorocyclohexanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, mesitylenesulfonate, 2,4,6-triisopropylbenzenesulfonate, toluenesulfonate, benzenesulfonate, 4-(4′-toluenesulfonyloxy)benzenesulfonate, naphthalenesulfonate, camphorsulfonate, octanesulfonate, dodecylbenzenesulfonate, butanesulfonate, methanesulfonate, 2-benzoyloxy-1,1,3,3,3-pentafluoropropanesulfonate, 1,1,3,3,3-pentafluoro-2-(4-phenylbenzoyloxy)propanesulfonate, 1,1,3,3,3-pentafluoro-2-pivaloyloxypropanesulfonate, 2-cyclohexanecarbonyloxy-1,1,3,3,3-pentafluoropropanesulfonate, 1,1,3,3,3-pentafluoro-2-furoyloxypropanesulfonate, 2-naphthoyloxy-1,1,3,3,3-pentafluoropropanesulfonate, 2-(4-tert-butylbenzoyloxy)-1,1,3,3,3-pentafluoropropanesulfonate, 2-adamantanecarbonyloxy-1,1,3,3,3-pentafluoropropanesulfonate, 2-acetyloxy-1,1,3,3,3-pentafluoropropanesulfonate, 1,1,3,3,3-pentafluoro-2-hydroxypropanesulfonate, 1,1,3,3,3-pentafluoro-2-tosyloxypropanesulfonate, 1,1-difluoro-2-naphthyl-ethanesulfonate, 1,1,2,2-tetrafluoro-2-(norbornan-2-yl)ethanesulfonate, and 1,1,2,2-tetrafluoro-2-(tetracyclo[4.4.0.1^{2,5}.1^{7,10}]dodec-3-en-8-yl)ethanesulfonate. Exemplary bis(substituted alkylsulfonyl)imides include bistrifluoromethylsulfonylimide, bispentafluoroethylsulfonylimide, bisheptafluoropropylsulfonylimide, and 1,3-propylenebissulfonylimide. A typical tris(substituted alkylsulfonyl)methide is tristrifluoromethylsulfonylmethide. Sulfonium salts based on combination of the foregoing examples are included.

Iodonium salts are salts of iodonium cations with sulfonates, bis(substituted alkylsulfonyl)imides and tris(substituted alkylsulfonyl)methides. Exemplary iodonium cations are aryliodonium cations including diphenyliodinium, bis(4-tert-butylphenyl)iodonium, 4-tert-butoxyphenylphenyliodonium, and 4-methoxyphenylphenyliodonium. Exemplary sulfonates include trifluoromethanesulfonate, pentafluoroethanesulfonate, nonafluorobutanesulfonate, dodecafluorohexanesulfonate, pentafluoroethylperfluorocyclohexanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, mesitylenesulfonate, 2,4,6-triisopropylbenzenesulfonate, toluenesulfonate, benzenesulfonate, 4-(4-toluenesulfonyloxy)benzenesulfonate, naphthalenesulfonate, camphorsulfonate, octanesulfonate, dodecylbenzenesulfonate, butanesulfonate, methanesulfonate, 2-benzoyloxy-1,1,3,3,3-pentafluoropropanesulfonate, 1,1,3,3,3-pentafluoro-2-(4-phenylbenzoyloxy)propanesulfonate, 1,1,3,3,3-pentafluoro-2-pivaloyloxypropanesulfonate, 2-cyclohexanecarbonyloxy-1,1,3,3,3-pentafluoropropanesulfonate, 1,1,3,3,3-pentafluoro-2-furoyloxypropanesulfonate, 2-naphthoyloxy-1,1,3,3,3-pentafluoropropanesulfonate, 2-(4-tert-butylbenzoyloxy)-1,1,3,3,3-pentafluoropropanesulfonate, 2-adamantanecarbonyloxy-1,1,3,3,3-pentafluoropropanesulfonate, 2-acetyloxy-1,1,3,3,3-pentafluoropropanesulfonate, 1,1,3,3,3-pentafluoro-2-hydroxypropanesulfonate, 1,1,3,3,3-pentafluoro-2-tosyloxypropanesulfonate, 1,1-difluoro-2-naphthyl-ethanesulfonate, 1,1,2,2-tetrafluoro-2-(norbornan-2-yl)ethanesulfonate, and 1,1,2,2-tetrafluoro-2-(tetracyclo[4.4.0.1^{2,5}.1^{7,10}]dodec-3-en-8-yl)ethanesulfonate. Exemplary bis(substituted alkylsulfonyl)imides include bistrifluoromethylsulfonylimide, bispentafluoroethylsulfonylimide, bisheptafluoropropylsulfonylimide, and 1,3-propylenebissulfonylimide. A typical tris(substituted alkylsulfonyl)methide is tristrifluoromethylsulfonylmethide. Iodonium salts based on combination of the foregoing examples are included.

Exemplary sulfonyldiazomethane compounds include bissulfonyldiazomethane compounds and sulfonyl-carbonyldiazomethane compounds such as
bis(ethylsulfonyl)diazomethane,
bis(1-methylpropylsulfonyl)diazomethane,
bis(2-methylpropylsulfonyl)diazomethane,
bis(1,1-dimethylethylsulfonyl)diazomethane,
bis(cyclohexylsulfonyl)diazomethane,
bis(perfluoroisopropylsulfonyl)diazomethane,
bis(phenylsulfonyl)diazomethane,
bis(4-methylphenylsulfonyl)diazomethane,
bis(2,4-dimethylphenylsulfonyl)diazomethane,
bis(2-naphthylsulfonyl)diazomethane,
bis(4-acetyloxyphenylsulfonyl)diazomethane,
bis(4-methanesulfonyloxyphenylsulfonyl)diazomethane,
bis(4-(4-toluenesulfonyloxy)phenylsulfonyl)diazomethane,
bis(4-(n-hexyloxy)phenylsulfonyl)diazomethane,
bis(2-methyl-4-(n-hexyloxy)phenylsulfonyl)diazomethane,
bis(2,5-dimethyl-4-(n-hexyloxy)phenylsulfonyl)diazomethane,
bis(3,5-dimethyl-4-(n-hexyloxy)phenylsulfonyl)diazomethane,
bis(2-methyl-5-isopropyl-4-(n-hexyloxy)phenylsulfonyl)diazomethane,
4-methylphenylsulfonylbenzoyldiazomethane,
tert-butylcarbonyl-4-methylphenylsulfonyldiazomethane,
2-naphthylsulfonylbenzoyldiazomethane,
4-methylphenylsulfonyl-2-naphthoyldiazomethane,
methylsulfonylbenzoyldiazomethane, and
tert-butoxycarbonyl-4-methylphenylsulfonyldiazomethane.

N-sulfonyloxyimide photoacid generators include combinations of imide skeletons with sulfonates. Exemplary imide skeletons are succinimide, naphthalene dicarboxylic acid imide, phthalimide, cyclohexyldicarboxylic acid imide, 5-norbornene-2,3-dicarboxylic acid imide, and 7-oxabicyclo[2.2.1]-5-heptene-2,3-dicarboxylic acid imide. Exemplary sulfonates include trifluoromethanesulfonate, pentafluoroethanesulfonate, nonafluorobutanesulfonate, dodecafluorohexanesulfonate, pentafluoroethylperfluorocyclohexanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, mesitylenesulfonate, 2,4,6-triisopropylbenzenesulfonate, toluenesulfonate, benzenesulfonate, naphthalenesulfonate, camphorsulfonate, octanesulfonate, dodecylbenzenesulfonate, butanesulfonate, methanesulfonate, 2-benzoyloxy-1,1,3,3,3-pentafluoropropanesulfonate, 1,1,3,3,3-pentafluoro-2-(4-phenylbenzoyloxy)propanesulfonate, 1,1,3,3,3-pentafluoro-2-pivaloyloxypropanesulfonate, 2-cyclohexanecarbonyloxy-1,1,3,3,3-pentafluoropropanesulfonate, 1,1,3,3,3-pentafluoro-2-furoyloxypropanesulfonate, 2-naphthoyloxy-1,1,3,3,3-pentafluoropropanesulfonate, 2-(4-tert-butylbenzoyloxy)-1,1,3,3,3-pentafluoropropanesulfonate, 2-adamantanecarbonyloxy-1,1,3,3,3-pentafluoropropanesulfonate, 2-acetyloxy-1,1,3,3,3-pentafluoropropanesulfonate, 1,1,3,3,3-pentafluoro-2-hydroxypropanesulfonate, 1,1,3,3,3-pentafluoro-2-tosyloxypropanesulfonate, 1,1-difluoro-2-naphthyl-ethanesulfonate, 1,1,2,2-tetrafluoro-2-(norbornan-2-yl)ethanesulfonate, and 1,1,2,2-tetrafluoro-2-(tetracyclo[4.4.0.1^{2,5}.1^{7,10}]dodec-3-en-8-yl)ethanesulfonate.

Benzoinsulfonate photoacid generators include benzoin tosylate, benzoin mesylate, and benzoin butanesulfonate.

Pyrogallol trisulfonate photoacid generators include pyrogallol, phloroglucinol, catechol, resorcinol, and hydroquinone, in which all the hydroxyl groups are substituted by trifluoromethanesulfonate, pentafluoroethanesulfonate, nonafluorobutanesulfonate, dodecafluorohexanesulfonate, pentafluoroethylperfluorocyclohexanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, toluenesulfonate, benzenesulfonate, naphthalenesulfonate, camphorsulfonate, octanesulfonate, dodecylbenzenesulfonate, butanesulfonate, methanesulfonate, 2-benzoyloxy-1,1,3,3,3-pentafluoropropanesulfonate, 1,1,3,3,3-pentafluoro-2-(4-phenylbenzoyloxy)propanesulfonate, 1,1,3,3,3-pentafluoro-2-pivaloyloxypropanesulfonate, 2-cyclohexanecarbonyloxy-1,1,3,3,3-pentafluoropropanesulfonate, 1,1,3,3,3-pentafluoro-2-furoyloxypropanesulfonate, 2-naphthoyloxy-1,1,3,3,3-pentafluoropropanesulfonate, 2-(4-tert-butylbenzoyloxy)-1,1,3,3,3-pentafluoropropanesulfonate, 2-adamantanecarbonyloxy-1,1,3,3,3-pentafluoropropanesulfonate, 2-acetyloxy-1,1,3,3,3-pentafluoropropanesulfonate, 1,1,3,3,3-pentafluoro-2-hydroxypropanesulfonate, 1,1,3,3,3-pentafluoro-2-tosyloxypropanesulfonate, 1,1-difluoro-2-naphthyl-ethanesulfonate, 1,1,2,2-tetrafluoro-2-(norbornan-2-yl)ethanesulfonate, and 1,1,2,2-tetrafluoro-2-(tetracyclo[4.4.0.1^{2,5}.1^{7,10}]dodec-3-en-8-yl)ethanesulfonate.

Nitrobenzyl sulfonate photoacid generators include 2,4-dinitrobenzyl sulfonate, 2-nitrobenzyl sulfonate, and 2,6-dinitrobenzyl sulfonate, with exemplary sulfonates including trifluoromethanesulfonate, pentafluoroethanesulfonate, nonafluorobutanesulfonate, dodecafluorohexanesulfonate, pentafluoroethylperfluorocyclohexanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, toluenesulfonate, benzenesulfonate, naphthalenesulfonate, camphorsulfonate, octanesulfonate, dodecylbenzenesulfonate, butanesulfonate, methanesulfonate, 2-benzoyloxy-1,1,3,3,3-pentafluoropropanesulfonate, 1,1,3,3,3-pentafluoro-2-(4-phenylbenzoyloxy)propanesulfonate, 1,1,3,3,3-pentafluoro-2-pivaloyloxypropanesulfonate, 2-cyclohexanecarbonyloxy-1,1,3,3,3-pentafluoropropanesulfonate, 1,1,3,3,3-pentafluoro-2-furoyloxypropanesulfonate, 2-naphthoyloxy-1,1,3,3,3-pentafluoropropanesulfonate, 2-(4-tert-butylbenzoyloxy)-1,1,3,3,3-pentafluoropropanesulfonate, 2-adamantanecarbonyloxy-1,1,3,3,3-pentafluoropropanesulfonate, 2-acetyloxy-1,1,3,3,3-pentafluoropropanesulfonate, 1,1,3,3,3-pentafluoro-2-hydroxypropanesulfonate, 1,1,3,3,3-pentafluoro-2-tosyloxypropanesulfonate, 1,1-difluoro-2-naphthyl-ethanesulfonate, 1,1,2,2-tetrafluoro-2-(norbornan-2-yl)ethanesulfonate, and 1,1,2,2-tetrafluoro-2-(tetracyclo[4.4.0.1^{2,5}.1^{7,10}]dodec-3-en-8-yl)ethanesulfonate. Also useful are analogous nitrobenzyl sulfonate compounds in which the nitro group on the benzyl side is substituted by a trifluoromethyl group.

Sulfone photoacid generators include
bis(phenylsulfonyl)methane,
bis(4-methylphenylsulfonyl)methane,
bis(2-naphthylsulfonyl)methane,
2,2-bis(phenylsulfonyl)propane,
2,2-bis(4-methylphenylsulfonyl)propane,
2,2-bis(2-naphthylsulfonyl)propane,
2-methyl-2-(p-toluenesulfonyl)propiophenone,
2-cyclohexylcarbonyl-2-(p-toluenesulfonyl)propane, and
2,4-dimethyl-2-(p-toluenesulfonyl)pentan-3-one.

Photoacid generators in the form of glyoxime derivatives are described in Japanese Patent No. 2,906,999 and JP-A 9-301948 and include
bis-O-(p-toluenesulfonyl)-α-dimethylglyoxime,
bis-O-(p-toluenesulfonyl)-α-diphenylglyoxime,
bis-O-(p-toluenesulfonyl)-α-dicyclohexylglyoxime,
bis-O-(p-toluenesulfonyl)-2,3-pentanedioneglyoxime,
bis-O-(n-butanesulfonyl)-α-dimethylglyoxime,
bis-O-(n-butanesulfonyl)-α-diphenylglyoxime,
bis-O-(n-butanesulfonyl)-α-dicyclohexylglyoxime,
bis-O-(methanesulfonyl)-α-dimethylglyoxime,
bis-O-(trifluoromethanesulfonyl)-α-dimethylglyoxime,
bis-O-(2,2,2-trifluoroethanesulfonyl)-α-dimethylglyoxime,
bis-O-(10-camphorsulfonyl)-α-dimethylglyoxime,
bis-O-(benzenesulfonyl)-α-dimethylglyoxime,
bis-O-(p-fluorobenzenesulfonyl)-α-dimethylglyoxime,
bis-O-(p-trifluoromethylbenzenesulfonyl)-α-dimethylglyoxime,
bis-O-(xylenesulfonyl)-α-dimethylglyoxime,
bis-O-(trifluoromethanesulfonyl)-nioxime,
bis-O-(2,2,2-trifluoroethanesulfonyl)-nioxime,
bis-O-(10-camphorsulfonyl)-nioxime,
bis-O-(benzenesulfonyl)-nioxime,
bis-O-(p-fluorobenzenesulfonyl)-nioxime,
bis-O-(p-trifluoromethylbenzenesulfonyl)-nioxime, and
bis-O-(xylenesulfonyl)-nioxime.

Also included are the oxime sulfonates described in U.S. Pat. No. 6,004,724, for example, (5-(4-toluenesulfonyl)oxyimino-5H-thiophen-2-ylidene)phenylacetonitrile, (5-(10-camphorsulfonyl)oxyimino-5H-thiophen-2-ylidene)phenylacetonitrile, (5-n-octanesulfonyloxyimino-5H-thiophen-2-ylidene)phenylacetonitrile, (5-(4-toluenesulfonyl)oxyimino-5H-thiophen-2-ylidene)(2-methylphenyl)acetonitrile, (5-(10-camphorsulfonyl)oxyimino-5H-thiophen-2-ylidene)(2-methylphenyl)acetonitrile, (5-n-octanesulfonyloxyimino-5H-thiophen-2-ylidene)(2-methylphenyl)acetonitrile, etc. Also included are the oxime sulfonates described in U.S. Pat. No. 6,916,591, for example, (5-(4-(4-toluenesulfonyloxy)benzenesulfonyl)oxyimino-5H-thiophen-2-ylidene)phenylacetonitrile and (5-(2,5-bis(4-toluenesulfonyloxy)benzenesulfonyl)oxyimino-5H-thiophen-2-ylidene)phenylacetonitrile.

Also included are the oxime sulfonates described in U.S. Pat. No. 6,261,738 and JP-A 2000-314956, for example, 2,2,2-trifluoro-1-phenyl-ethanone oxime-O-methylsulfonate; 2,2,2-trifluoro-1-phenyl-ethanone oxime-O-(10-camphorylsulfonate); 2,2,2-trifluoro-1-phenyl-ethanone oxime-O-(4-methoxyphenylsulfonate); 2,2,2-trifluoro-1-phenyl-ethanone oxime-O-(1-naphthylsulfonate); 2,2,2-trifluoro-1-phenylethanone oxime-O-(2-naphthylsulfonate); 2,2,2-trifluoro-1-phenyl-ethanone oxime-O-(2,4,6-trimethylphenylsulfonate); 2,2,2-trifluoro-1-(4-methylphenyl)-ethanone oxime-O-(10-camphorylsulfonate); 2,2,2-trifluoro-1-(4-methylphenyl)-ethanone oxime-O-(methylsulfonate); 2,2,2-trifluoro-1-(2-methylphenyl)-ethanone oxime-O-(10-camphorylsulfonate); 2,2,2-trifluoro-1-(2,4-dimethylphenyl)-ethanone oxime-O-(10-camphorylsulfonate); 2,2,2-trifluoro-1-(2,4-dimethylphenyl)-ethanone oxime-O-(1-naphthylsulfonate); 2,2,2-trifluoro-1-(2,4-dimethylphenyl)-ethanone oxime-O-(2-naphthylsulfonate); 2,2,2-trifluoro-1-(2,4,6-trimethylphenyl)-ethanone oxime-O-(10-camphorylsulfonate); 2,2,2-trifluoro-1-(2,4,6-trimethylphenyl)-ethanone oxime-O-(1-naphthylsulfonate); 2,2,2-trifluoro-1-(2,4,6-trimethylphenyl)-ethanone oxime-O-(2-naphthylsulfonate); 2,2,2-trifluoro-1-(4-methoxyphenyl)-ethanone oxime-O-methylsulfonate; 2,2,2-trifluoro-1-(4-methylthiophenyl)-ethanone oxime-O-methylsulfonate; 2,2,2-trifluoro-1-(3,4-dimethoxyphenyl)-ethanone oxime-O-methylsulfonate; 2,2,3,3,4,4,4-heptafluoro-1-phenyl-butanone oxime-O-(10-camphorylsulfonate); 2,2,2-trifluoro-1-(phenyl)-ethanone oxime-O-methylsulfonate; 2,2,2-trifluoro-1-(phenyl)-ethanone oxime-O-10-camphorylsulfonate; 2,2,2-trifluoro-1-(phenyl)-ethanone oxime-O-(4-methoxyphenyl)sulfonate; 2,2,2-trifluoro-1-(phenyl)-ethanone oxime-O-(1-naphthyl)sulfonate; 2,2,2-trifluoro-1-(phenyl)-ethanone oxime-O-(2-naphthyl)sulfonate; 2,2,2-trifluoro-1-(phenyl)-ethanone oxime-O-(2,4,6-trimethylphenyl)sulfonate; 2,2,2-trifluoro-1-(4-methylphenyl)-ethanone oxime-O-(10-camphoryl)sulfonate; 2,2,2-trifluoro-1-(4-methylphenyl)-ethanone oxime-O-methylsulfonate; 2,2,2-trifluoro-1-(2-methylphenyl)-ethanone oxime-O-(10-camphoryl)sulfonate; 2,2,2-trifluoro-1-(2,4-dimethylphenyl)-ethanone oxime-O-(1-naphthyl)sulfonate; 2,2,2-trifluoro-1-(2,4-dimethylphenyl)-ethanone oxime-O-(2-naphthyl)sulfonate; 2,2,2-trifluoro-1-(2,4,6-trimethylphenyl)-ethanone oxime-O-(10-camphoryl)-sulfonate; 2,2,2-trifluoro-1-(2,4,6-trimethylphenyl)-ethanone oxime-O-(1-naphthyl)sulfonate; 2,2,2-trifluoro-1-(2,4,6-trimethylphenyl)-ethanone oxime-O-(2-naphthyl)-sulfonate; 2,2,2-trifluoro-1-(4-methoxyphenyl)-ethanone oxime-O-methylsulfonate; 2,2,2-trifluoro-1-(4-thiomethyl-phenyl)-ethanone oxime-O-methylsulfonate; 2,2,2-trifluoro-1-(3,4-dimethoxyphenyl)-ethanone oxime-O-methylsulfonate; 2,2,2-trifluoro-1-(4-methoxyphenyl)-ethanone oxime-O-(4-methylphenyl)sulfonate; 2,2,2-trifluoro-1-(4-methoxyphenyl)-ethanone oxime-O-(4-methoxyphenyl)sulfonate; 2,2,2-trifluoro-1-(4-methoxyphenyl)-ethanone oxime-O-(4-dodecylphenyl)sulfonate; 2,2,2-trifluoro-1-(4-methoxy-phenyl)-ethanone oxime-O-octylsulfonate; 2,2,2-trifluoro-1-(4-thiomethylphenyl)-ethanone oxime-O-(4-methoxyphenyl)-sulfonate; 2,2,2-trifluoro-1-(4-thiomethylphenyl)-ethanone oxime-O-(4-dodecylphenyl)sulfonate; 2,2,2-trifluoro-1-(4-thiomethylphenyl)-ethanone oxime-O-octylsulfonate; 2,2,2-trifluoro-1-(4-thiomethylphenyl)-ethanone oxime-O-(2-naphthyl)sulfonate; 2,2,2-trifluoro-1-(2-methylphenyl)-ethanone oxime-O-methylsulfonate; 2,2,2-trifluoro-1-(4-methylphenyl)ethanone oxime-O-phenylsulfonate; 2,2,2-trifluoro-1-(4-chlorophenyl)-ethanone oxime-O-phenylsulfonate; 2,2,3,3,4,4,4-heptafluoro-1-(phenyl)-butanone oxime-O-(10-camphoryl)sulfonate; 2,2,2-trifluoro-1-naphthylethanone oxime-O-methylsulfonate; 2,2,2-trifluoro-2-naphthyl-ethanone oxime-O-methylsulfonate; 2,2,2-trifluoro-1-[4-benzylphenyl]-ethanone oxime-O-methylsulfonate; 2,2,2-trifluoro-1-[4-(phenyl-1,4-dioxa-but-1-yl)phenyl]-ethanone oxime-O-methylsulfonate; 2,2,2-trifluoro-1-naphthyl-ethanone oxime-O-propylsulfonate; 2,2,2-trifluoro-2-naphthyl-ethanone oxime-O-propylsulfonate; 2,2,2-trifluoro-1-[4-benzylphenyl]-ethanone oxime-O-propylsulfonate; 2,2,2-trifluoro-1-[4-methylsulfonylphenyl]-ethanone oxime-O-propylsulfonate; 1,3-bis[1-(4-phenoxyphenyl)-2,2,2-trifluoroethanone oxime-O-sulfonyl]phenyl; 2,2,2-trifluoro-1-[4-methylsulfonyloxyphenyl]-ethanone oxime-O-propylsulfonate; 2,2,2-trifluoro-1-[4-methylcarbonyloxyphenyl]-ethanone oxime-O-propylsulfonate; 2,2,2-trifluoro-1-[6H,7H-5,8-dioxonaphth-2-yl]-ethanone oxime-O-propylsulfonate; 2,2,2-trifluoro-1-[4-methoxycarbonylmethoxyphenyl]-ethanone oxime-O-propylsulfonate; 2,2,2-trifluoro-1-[4-(methoxycarbonyl)-(4-amino-1-oxa-pent-1-yl)-phenyl]-ethanone oxime-O-propylsulfonate; 2,2,2-trifluoro-1-[3,5-dimethyl-4-ethoxyphenyl]-ethanone oxime-O-propylsulfonate; 2,2,2-trifluoro-1-[4-benzyloxyphenyl]-ethanone oxime-O-propylsulfonate; 2,2,2-trifluoro-1-[2-thiophenyl]-ethanone oxime-O-propylsulfonate; 2,2,2-trifluoro-1-[1-dioxa-thiophen-2-yl)]-ethanone oxime-O-propylsulfonate; 2,2,2-trifluoro-1-(4-(3-(4-(2,2,2-trifluoro-1-(trifluoromethanesulfonyloxyimino)-ethyl)-phenoxy)-propoxy)-phenyl)ethanone oxime(trifluoromethanesulfonate); 2,2,2-trifluoro-1-(4-(3-(4-(2,2,2-trifluoro-1-(1-propanesulfonyloxyimino)-ethyl)-phenoxy)-propoxy)-phenyl)ethanone oxime(1-propanesulfonate); and 2,2,2-trifluoro-1-(4-(3-(4-(2,2,2-trifluoro-1-(1-butanesulfonyloxyimino)-ethyl)-phenoxy)-propoxy)-phenyl)ethanone oxime(1-butanesulfonate). Also included are the oxime sulfonates described in U.S. Pat. No. 6,916,591, for example, 2,2,2-trifluoro-1-(4-(3-(4-(2,2,2-trifluoro-1-(4-(4-methylphenylsulfonyloxy)phenylsulfonyloxyimino)-ethyl)-phenoxy)-propoxy)-phenyl)ethanone oxime(4-(4-methylphenylsulfonyloxy)phenylsulfonate) and 2,2,2-trifluoro-1-(4-(3-(4-(2,2,2-trifluoro-1-(2,5-bis(4-methylphenylsulfonyloxy)-benzenesulfonyloxy)phenylsulfonyloxyimino)-ethyl)-phenoxy)-propoxy)-phenyl)ethanone oxime(2,5-bis(4-methylphenylsulfonyloxy)benzenesulfonyloxy)phenylsulfonate).

Also included are the oxime sulfonates described in JP-A 9-95479 and JP-A 9-230588 and the references cited therein, for example,
α-(p-toluenesulfonyloxyimino)-phenylacetonitrile,
α-(p-chlorobenzenesulfonyloxyimino)-phenylacetonitrile,
α-(4-nitrobenzenesulfonyloxyimino)-phenylacetonitrile,
α-(4-nitro-2-trifluoromethylbenzenesulfonyloxyimino)-phenylacetonitrile,
α-(benzenesulfonyloxyimino)-4-chlorophenylacetonitrile,
α-(benzenesulfonyloxyimino)-2,4-dichlorophenylacetonitrile,
α-(benzenesulfonyloxyimino)-2,6-dichlorophenylacetonitrile,
α-(benzenesulfonyloxyimino)-4-methoxyphenylacetonitrile,
α-(2-chlorobenzenesulfonyloxyimino)-4-methoxyphenylacetonitrile,
α-(benzenesulfonyloxyimino)-2-thienylacetonitrile,
α-(4-dodecylbenzenesulfonyloxyimino)-phenylacetonitrile,
α-[(4-toluenesulfonyloxyimino)-4-methoxyphenyl]acetonitrile,
α-[(dodecylbenzenesulfonyloxyimino)-4-methoxyphenyl]acetonitrile,
α-(tosyloxyimino)-3-thienylacetonitrile,
α-(methylsulfonyloxyimino)-1-cyclopentenylacetonitrile,
α-(ethylsulfonyloxyimino)-1-cyclopentenylacetonitrile,
α-(isopropylsulfonyloxyimino)-1-cyclopentenylacetonitrile,
α-(n-butylsulfonyloxyimino)-1-cyclopentenylacetonitrile,
α-(ethylsulfonyloxyimino)-1-cyclohexenylacetonitrile,
α-(isopropylsulfonyloxyimino)-1-cyclohexenylacetonitrile,
and α-(n-butylsulfonyloxyimino)-1-cyclohexenyladetonitrile.

Also included are oxime sulfonates having the formula:

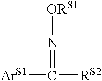

wherein R^{s1} is a substituted or unsubstituted haloalkylsulfonyl or halobenzenesulfonyl group of 1 to 10 carbon atoms, R^{s2} is a haloalkyl group of 1 to 11 carbon atoms, and Ar^{s1} is substituted or unsubstituted aromatic or hetero-aromatic group, as described in WO 2004/074242. Examples include
2-[2,2,3,3,4,4,5,5-octafluoro-1-(nonafluorobutylsulfonyloxyimino)-pentyl]-fluorene,
2-[2,2,3,3,4,4-pentafluoro-1-(nonafluorobutylsulfonyloxyimino)-butyl]-fluorene,
2-[2,2,3,3,4,4,5,5,6,6-decafluoro-1-(nonafluorobutylsulfonyloxyimino)-hexyl]-fluorene,
2-[2,2,3,3,4,4,5,5-octafluoro-1-(nonafluorobutylsulfonyloxyimino)-pentyl]-4-biphenyl,
2-[2,2,3,3,4,4-pentafluoro-1-(nonafluorobutylsulfonyloxyimino)-butyl]-4-biphenyl, and
2-[2,2,3,3,4,4,5,5,6,6-decafluoro-1-(nonafluorobutylsulfonyloxyimino)-hexyl]-4-biphenyl.

Suitable bisoxime sulfonates include those described in JP-A 9-208554, for example,
bis(α-(4-toluenesulfonyloxy)imino)-p-phenylenediacetonitrile,
bis(α-(benzenesulfonyloxy)imino)-p-phenylenediacetonitrile,
bis(α-(methanesulfonyloxy)imino)-p-phenylenediacetonitrile,
bis(α-(butanesulfonyloxy)imino)-p-phenylenediacetonitrile,
bis(α-(10-camphorsulfonyloxy)imino)-p-phenylenediacetonitrile,
bis(α-(4-toluenesulfonyloxy)imino)-p-phenylenediacetonitrile,
bis(α-(trifluoromethanesulfonyloxy)imino)-p-phenylenediacetonitrile,
bis(α-(4-methoxybenzenesulfonyloxy)imino)-p-phenylenediacetonitrile,
bis(α-(4-toluenesulfonyloxy)imino)-m-phenylenediacetonitrile,
bis(α-(benzenesulfonyloxy)imino)-m-phenylenediacetonitrile,
bis(α-(methanesulfonyloxy)imino)-m-phenylenediacetonitrile,
bis(α-(butanesulfonyloxy)imino)-m-phenylenediacetonitrile,
bis(α-(10-camphorsulfonyloxy)imino)-m-phenylenediacetonitrile,
bis(α-(4-toluenesulfonyloxy)imino)-m-phenylenediacetonitrile,
bis(α-(trifluoromethanesulfonyloxy)imino)-m-phenylenediacetonitrile,
bis(α-(4-methoxybenzenesulfonyloxy)imino)-m-phenylenediacetonitrile, etc.

Of these, preferred photoacid generators are sulfonium salts, bissulfonyldiazomethanes, N-sulfonyloxyimides, oxime-O-sulfonates and glyoxime derivatives. More preferred photoacid generators are sulfonium salts, bissulfonyldiazomethanes, N-sulfonyloxyimides, and oxime-O-sulfonates. Typical examples include triphenylsulfonium p-toluenesulfonate, triphenylsulfonium camphorsulfonate, triphenylsulfonium pentafluorobenzenesulfonate, triphenylsulfonium nonafluorobutanesulfonate, triphenylsulfonium 4-(4′-toluenesulfonyloxy)benzenesulfonate, triphenylsulfonium 2,4,6-triisopropylbenzenesulfonate, 4-tert-butoxyphenyldiphenylsulfonium p-toluenesulfonate, 4-tert-butoxyphenyldiphenylsulfonium camphorsulfonate, 4-tert-butoxyphenyldiphenylsulfonium 4-(4′-toluenesulfonyloxy)benzenesulfonate, tris(4-methylphenyl)sulfonium camphorsulfonate, tris(4-tert-butylphenyl)sulfonium camphorsulfonate, 4-tert-butylphenyldiphenylsulfonium camphorsulfonate, 4-tert-butylphenyldiphenylsulfonium nonafluoro-1-butanesulfonate, 4-tert-butylphenyldiphenylsulfonium pentafluoroethylperfluorocyclohexanesulfonate, 4-tert-butylphenyldiphenylsulfonium perfluoro-1-octanesulfonate, triphenylsulfonium 1,1-difluoro-2-naphthyl-ethanesulfonate, triphenylsulfonium 1,1,2,2-tetrafluoro-2-(norbornan-2-yl)-ethanesulfonate, bis(tert-butylsulfonyl)diazomethane, bis(cyclohexylsulfonyl)diazomethane, bis(2,4-dimethylphenylsulfonyl)diazomethane, bis(4-(n-hexyloxy)phenylsulfonyl)diazomethane, bis(2-methyl-4-(n-hexyloxy)phenylsulfonyl)diazomethane, bis(2,5-dimethyl-4-(n-hexyloxy)phenylsulfonyl)diazomethane, bis(3,5-dimethyl-4-(n-hexyloxy)phenylsulfonyl)diazomethane, bis(2-methyl-5-isopropyl-4-(n-hexyloxy)phenylsulfonyl)-diazomethane, bis(4-tert-butylphenylsulfonyl)diazomethane, N-camphorsulfonyloxy-5-norbornene-2,3-dicarboxylic acid imide, N-p-toluenesulfonyloxy-5-norbornene-2,3-dicarboxylic acid imide, 2-[2,2,3,3,4,4,5,5-octafluoro-1-(nonafluorobutylsulfonyloxyimino)-pentyl]-fluorene, 2-[2,2,3,3,4,4-pentafluoro-1-(nonafluorobutylsulfonyloxyimino)-butyl]-fluorene, and 2-[2,2,3,3,4,4,5,5,6,6-decafluoro-1-(nonafluorobutylsulfonyloxyimino)-hexyl]-fluorene.

In the chemically amplified resist composition, an appropriate amount of the photoacid generator (B) is, but not limited to, 0.1 to 40 parts, and especially 0.1 to 20 parts by weight per 100 parts by weight of the base polymer. Too high a proportion of the photoacid generator may give rise to problems of degraded resolution and foreign matter upon development and resist film peeling. The photoacid generators may be used alone or in admixture of two or more. The transmittance of the resist film can be controlled by using a photoacid generator having a low transmittance at the exposure wavelength and adjusting the amount of the photoacid generator added.

In the resist composition, there may be added a compound which is decomposed with an acid to generate another acid, that is, acid-amplifier compound. For these compounds, reference should be made to J. Photopolym. Sci. and Tech., 8, 43-44, 45-46 (1995), and ibid., 9, 29-30 (1996).

Examples of the acid-amplifier compound include tert-butyl-2-methyl-2-tosyloxymethyl acetoacetate and 2-phenyl-2-(2-tosyloxyethyl)-1,3-dioxolane, but are not limited thereto. Of well-known photoacid generators, many of those compounds having poor stability, especially poor thermal stability exhibit an acid amplifier-like behavior.

In the resist composition, an appropriate amount of the acid-amplifier compound is 0 to 2 parts, and preferably 0 to 1 part by weight per 100 parts by weight of the base polymer. Excessive amounts of the acid-amplifier compound make diffusion control difficult, leading to degradation of resolution and pattern profile.

### Component C

Also included in the resist composition of the invention is (C) at least one acidic organic compound having a molecular weight of at least 150. The inclusion of the acidic organic compound (C) minimizes defects on the substrate.

The preferred acidic organic compounds have the general formula (1) or (2).

R¹—X (1)

In formula (1), R¹ is a straight or branched monovalent organic group which is free of double bonds and atoms other than carbon, hydrogen and oxygen in its structure, and X is —SO₃H or —CO₂H.

R¹ is a straight or branched monovalent organic group which contains neither double bonds nor atoms other than carbon, hydrogen and oxygen in its structure, preferably a monovalent group consisting of methyl, methylene, methine moieties and/or ether bonds. Examples of the acidic organic compounds of formula (1) having a molecular weight of at least 150 include, but are not limited to, 2-methyloctanesulfonic acid, 1-ethylheptanesulfonic acid, 1-methoxyhexanesulfonic acid, 1-methoxyoctanesulfonic acid, 7-methyloctanesulfonic acid, 1,1-dimethylnonanesulfonic acid, 1-ethyltetracontanesulfonic acid, 2-methylnonanoic acid, 1-ethyloctanoic acid, 1-methoxyheptanoic acid, 1-methoxynonanoic acid, 7-methylnonanoic acid, 1,1-dimethyldecanoic acid, and 1-ethyltetracontanoic acid as well as examples of the acidic organic compound of formula (2) which are illustrated later.

CH₃(A)ₙCH₂—X (2)

In formula (2), A is a methylene group, some of the number “n” of methylene groups may be replaced by oxygen atoms, with the proviso that when some methylene groups are replaced by oxygen atoms, a structure in which two oxygen atoms adjoin is excluded, n is an integer from 3 to 100, and X is —SO₃H or —CO₂H.

The subscript n is an integer in the range: 3≦n≦100. That is, formula (2) represents straight saturated fatty acids of 6 to 103 carbon atoms and straight saturated alkane sulfonic acids of 5 to 102 carbon atoms. Examples of the acidic organic compounds of formula (2) having a molecular weight of at least 150 include, but are not limited to, compounds of the following formulae.
n-C₅H₁₁SO₃H, n-C₆H₁₃SO₃H, n-C₇H₁₅SO₃H, n-C₈H₁₇SO₃H, n-C₉H₁₉SO₃H, n-C₁₀H₂₁SO₃H, n-C₁₂H₂₅SO₃H, n-C₁₄H₂₉SO₃H, n-C₁₆H₃₃SO₃H, n-C₁₀₂H₂₀₅SO₃H, C₂H₅OCH₂CH₂SO₃H, n-C₄H₉OCH₂CH₂SO₃H, n-C₁₂H₂₅₀CH₂CH₂SO₃H, n-C₉₉H₁₉₉OCH₂CH₂SO₃H, C₂H₅OCH₂CH₂OCH₂CH₂SO₃H, n-C₈H₁₇CO₂H, n-C₉H₁₉CO₂H, n-C₁₀H₂₁CO₂H, n-C₁₁H₂₃CO₂H, n-C₁₂H₂₅CO₂H, n-C₁₃H₂₇CO₂H, n-C₁₄H₂₉CO₂H, n-C₁₅H₃₁CO₂H, n-C₁₆H₃₃CO₂H, n-C₁₇H₃₅CO₂H, n-C₁₈H₃₇CO₂H, n-C₁₉H₃₉CO₂H, n-C₂₀H₄₁CO₂H, n-C₂₁H₄₃CO₂H, n-C₂₂H₄₁CO₂H, n-C₂₃H₄₇CO₂H, n-C₂₄H₄₉CO₂H, n-C₂₆H₁₃CO₂H, n-C₂₇H₅₅CO₂H, n-C₂₈H₇CO₂H, n-C₃₀H₆CO₂H, n-C₄₀H₈₁CO₂H, n-C₆₀H₁₂₁CO₂H, n-C₈₀H₁₆₁CO₂H, n-C₁₀₂H₂₀₅CO₂H, n-C₇H, OCH₂CO₂H, n-C₈H₁₇OCH₂CO₂H, n-C₁₀H₂₁OCH₂CO₂H, n-C₁₂H₂₅OCH₂CO₂H, n-C₁₄H₂₉₀CH₂CO₂H, n-C₁₆H₃₃OCH₂CO₂H, n —C₁₈H₃₇OCH₂CO₂H, n —C₂₀H₄₁OCH₂CO₂H, n-C₄₀H₈₁₀CH₂CO₂H, n-C₁₀₀H₂₁₁OCH₂CO₂H, CH₃OCH₂CH₂OCH₂CH₂OCH₂CO₂H, CH₃OCH₂CH₂OCH₂CH₂OCH₂CH₂OCH₂CO₂H, CH₃OCH₂CH₂OCH₂CH₂OCH₂CH₂OCH₂CH₂OCH₂CO₂H, C₂H₅OCH₂CH₂OCH₂CH₂OCH₂CO₂H, n-C₄H₉OCH₂CH₂OCH₂CH₂OCH₂CO₂H, n-C₆H₁₃OCH₂CH₂OCH₂CH₂OCH₂CO₂H

The acidic organic compound (C) should have a molecular weight of at least 150. Compounds with a molecular weight below 150 are insufficient in reducing defects. The upper limit of molecular weight is generally equal to or less than 3,000, and preferably equal to or less than 2,000.

In the resist composition, an appropriate amount of the acidic organic compound (C) is from more than 0 to 10 parts by weight, and preferably from more than 0 to 5 parts by weight per 100 parts by weight of the base polymer. Preferably the amount of the acidic organic compound added is at least 0.1 part by weight, and more preferably at least 0.3 parts by weight. Excessive amounts of the acidic organic compound may cause degradation of resolution and pattern profile.

The acidic organic compound (C) may exert better addition effects particularly when the resin component (A) contains acidic recurring units.

The acidic recurring units include units having a partial structure such as carboxylic acid or partially or overall fluorine-substituted alcohol. Examples include, but are not limited to, units derived from acrylic acid, methacrylic acid, acryloyloxycyclohexanecarboxylic acid, methacryloyloxycyclohexanecarboxylic acid, methacryloyloxybicyclo[2.2.1]heptanecarboxylic acid, methacryloyloxytricyclo[5.2.1.0^{2,6}]decanecarboxylic acid, methacryloyloxytetracyclo[4.4.0.1^{2,5}.1^{7,10}]dodecanecarboxylic acid, [2,2,2-trifluoro-1-hydroxy-1-(trifluoromethyl)ethyl]-cyclohexyl acrylate, [2,2,2-trifluoro-1-hydroxy-1-(trifluoromethyl)ethyl]-cyclohexyl methacrylate, bis[2,2,2-trifluoro-1-hydroxy-1-(trifluoromethyl)ethyl]-cyclohexyl acrylate, and bis[2,2,2-trifluoro-1-hydroxy-1-(trifluoromethyl)ethyl]-cyclohexyl methacrylate. A proportion of acidic recurring units incorporated is preferably 0 to 30 mol %, and more preferably 0 to 20 mol % based on the resin (A).

Resins comprising acidic recurring units have a higher polarity than resins free of such units. In general, the substrate has a higher polarity than a resist film and a resin of which the resist film is formed. Incorporating acidic recurring units in a resin provides a polarity approximate to that of the substrate, increasing the tendency that residues resulting from the resin are left on the substrate.

In addition to the above-described components (A), (B) and (C), the resist composition of the invention may further comprise (D) an organic solvent, and optionally, (E) a nitrogen-containing organic compound, (F) a surfactant, and (G) other components.

### Component D

The organic solvent (D) used herein may be any organic solvent in which the base resin, photoacid generator, and other components are soluble. Illustrative, non-limiting, examples of the organic solvent include ketones such as cyclohexanone and methyl amyl ketone; alcohols such as 3-methoxybutanol, 3-methyl-3-methoxybutanol, 1-methoxy-2-propanol, and 1-ethoxy-2-propanol; ethers such as propylene glycol monomethyl ether, ethylene glycol monomethyl ether, propylene glycol monoethyl ether, ethylene glycol monoethyl ether, propylene glycol dimethyl ether, and diethylene glycol dimethyl ether; esters such as propylene glycol monomethyl ether acetate (PGMEA), propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate, and propylene glycol mono-tert-butyl ether acetate; and lactones such as γ-butyrolactone. These solvents may be used alone or in combinations of two or more thereof. Of the above organic solvents, it is recommended to use diethylene glycol dimethyl ether, 1-ethoxy-2-propanol, propylene glycol monomethyl ether acetate, and mixtures thereof because the acid generator is most soluble therein.

An appropriate amount of the organic solvent used is about 200 to 3,000 parts, especially about 400 to 2,500 parts by weight per 100 parts by weight of the base polymer.

### Component E

In the resist composition, (E) an organic nitrogen-containing compound or compounds may be compounded. The organic nitrogen-containing compound used herein is preferably a compound capable of suppressing the rate of diffusion when the acid generated by the acid generator diffuses within the resist film. The inclusion of this type of organic nitrogen-containing compound holds down the rate of acid diffusion within the resist film, resulting in better resolution. In addition, it suppresses changes in sensitivity following exposure and reduces substrate and environment dependence, as well as improving the exposure latitude and the pattern profile.

The organic nitrogen-containing compound may be any of well-known organic nitrogen-containing compounds commonly used in resist compositions, especially chemically amplified resist compositions. Typical compounds include primary, secondary, and tertiary aliphatic amines, mixed amines, aromatic amines, heterocyclic amines, nitrogen-containing compounds having carboxyl group, nitrogen-containing compounds having sulfonyl group, nitrogen-containing compounds having hydroxyl group, nitrogen-containing compounds having hydroxyphenyl group, alcoholic nitrogen-containing compounds, amide derivatives, imide derivatives, and carbamate derivatives.

Examples of suitable primary aliphatic amines include ammonia, methylamine, ethylamine, n-propylamine, isopropylamine, n-butylamine, isobutylamine, sec-butylamine, tert-butylamine, pentylamine, tert-amylamine, cyclopentylamine, hexylamine, cyclohexylamine, heptylamine, octylamine, nonylamine, decylamine, dodecylamine, cetylamine, methylenediamine, ethylenediamine, and tetraethylenepentamine. Examples of suitable secondary aliphatic amines include dimethylamine, diethylamine, di-n-propylamine, diisopropylamine, di-n-butylamine, diisobutylamine, di-sec-butylamine, dipentylamine, dicyclopentylamine, dihexylamine, dicyclohexylamine, diheptylamine, dioctylamine, dinonylamine, didecylamine, didodecylamine, dicetylamine, N,N-dimethylmethylenediamine, N,N-dimethylethylenediamine, and N,N-dimethyltetraethylenepentamine. Examples of suitable tertiary aliphatic amines include trimethylamine, triethylamine, tri-n-propylamine, triisopropylamine, tri-n-butylamine, triisobutylamine, tri-sec-butylamine, tripentylamine, tricyclopentylamine, trihexylamine, tricyclohexylamine, triheptylamine, trioctylamine, trinonylamine, tridecylamine, tridodecylamine, tricetylamine, N,N,N′,N′-tetramethylmethylenediamine, N,N,N′,N′-tetramethylethylenediamine, and N,N,N′,N′-tetramethyltetraethylenepentamine.

Examples of suitable mixed amines include dimethylethylamine, methylethylpropylamine, benzylamine, phenethylamine, and benzyldimethylamine. Examples of suitable aromatic and heterocyclic amines include aniline derivatives (e.g., aniline, N-methylaniline, N-ethylaniline, N-propylaniline, N,N-dimethylaniline, 2-methylaniline, 3-methylaniline, 4-methylaniline, ethylaniline, propylaniline, trimethylaniline, 2-nitroaniline, 3-nitroaniline, 4-nitroaniline, 2,4-dinitroaniline, 2,6-dinitroaniline, 3,5-dinitroaniline, and N,N-dimethyltoluidine), diphenyl(p-tolyl)amine, methyldiphenylamine, triphenylamine, phenylenediamine, naphthylamine, diaminonaphthalene, pyrrole derivatives (e.g., pyrrole, 2H-pyrrole, 1-methylpyrrole, 2,4-dimethylpyrrole, 2,5-dimethylpyrrole, and N-methylpyrrole), oxazole derivatives (e.g., oxazole and isooxazole), thiazole derivatives (e.g., thiazole and isothiazole), imidazole derivatives (e.g., imidazole, 4-methylimidazole, and 4-methyl-2-phenylimidazole), pyrazole derivatives, furazan derivatives, pyrroline derivatives (e.g., pyrroline and 2-methyl-1-pyrroline), pyrrolidine derivatives (e.g., pyrrolidine, N-methylpyrrolidine, pyrrolidinone, and N-methylpyrrolidone), imidazoline derivatives, imidazolidine derivatives, pyridine derivatives (e.g., pyridine, methylpyridine, ethylpyridine, propylpyridine, butylpyridine, 4-(1-butylpentyl)pyridine, dimethylpyridine, trimethylpyridine, triethylpyridine, phenylpyridine, 3-methyl-2-phenylpyridine, 4-tert-butylpyridine, diphenylpyridine, benzylpyridine, methoxypyridine, butoxypyridine, dimethoxypyridine, 4-pyrrolidinopyridine, 2-(1-ethylpropyl)pyridine, aminopyridine, and dimethylaminopyridine), pyridazine derivatives, pyrimidine derivatives, pyrazine derivatives, pyrazoline derivatives, pyrazolidine derivatives, piperidine derivatives, piperazine derivatives, morpholine derivatives, indole derivatives, isoindole derivatives, 1H-indazole derivatives, indoline derivatives, quinoline derivatives (e.g., quinoline and 3-quinolinecarbonitrile), isoquinoline derivatives, cinnoline derivatives, quinazoline derivatives, quinoxaline derivatives, phthalazine derivatives, purine derivatives, pteridine derivatives, carbazole derivatives, phenanthridine derivatives, acridine derivatives, phenazine derivatives, 1,10-phenanthroline derivatives, adenine derivatives, adenosine derivatives, guanine derivatives, uanosine derivatives, uracil derivatives, and uridine derivatives.

Examples of suitable nitrogen-containing compounds having carboxyl group include aminobenzoic acid, indolecarboxylic acid, and amino acid derivatives (e.g. nicotinic acid, alanine, alginine, aspartic acid, glutamic acid, glycine, histidine, isoleucine, glycylleucine, leucine, methionine, phenylalanine, threonine, lysine, 3-aminopyrazine-2-carboxylic acid, and methoxyalanine). Examples of suitable nitrogen-containing compounds having sulfonyl group include 3-pyridinesulfonic acid and pyridinium p-toluenesulfonate. Examples of suitable nitrogen-containing compounds having hydroxyl group, nitrogen-containing compounds having hydroxyphenyl group, and alcoholic nitrogen-containing compounds include 2-hydroxypyridine, aminocresol, 2,4-quinolinediol, 3-indolemethanol hydrate, monoethanolamine, diethanolamine, triethanolamine, N-ethyldiethanolamine, N,N-diethylethanolamine, triisopropanolamine, 2,2′-iminodiethanol, 2-aminoethanol, 3-amino-1-propanol, 4-amino-1-butanol, 4-(2-hydroxyethyl)morpholine, 2-(2-hydroxyethyl)pyridine, 1-(2-hydroxyethyl)piperazine, 1-[2-(2-hydroxyethoxy)ethyl]piperazine, piperidine ethanol, 1-(2-hydroxyethyl)pyrrolidine, 1-(2-hydroxyethyl)-2-pyrrolidinone, 3-piperidino-1,2-propanediol, 3-pyrrolidino-1,2-propanediol, 8-hydroxyjulolidine, 3-quinuclidinol, 3-tropanol, 1-methyl-2-pyrrolidine ethanol, 1-aziridine ethanol, N-(2-hydroxyethyl)phthalimide, and N-(2-hydroxyethyl)isonicotinamide. Examples of suitable amide derivatives include formamide, N-methylformamide, N,N-dimethylformamide, acetamide, N-methylacetamide, N,N-dimethylacetamide, propionamide, benzamide, and 1-cyclohexylpyrrolidone. Suitable imide derivatives include phthalimide, succinimide, and maleimide. Suitable carbamate derivatives include N-t-butoxycarbonyl-N,N-dicyclohexylamine, N-t-butoxycarbonylbenzimidazole and oxazolidinone.

In addition, organic nitrogen-containing compounds of the following general formula (B)-1 may also be included alone or in admixture.

N(X)ₙ(Y)₃₋ₙ (B)-1

In the formula, n is equal to 1, 2 or 3; side chain Y is independently hydrogen or a straight, branched or cyclic alkyl group of 1 to 20 carbon atoms which may contain an ether or hydroxyl group; and side chain X is independently selected from groups of the following general formulas (X)-1 to (X)-3, and two or three X's may bond together to form a ring.

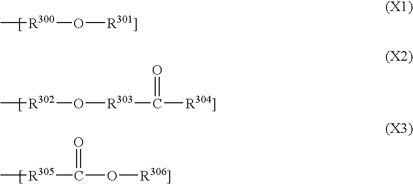

In the formulas, R³⁰⁰, R³⁰² and R³⁰⁵ are independently straight or branched alkylene groups of 1 to 4 carbon atoms; R³⁰¹ and R³⁰⁴ are independently hydrogen, straight, branched or cyclic alkyl groups of 1 to 20 carbon atoms, which may contain at least one hydroxyl, ether, ester group or lactone ring; R³⁰³ is a single bond or a straight or branched alkylene group of 1 to 4 carbon atoms; and R³⁰⁶ is a straight, branched or cyclic alkyl group of 1 to 20 carbon atoms, which may contain one or more hydroxyl, ether, ester groups or lactone rings.

Illustrative examples of the compounds of formula (B)-1 include tris(2-methoxymethoxyethyl)amine, tris{2-(2-methoxyethoxy)ethyl}amine, tris{2-(2-methoxyethoxymethoxy)ethyl}amine, tris{2-(1-methoxyethoxy)ethyl}amine, tris{2-(1-ethoxyethoxy)ethyl}amine, tris{2-(1-ethoxypropoxy)ethyl}amine, tris[2-{2-(2-hydroxyethoxy)ethoxy}ethyl]amine, 4,7,13,16,21,24-hexaoxa-1,10-diazabicyclo[8.8.8]hexacosane, 4,7,13,18-tetraoxa-1,10-diazabicyclo(8.5.5]eicosane, 1,4,10,13-tetraoxa-7,16-diazabicyclooctadecane, 1-aza-12-crown-4,1-aza-15-crown-5,1-aza-18-crown-6, tris(2-formyloxyethyl)amine, tris(2-acetoxyethyl)amine, tris(2-propionyloxyethyl)amine, tris(2-butyryloxyethyl)amine, tris(2-isobutyryloxyethyl)amine, tris(2-valeryloxyethyl)amine, tris(2-pivaloyloxyethyl)amine, N,N-bis(2-acetoxyethyl)-2-(acetoxyacetoxy)ethylamine, tris(2-methoxycarbonyloxyethyl)amine, tris(2-tert-butoxycarbonyloxyethyl)amine, tris[2-(2-oxopropoxy)ethyl]amine, tris[2-(methoxycarbonylmethyl)oxyethyl]amine, tris[2-(tert-butoxycarbonylmethyloxy)ethyl]amine, tris[2-(cyclohexyloxycarbonylmethyloxy)ethyl]amine, tris(2-methoxycarbonylethyl)amine, tris(2-ethoxycarbonylethyl)amine, N,N-bis(2-hydroxyethyl)-2-(methoxycarbonyl)ethylamine, N,N-bis(2-acetoxyethyl)-2-(methoxycarbonyl)ethylamine, N,N-bis(2-hydroxyethyl)-2-(ethoxycarbonyl)ethylamine, N,N-bis(2-acetoxyethyl)-2-(ethoxycarbonyl)ethylamine, N,N-bis(2-hydroxyethyl)-2-(2-methoxyethoxycarbonyl)ethylamine, N,N-bis(2-acetoxyethyl)-2-(2-methoxyethoxycarbonyl)ethylamine, N,N-bis(2-hydroxyethyl)-2-(2-hydroxyethoxycarbonyl)ethylamine, N,N-bis(2-acetoxyethyl)-2-(2-acetoxyethoxycarbonyl)ethylamine, N,N-bis(2-hydroxyethyl)-2-[(methoxycarbonyl)methoxycarbonyl]-ethylamine, N,N-bis(2-acetoxyethyl)-2-[(methoxycarbonyl)methoxycarbonyl]-ethylamine, N,N-bis(2-hydroxyethyl)-2-(2-oxopropoxycarbonyl)ethylamine, N,N-bis(2-acetoxyethyl)-2-(2-oxopropoxycarbonyl)ethylamine, N,N-bis(2-hydroxyethyl)-2-(tetrahydrofurfuryloxycarbonyl)-ethylamine, N,N-bis(2-acetoxyethyl)-2-(tetrahydrofurfuryloxycarbonyl)-ethylamine, N,N-bis(2-hydroxyethyl)-2-[(2-oxotetrahydrofuran-3-yl)oxycarbonyl]ethylamine, N,N-bis(2-acetoxyethyl)-2-[(2-oxotetrahydrofuran-3-yl)oxycarbonyl]ethylamine, N,N-bis(2-hydroxyethyl)-2-(4-hydroxybutoxycarbonyl)ethylamine, N,N-bis(2-formyloxyethyl)-2-(4-formyloxybutoxycarbonyl)-ethylamine, N,N-bis(2-formyloxyethyl)-2-(2-formyloxyethoxycarbonyl)-ethylamine, N,N-bis(2-methoxyethyl)-2-(methoxycarbonyl)ethylamine, N-(2-hydroxyethyl)-bis[2-(methoxycarbonyl)ethyl]amine, N-(2-acetoxyethyl)-bis[2-(methoxycarbonyl)ethyl]amine, N-(2-hydroxyethyl)-bis[2-(ethoxycarbonyl)ethyl]amine, N-(2-acetoxyethyl)-bis[2-(ethoxycarbonyl)ethyl]amine, N-(3-hydroxy-1-propyl)-bis[2-(methoxycarbonyl)ethyl]amine, N-(3-acetoxy-1-propyl)-bis[2-(methoxycarbonyl)ethyl]amine, N-(2-methoxyethyl)-bis[2-(methoxycarbonyl)ethyl]amine, N-butyl-bis[2-(methoxycarbonyl)ethyl]amine, N-butyl-bis[2-(2-methoxyethoxycarbonyl)ethyl]amine, N-methyl-bis(2-acetoxyethyl)amine, N-ethyl-bis(2-acetoxyethyl)amine, N-methyl-bis(2-pivaloyloxyethyl)amine, N-ethyl-bis[2-(methoxycarbonyloxy)ethyl]amine, N-ethyl-bis[2-(tert-butoxycarbonyloxy)ethyl]amine, tris(methoxycarbonylmethyl)amine, tris(ethoxycarbonylmethyl)amine, N-butyl-bis(methoxycarbonylmethyl)amine, N-hexyl-bis(methoxycarbonylmethyl)amine, and β-(diethylamino)-δ-valerolactone.

Also useful are one or more organic nitrogen-containing compounds having cyclic structure represented by the following general formula (B)-2.

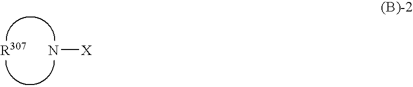

### Herein X is as defined above, and R³⁰⁷ is a straight or branched alkylene group of 2 to 20 carbon atoms which may contain one or more carbonyl, ether, ester or sulfide groups.

Illustrative examples of the organic nitrogen-containing compounds having formula (B)-2 include 1-[2-(methoxymethoxy)ethyl]pyrrolidine, 1-[2-(methoxymethoxy)ethyl]piperidine, 4-[2-(methoxymethoxy)ethyl]morpholine, 1-[2-[(2-methoxyethoxy)methoxy]ethyl]pyrrolidine, 1-[2-[(2-methoxyethoxy)methoxy]ethyl]piperidine, 4-[2-[(2-methoxyethoxy)methoxy]ethyl]morpholine, 2-(1-pyrrolidinyl)ethyl acetate, 2-piperidinoethyl acetate, 2-morpholinoethyl acetate, 2-(1-pyrrolidinyl)ethyl formate, 2-piperidinoethyl propionate, 2-morpholinoethyl acetoxyacetate, 2-(1-pyrrolidinyl)ethyl methoxyacetate, 4-[2-(methoxycarbonyloxy)ethyl]morpholine, 1-[2-(t-butoxycarbonyloxy)ethyl]piperidine, 4-[2-(2-methoxyethoxycarbonyloxy)ethyl]morpholine, methyl 3-(1-pyrrolidinyl)propionate, methyl 3-piperidinopropionate, methyl 3-morpholinopropionate, methyl 3-(thiomorpholino)propionate, methyl 2-methyl-3-(1-pyrrolidinyl)propionate, ethyl 3-morpholinopropionate, methoxycarbonylmethyl 3-piperidinopropionate, 2-hydroxyethyl 3-(1-pyrrolidinyl)propionate, 2-acetoxyethyl 3-morpholinopropionate, 2-oxotetrahydrofuran-3-yl 3-(1-pyrrolidinyl)propionate, tetrahydrofurfuryl 3-morpholinopropionate, glycidyl 3-piperidinopropionate, 2-methoxyethyl 3-morpholinopropionate, 2-(2-methoxyethoxy)ethyl 3-(1-pyrrolidinyl)propionate, butyl 3-morpholinopropionate, cyclohexyl 3-piperidinopropionate, α-(1-pyrrolidinyl)methyl-γ-butyrolactone, β-piperidino-γ-butyrolactone, β-morpholino-δ-valerolactone, methyl 1-pyrrolidinylacetate, methyl piperidinoacetate, methyl morpholinoacetate, methyl thiomorpholinoacetate, ethyl 1-pyrrolidinylacetate, 2-methoxyethyl morpholinoacetate, 2-morpholinoethyl 2-methoxyacetate, 2-morpholinoethyl 2-(2-methoxyethoxy)acetate, 2-morpholinoethyl 2-[2-(2-methoxyethoxy)ethoxy]acetate, 2-morpholinoethyl hexanoate, 2-morpholinoethyl octanoate, 2-morpholinoethyl decanoate, 2-morpholinoethyl laurate, 2-morpholinoethyl myristate, 2-morpholinoethyl palmitate, and 2-morpholinoethyl stearate.

Also, one or more organic nitrogen-containing compounds having cyano group represented by the following general formulae (B)-3 to (B)-6 may be blended.

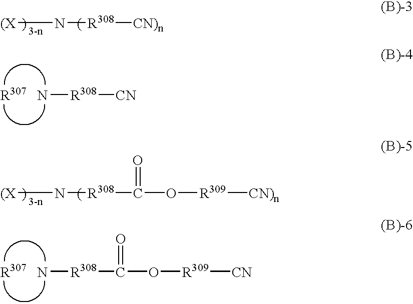

### Herein, X, R³⁰⁷ and n are as defined above, and R³⁰⁸ and R³⁰⁹ are each independently a straight or branched alkylene group of 1 to 4 carbon atoms.

Illustrative examples of the organic nitrogen-containing compounds having cyano represented by formulae (B)-3 to (B)-6 include
3-(diethylamino)propiononitrile,
N,N-bis(2-hydroxyethyl)-3-aminopropiononitrile,
N,N-bis(2-acetoxyethyl)-3-aminopropiononitrile,
N,N-bis(2-formyloxyethyl)-3-aminopropiononitrile,
N,N-bis(2-methoxyethyl)-3-aminopropiononitrile,
N,N-bis[2-(methoxymethoxy)ethyl]-3-aminopropiononitrile,
methyl N-(2-cyanoethyl)-N-(2-methoxyethyl)-3-aminopropionate,
methyl N-(2-cyanoethyl)-N-(2-hydroxyethyl)-3-aminopropionate,
methyl N-(2-acetoxyethyl)-N-(2-cyanoethyl)-3-aminopropionate,
N-(2-cyanoethyl)-N-ethyl-3-aminopropiononitrile,
N-(2-cyanoethyl)-N-(2-hydroxyethyl)-3-aminopropiononitrile,
N-(2-acetoxyethyl)-N-(2-cyanoethyl)-3-aminopropiononitrile,
N-(2-cyanoethyl)-N-(2-formyloxyethyl)-3-aminopropiononitrile,
N-(2-cyanoethyl)-N-(2-methoxyethyl)-3-aminopropiononitrile,
N-(2-cyanoethyl)-N-[2-(methoxymethoxy)ethyl]-3-aminopropiononitrile,
N-(2-cyanoethyl)-N-(3-hydroxy-1-propyl)-3-aminopropiononitrile,
N-(3-acetoxy-1-propyl)-N-(2-cyanoethyl)-3-aminopropiononitrile,
N-(2-cyanoethyl)-N-(3-formyloxy-1-propyl)-3-aminopropiononitrile,
N-(2-cyanoethyl)-N-tetrahydrofurfuryl-3-aminopropiononitrile,
N,N-bis(2-cyanoethyl)-3-aminopropiononitrile,
diethylaminoacetonitrile,
N,N-bis(2-hydroxyethyl)aminoacetonitrile,
N,N-bis(2-acetoxyethyl)aminoacetonitrile,
N,N-bis(2-formyloxyethyl)aminoacetonitrile,
N,N-bis(2-methoxyethyl)aminoacetonitrile,
N,N-bis[2-(methoxymethoxy)ethyl]aminoacetonitrile,
methyl N-cyanomethyl-N-(2-methoxyethyl)-3-aminopropionate,
methyl N-cyanomethyl-N-(2-hydroxyethyl)-3-aminopropionate,
methyl N-(2-acetoxyethyl)-N-cyanomethyl-3-aminopropionate,
N-cyanomethyl-N-(2-hydroxyethyl)aminoacetonitrile,
N-(2-acetoxyethyl)-N-(cyanomethyl)aminoacetonitrile,
N-cyanomethyl-N-(2-formyloxyethyl)aminoacetonitrile,
N-cyanomethyl-N-(2-methoxyethyl)aminoacetonitrile,
N-cyanomethyl-N-[2-(methoxymethoxy)ethyl)aminoacetonitrile,
N-cyanomethyl-N-(3-hydroxy-1-propyl)aminoacetonitrile,
N-(3-acetoxy-1-propyl)-N-(cyanomethyl)aminoacetonitrile,
N-cyanomethyl-N-(3-formyloxy-1-propyl)aminoacetonitrile,
N,N-bis(cyanomethyl)aminoacetonitrile,
1-pyrrolidinepropiononitrile, 1-piperidinepropiononitrile;
4-morpholinepropiononitrile, 1-pyrrolidineacetonitrile,
1-piperidineacetonitrile, 4-morpholineacetonitrile,
cyanomethyl 3-diethylaminopropionate,
cyanomethyl N,N-bis(2-hydroxyethyl)-3-aminopropionate,
cyanomethyl N,N-bis(2-acetoxyethyl)-3-aminopropionate,
cyanomethyl N,N-bis(2-formyloxyethyl)-3-aminopropionate,
cyanomethyl N,N-bis(2-methoxyethyl)-3-aminopropionate,
cyanomethyl N,N-bis[2-(methoxymethoxy)ethyl]-3-aminopropionate,
2-cyanoethyl 3-diethylaminopropionate,
2-cyanoethyl N,N-bis(2-hydroxyethyl)-3-aminopropionate,
2-cyanoethyl N,N-bis(2-acetoxyethyl)-3-aminopropionate,
2-cyanoethyl N,N-bis(2-formyloxyethyl)-3-aminopropionate,
2-cyanoethyl N,N-bis(2-methoxyethyl)-3-aminopropionate,
2-cyanoethyl N,N-bis[2-(methoxymethoxy)ethyl]-3-aminopropionate,
cyanomethyl 1-pyrrolidinepropionate,
cyanomethyl 1-piperidinepropionate,
cyanomethyl 4-morpholinepropionate,
2-cyanoethyl 1-pyrrolidinepropionate,
2-cyanoethyl 1-piperidinepropionate, and
2-cyanoethyl 4-morpholinepropionate.

Also included are organic nitrogen-containing compounds having an imidazole structure and a polar functional group, represented by the general formula (B)-7.

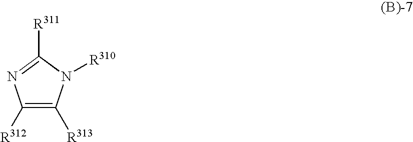

Herein, R³¹⁰ is a straight, branched or cyclic alkyl group of 2 to 20 carbon atoms bearing at least one polar functional group selected from among hydroxyl, carbonyl, ester, ether, sulfide, carbonate, cyano and acetal groups; R³¹¹, R³¹² and R³¹³ are each independently a hydrogen atom, a straight, branched or cyclic alkyl group, aryl group or aralkyl group having 1 to 10 carbon atoms.

Also included are organic nitrogen-containing compounds having a benzimidazole structure and a polar functional group, represented by the general formula (B)-8.

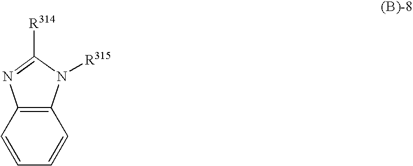

Herein, R³¹⁴ is a hydrogen atom, a straight, branched or cyclic alkyl group, aryl group or aralkyl group having 1 to 10 carbon atoms. R³¹⁵ is a polar functional group-bearing, straight, branched or cyclic alkyl group of 1 to 20 carbon atoms, and the alkyl group contains as the polar functional group at least one group selected from among ester, acetal and cyano groups, and may additionally contain at least one group selected from among hydroxyl, carbonyl, ether, sulfide and carbonate groups.

Further included are heterocyclic nitrogen-containing compounds having a polar functional group, represented by the general formulae (B)-9 and (B)-10.

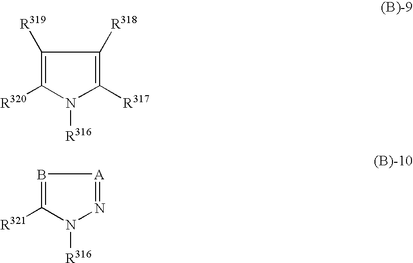

Herein, A is a nitrogen atom or ≡C—R³²², B is a nitrogen atom or ≡C—R³²³, R³¹⁶ is a straight, branched or cyclic alkyl group of 2 to 20 carbon atoms bearing at least one polar functional group selected from among hydroxyl, carbonyl, ester, ether, sulfide, carbonate, cyano and acetal groups; R³¹⁷, R³¹⁸, R³¹⁹ and R³²⁰ are each independently a hydrogen atom, a straight, branched or cyclic alkyl group or aryl group having 1 to 10 carbon atoms, or a pair of R³¹⁷ and R³¹⁸ and a pair of R³¹⁹ and R³²⁰, taken together, may form a benzene, naphthalene or pyridine ring; R³²¹ is a hydrogen atom, a straight, branched or cyclic alkyl group or aryl group having 1 to 10 carbon atoms; R³²² and R³²³ each are a hydrogen atom, a straight, branched or cyclic alkyl group or aryl group having 1 to 10 carbon atoms, or a pair of R³²¹ and R³²³, taken together, may form a benzene or naphthalene ring.

Also included are organic nitrogen-containing compounds of aromatic carboxylic ester structure having the general formulae (B)-11 to (B)-14.

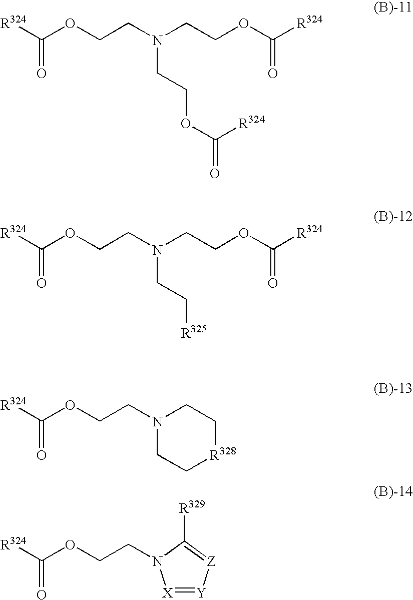

Herein R³²⁴ is a C₆-C₂₀ aryl group or C₄-C₂₀ hetero-aromatic group, in which some or all of hydrogen atoms may be replaced by halogen atoms, straight, branched or cyclic C₁-C₂₀ alkyl groups, C₆-C₂₀ aryl groups, C₇-C₂₀ aralkyl groups, C₁-C₁₀ alkoxy groups, C₁-C₁₀ acyloxy groups or C₁-C₁₀ alkylthio groups. R³²⁵ is CO₂R³²⁶, OR³²⁷ or cyano group. R³²⁶ is a C₁-C₁₀ alkyl group, in which some methylene groups may be replaced by oxygen atoms. R³²⁷ is a C₁-C₁₀ alkyl or acyl group, in which some methylene groups may be replaced by oxygen atoms. R³²⁸ is a single bond, methylene, ethylene, sulfur atom or —O(CH₂CH₂O)ₘ— group wherein m is 0, 1, 2, 3 or 4. R³²⁹ is hydrogen, methyl, ethyl or phenyl. X is a nitrogen atom or CR³³⁰. Y is a nitrogen atom or CR³³¹. Z is a nitrogen atom or CR³³². R³³⁰, R³³¹ and R³³² are each independently hydrogen, methyl or phenyl. Alternatively, a pair of R³³⁰ and R³³¹ or a pair of R³³¹ and R³³² may bond together to form a C₆-C₂₀ aromatic ring or C₂-C₂₀ hetero-aromatic ring.

Further included are organic nitrogen-containing compounds of 7-oxanorbornane-2-carboxylic ester structure having the general formula (B)-15.

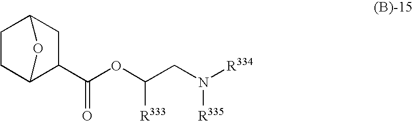

Herein R³³³ is hydrogen or a straight, branched or cyclic C₁-C₁₀ alkyl group. R³³⁴ and R³³⁵ are each independently a C₁-C₂₀ alkyl group, C₆-C₂₀ aryl group or C₇-C₂₀ aralkyl group, which may contain one or more polar functional groups selected from among ether, carbonyl, ester, alcohol, sulfide, nitrile, amine, imine, and amide and in which some hydrogen atoms may be replaced by halogen atoms. R³³⁴ and R³³, taken together, may form a heterocyclic or hetero-aromatic ring of 2 to 20 carbon atoms.

The organic nitrogen-containing compounds may be used alone or in admixture of two or more. The organic nitrogen-containing compound is preferably formulated in an amount of 0.001 to 4 parts, and especially 0.01 to 2 parts by weight, per 100 parts by weight of the entire base resin. Less than 0.001 part of the nitrogen-containing compound achieves no or little addition effect whereas more than 4 parts would result in too low a sensitivity.

### Component F

The resist composition of the invention may include a surfactant which is commonly used for improving the coating characteristics. It may be added in conventional amounts so long as this does not compromise the objects of the invention.

Nonionic surfactants are preferred, examples of which include perfluoroalkylpolyoxyethylene ethanols, fluorinated alkyl esters, perfluoroalkylamine oxides, perfluoroalkyl EO-addition products, and fluorinated organosiloxane compounds. Useful surfactants are commercially available under the trade names Fluorad FC-430 and FC-431 from Sumitomo 3M, Ltd., Surflon S-141, S-145, KH-10, KH-20, KH-30 and KH-40 from Asahi Glass Co., Ltd., Unidyne DS-401, DS-403 and DS-451 from Daikin Industry Co., Ltd., Megaface F-8151 from Dai-Nippon Ink & Chemicals, Inc., and X-70-092 and X-70-093 from Shin-Etsu Chemical Co., Ltd. Preferred surfactants are Fluorad FC-430 from Sumitomo 3M, Ltd., KH-20 and KH-30 from Asahi Glass Co., Ltd., and X-70-093 from Shin-Etsu Chemical Co., Ltd.

### Other Components

To the resist composition of the invention, other components may be added if desired. For example, a polymer, which will localize at the top of a coating, may be added for the purposes of adjusting a hydrophilic/hydrophobic balance on the coating surface, enhancing water repellency, or preventing a low-molecular-weight fraction from being flowing in or out of the coating when the coating is contacted with water or other liquid. The polymer may be added in conventional amounts so long as this does not compromise the objects of the invention.

Preferred polymers which will localize at the top of a coating include polymers and copolymers comprising fluorinated units of one or more type, and copolymers comprising fluorinated units and other units. Illustrative examples of suitable fluorinated units and other units are given below, but not limited thereto.

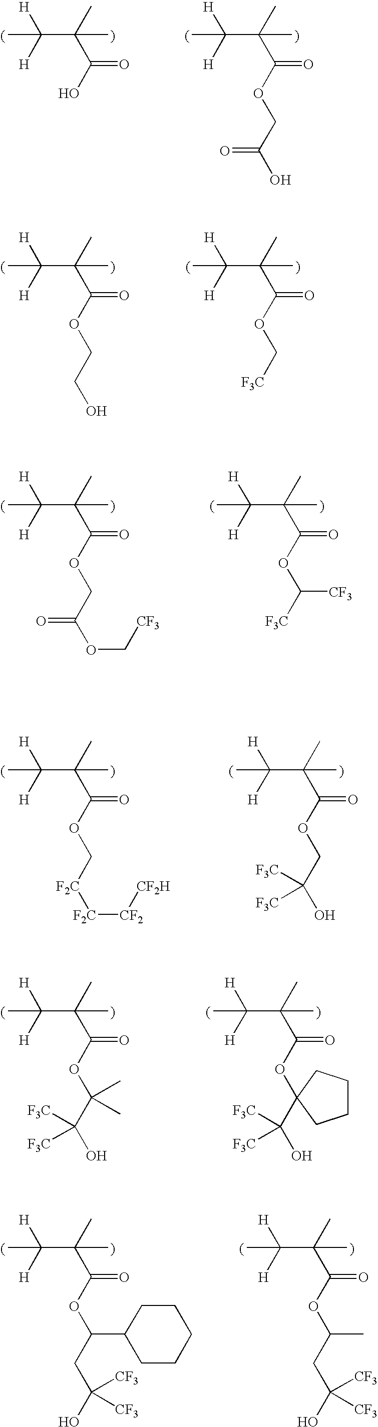

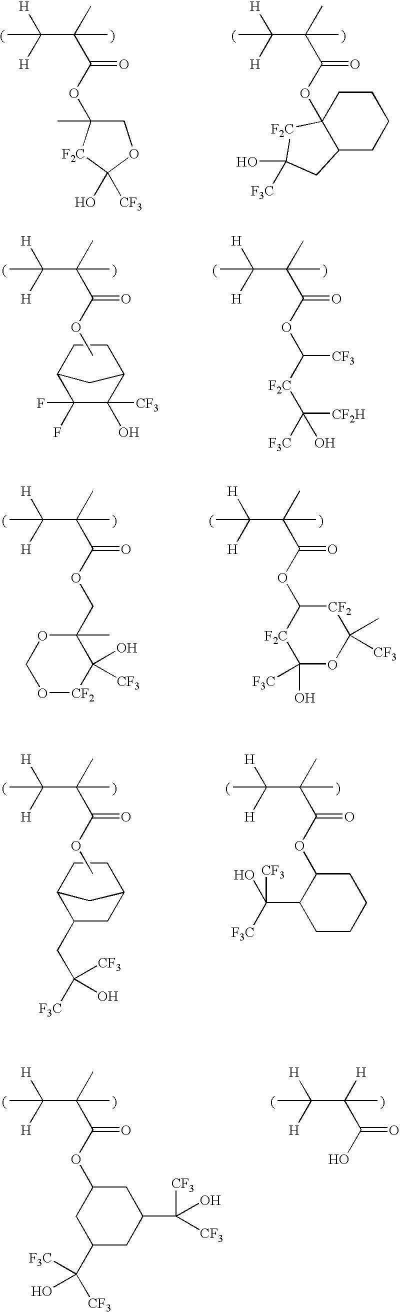

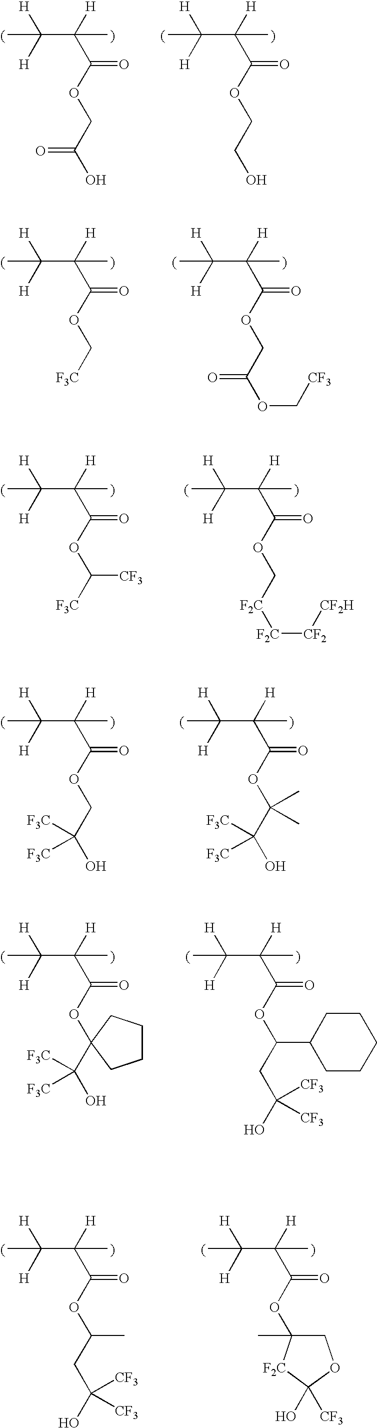

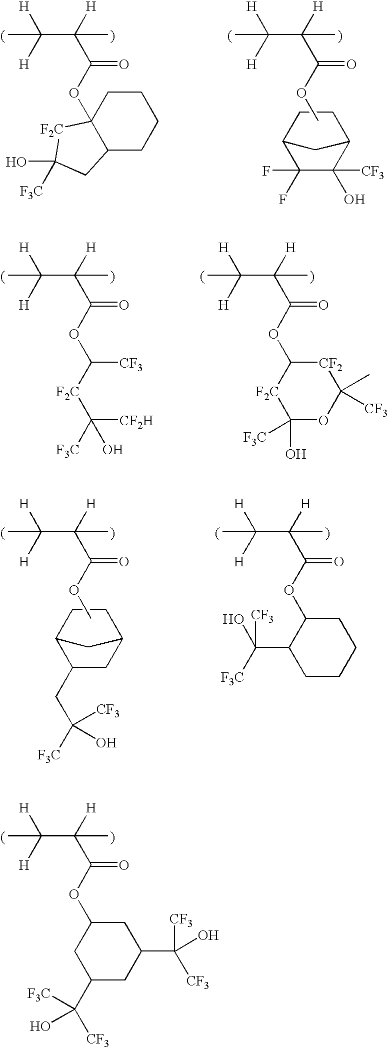

The polymer which will localize at the top of a coating preferably has a weight average molecular weight (Mw) of 1,000 to 50,000, more preferably 2,000 to 20,000. Outside the range, the surface modifying effect may be insufficient, or development defects occur. Note that the Mw is determined by gel permeation chromatography (GPC) versus polystyrene standards.

Also, if desired, other components including dissolution regulators, carboxylic acid compounds and acetylene alcohol derivatives may be added to the resist composition of the invention. Optional components may be added in conventional amounts so long as this does not compromise the objects of the invention.

The dissolution regulator which can be added to the resist composition is a compound having on the molecule at least two phenolic hydroxyl groups, in which an average of from 0 to 100 mol % of all the hydrogen atoms on the phenolic hydroxyl groups are replaced with acid labile groups or a compound having on the molecule at least one carboxyl group, in which an average of 50 to 100 mol % of all the hydrogen atoms on the carboxyl groups are replaced with acid labile groups, both the compounds having an average molecular weight within a range of 100 to 1,000, and preferably 150 to 800.

The degree of substitution of the hydrogen atoms on the phenolic hydroxyl groups with acid labile groups is on average at least 0 mol %, and preferably at least 30 mol %, of all the phenolic hydroxyl groups. The upper limit is 100 mol %, and preferably 80 mol %. The degree of substitution of the hydrogen atoms on the carboxyl groups with acid labile groups is on average at least 50 mol %, and preferably at least 70 mol %, of all the carboxyl groups, with the upper limit being 100 mol %.

Preferable examples of such compounds having two or more phenolic hydroxyl groups or compounds having at least one carboxyl group include those of formulas (D1) to (D14) below.

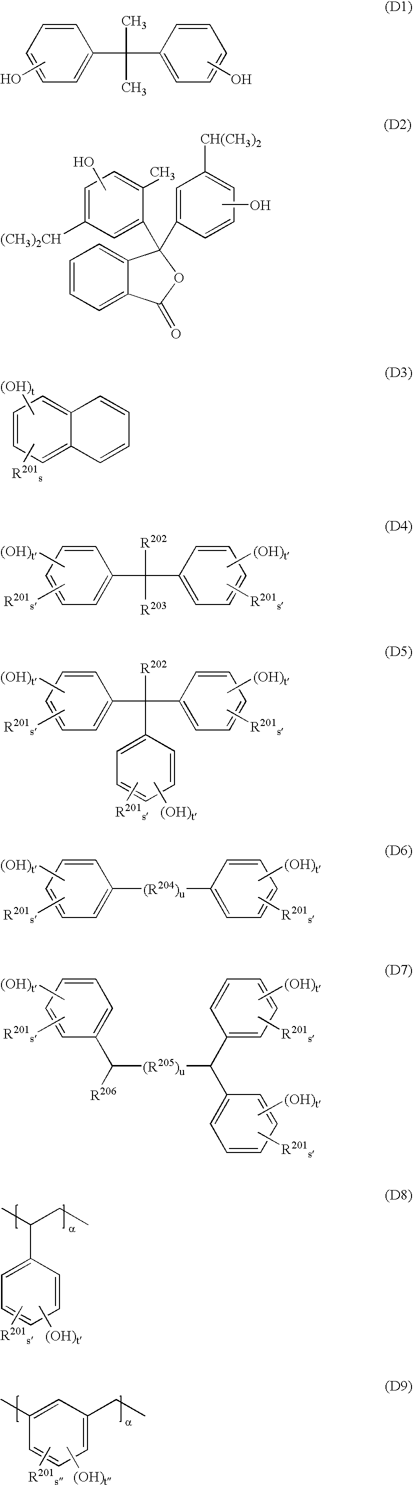

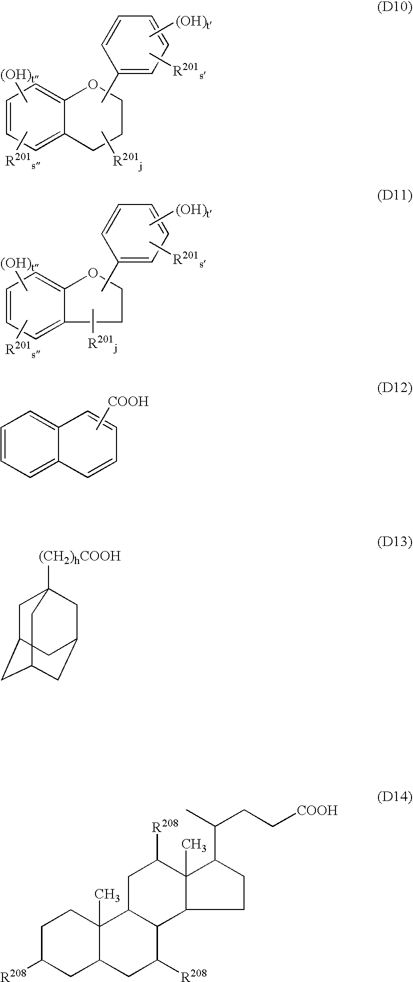

In these formulas, R²⁰¹ and R²⁰² are each hydrogen or a straight or branched C₁-C₈ alkyl or alkenyl group, for example, hydrogen, methyl, ethyl, butyl, propyl, ethynyl and cyclohexyl.

R²⁰³ is hydrogen, a straight or branched C₁-C₈ alkyl or alkenyl group, or —(R²⁰⁷)ₕ—COOH wherein R²⁰⁷ is a straight or branched C₁-C₁₀ alkylene, for example, those exemplified for R²⁰¹ and R²⁰² and —COOH and —CH₂COOH.

R²⁰⁴ is —(CH₂)ᵢ— wherein i=2 to 10, C₆-C₁₀ arylene, carbonyl, sulfonyl, an oxygen atom, or a sulfur atom, for example, ethylene, phenylene, carbonyl, sulfonyl, oxygen atom or sulfur atom.

R²⁰⁵ is a C₁-C₁₀ alkylene, a C₆-C₁₀ arylene, carbonyl, sulfonyl, an oxygen atom, or a sulfur atom, for example, methylene and those exemplified for R²⁰⁴.

R²⁰⁶ is hydrogen, a straight or branched C₁-C₈ alkyl or alkenyl group, or a phenyl or naphthyl group having at least one hydrogen atom substituted by hydroxyl, for example, hydrogen, methyl, ethyl, butyl, propyl, ethynyl, cyclohexyl, hydroxyl-substituted phenyl, and hydroxyl-substituted naphthyl.

R²⁰⁸ is hydrogen or hydroxyl.

The letter j is an integer from 0 to 5; u and h are each 0 or 1; s, t, s′, t′, s″, and t″ are each numbers which satisfy s+t=8, s′+t′=5, and s″+t″=4, and are such that each phenyl skeleton has at least one hydroxyl group; and α is a number such that the compounds of formula (D8) or (D9) have a weight average molecular weight of from 100 to 1,000.

Exemplary acid labile groups on the dissolution regulator include a variety of such groups, typically groups of the general formulae (L1) to (L4), tertiary alkyl groups of 4 to 20 carbon atoms, trialkylsilyl groups in which each of the alkyls has 1 to 6 carbon atoms, and oxoalkyl groups of 4 to 20 carbon atoms. Examples of the respective groups are as previously described.

The dissolution regulator may be formulated in an amount of 0 to 50 parts, preferably 0 to 40 parts, and more preferably 0 to 30 parts by weight, per 100 parts by weight of the base polymer, and may be used singly or as a mixture of two or more thereof. The use of more than 50 parts of the dissolution regulator would lead to slimming of the patterned film, and thus a decline in resolution.

The dissolution regulator can be synthesized by introducing acid labile groups into a compound having phenolic hydroxyl or carboxyl groups in accordance with an organic chemical formulation.

In the resist composition, a carboxylic acid compound may be blended. Exemplary, non-limiting carboxylic acid compounds include one or more compounds selected from Groups I and II below. Including this compound improves the PED stability of the resist and ameliorates edge roughness on nitride film substrates.

### Group I:

Compounds in which some or all of the hydrogen atoms on the phenolic hydroxyl groups of the compounds of general formulas (A1) to (A10) below are replaced by —R⁴⁰¹—COOH (wherein R⁴⁰¹ is a straight or branched alkylene of 1 to 10 carbon atoms), and in which the molar ratio C/(C+D) of phenolic hydroxyl groups (C) to ≡C—COOH groups (D) in the molecule is from 0.1 to 1.0.

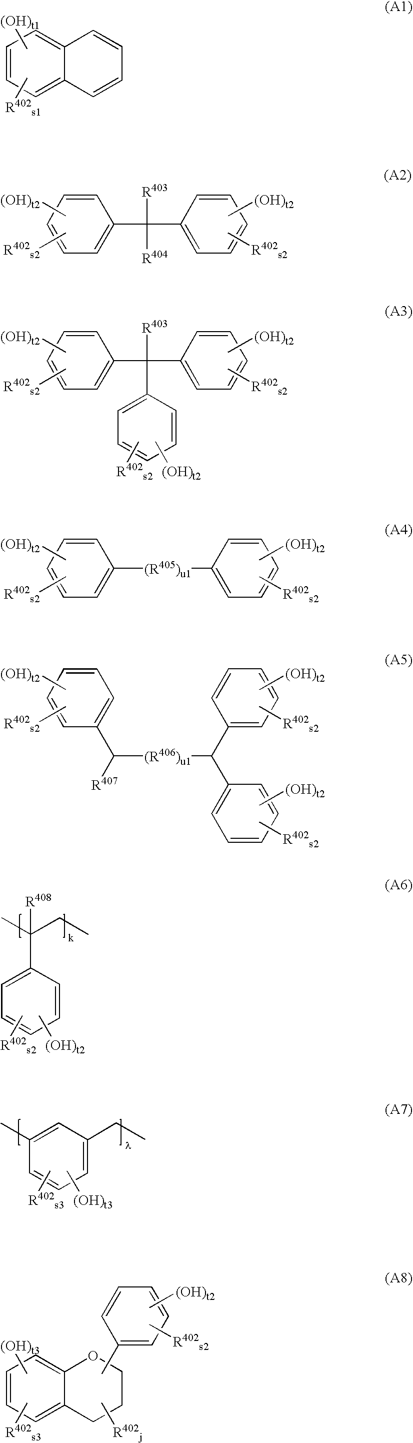

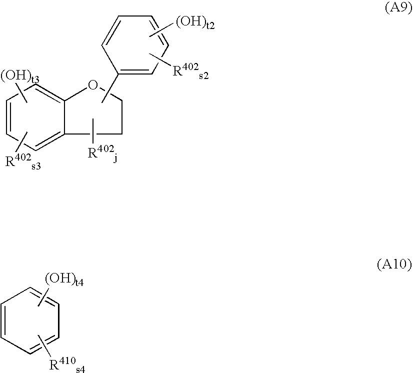

In these formulas, R⁴⁰² and R⁴⁰³ are each hydrogen or a straight or branched C₁-C₈ alkyl or alkenyl; R⁴⁰⁴ is hydrogen, a straight or branched C₁-C₈ alkyl or alkenyl, or a —(R⁴⁰⁹)ₕ₁—COOR′ group (R′ being hydrogen or —R⁴⁰⁹—COOH); R⁴⁰⁵ is —(CH₂)ᵢ— (wherein i is 2 to 10), a C₆-C₁₀ arylene, carbonyl, sulfonyl, an oxygen atom, or a sulfur atom; R⁴⁰⁶ is a C₁-C₁₀ alkylene, a C₆-C₁₀ arylene, carbonyl, sulfonyl, an oxygen atom, or a sulfur atom; R⁴⁰⁷ is hydrogen, a straight or branched C₁-C₈ alkyl or alkenyl, or a hydroxyl-substituted phenyl or naphthyl; R⁴⁰⁸ is hydrogen or methyl; R⁴⁰⁹ is a straight or branched C₁-C₁₀ alkylene; R⁴¹⁰ is hydrogen, a straight or branched C₁-C₈ alkyl or alkenyl, or a —R⁴¹¹—COOH group; R⁴¹¹ is a straight or branched C₁-C₁₀ alkylene; the letter j is an integer from 0 to 3; s1, t1, s2, t2, s3, t3, s4, and t4 are each numbers which satisfy s1+t1=8, s2+t2=5, s3+t3=4, and s4+t4=6, and are such that each phenyl structure has at least one hydroxyl group; u1 is a number from 1 to 4, h1 is a number from 0 to 4; κ is a number such that the compound of formula (A6) may have a weight average molecular weight of 1,000 to 5,000; and λ is a number such that the compound of formula (A7) may have a weight average molecular weight of 1,000 to 10,000.

### Group II:

Compounds of general formulas (A11) to (A15) below.

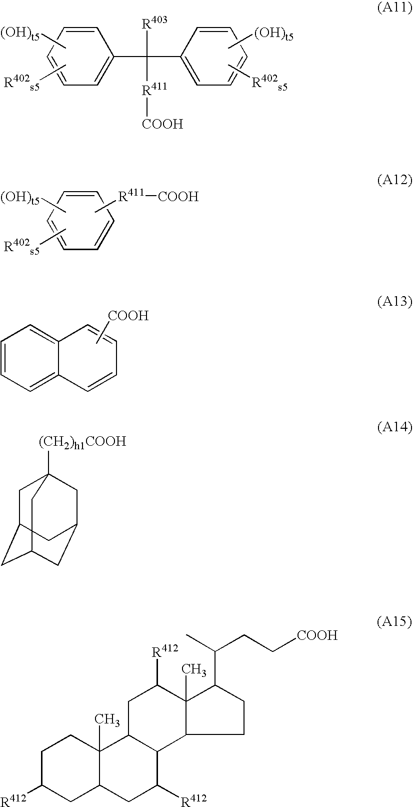

In these formulas, R⁴⁰², R⁴⁰³, and R⁴¹¹ are as defined above; R⁴¹² is hydrogen or hydroxyl; s5 and t5 are numbers which satisfy s5Δ0, t5≧0, and s5+t5=5; and h1 is a number from 0 to 4.

Illustrative, non-limiting examples of the compound having a carboxyl group include compounds of the general formulas AI-1 to AI-14 and AII-1 to AII-10 below.

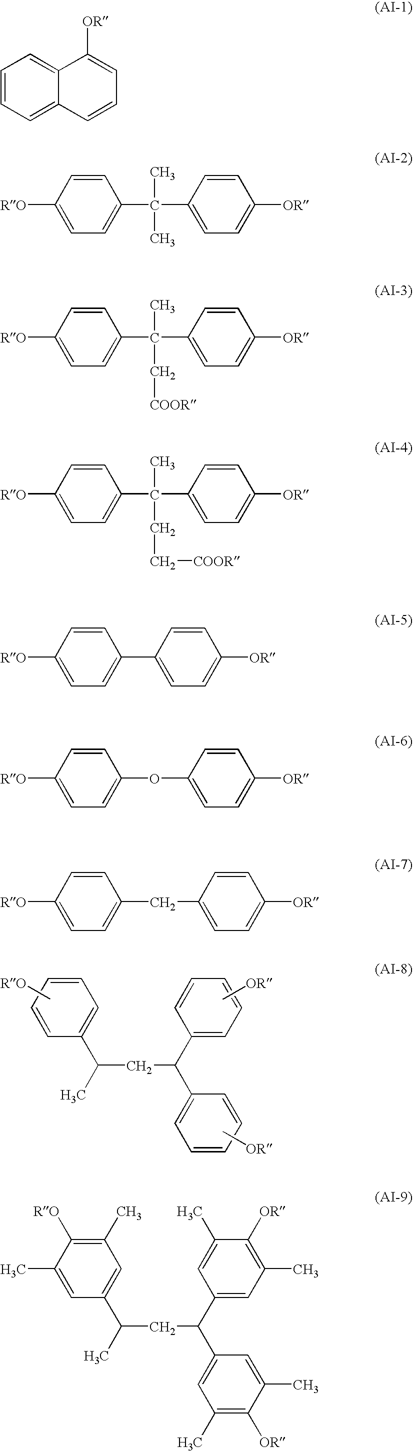

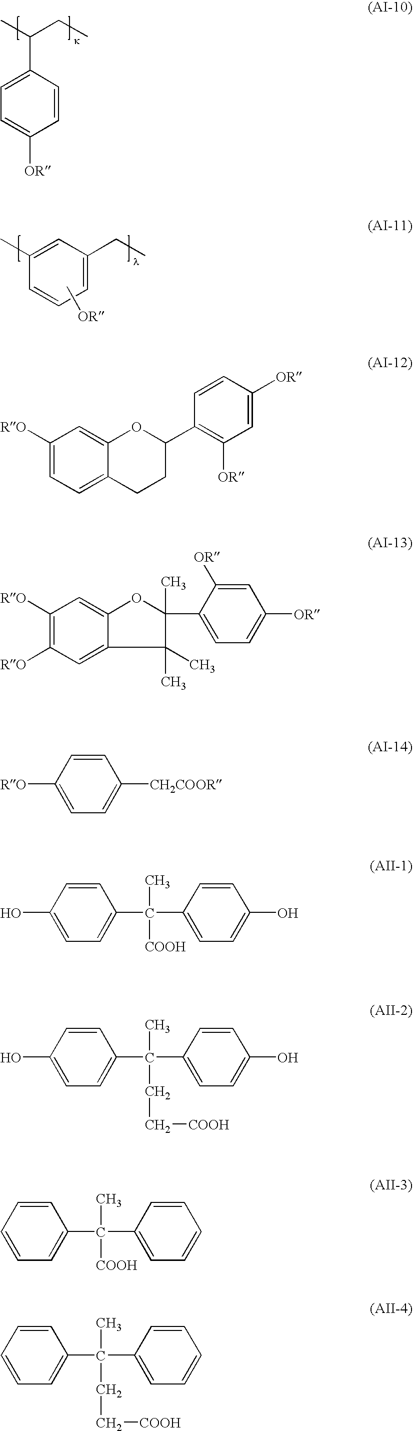

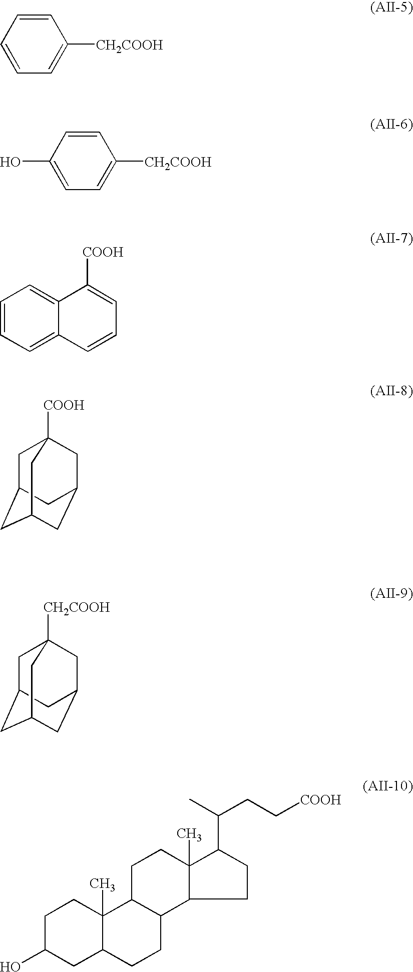

In the above formulas, R″ is hydrogen or a —CH₂COOH group such that the —CH₂COOH group accounts for 10 to 100 mol % of R″ in each compound, κ and λ are as defined above.

The compound having a ≡C—COOH group in the molecule is added in an amount ranging from 0 to 5 parts, preferably 0.1 to 5 parts, more preferably 0.1 to 3 parts, even more preferably 0.1 to 2 parts by weight, per 100 parts by weight of the base polymer. More than 5 parts of the compound can reduce the resolution of the resist composition.

The resist composition of the invention may additionally include an acetylene alcohol derivative. Preferred acetylene alcohol derivatives are those having the general formula (S1) or (S2) below.

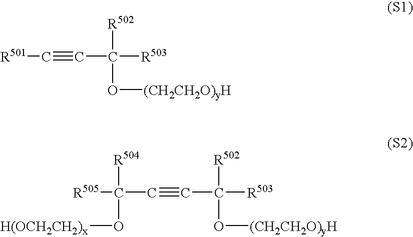

In the formulas, R⁵⁰¹, R⁵⁰², R⁵⁰³, R⁵⁰⁴, and R⁵⁰⁵ are each hydrogen or a straight, branched or cyclic C₁-C₈ alkyl; and X and Y are each 0 or a positive number, satisfying 0≦X≦30, 0≦Y≦30, and 0≦X+Y≦40.

Preferable examples of the acetylene alcohol derivative include Surfynol 61, Surfynol 82, Surfynol 104, Surfynol 104E, Surfynol 104H, Surfynol 104A, Surfynol TG, Surfynol PC, Surfynol 440, Surfynol 465, and Surfynol 485 from Air Products and Chemicals Inc., and Surfynol E1004 from Nisshin Chemical Industry K.K.

The acetylene alcohol derivative is added in an amount of 0 to 2 parts, preferably 0.01 to 2 parts, and more preferably 0.02 to 1 part by weight, per 100 parts by weight of the base polymer in the resist composition. More than 2 parts by weight would result in a resist material having a low resolution.

Pattern formation using the resist composition of the invention may be carried out by a known lithographic technique. The pattern forming process generally involves the steps of coating, heat treatment (or prebaking), exposure, heat treatment (or post-exposure baking (PEB)), and development. Some other steps may be added if necessary.

In forming a pattern, the resist composition of the invention is first applied onto a substrate for integrated circuitry fabrication (e.g., Si, SiO₂, SiN, SiON, TiN, WSi, BPSG, SOG, organic antireflective coating, Cr, CrO, CrON, or MoSi) by a suitable coating technique (e.g., spin coating, roll coating, flow coating, dip coating, spray coating, or doctor coating) to form a resist coating having a thickness of 0.01 to 2.0 μm. It is then pre-baked on a hot plate at 60 to 150° C. for 1 to 10 minutes, and preferably at 80 to 140° C. for 1 to 5 minutes. Due to the necessity to establish a reduction of resist thickness and an etching selectivity ratio between a resist and a substrate to be processed, severer requirements are imposed on the lithography. Under investigation is the tri-layer resist process using a structure including a resist film, a silicon-containing intermediate film, an undercoat film having a high carbon density and high etching resistance, and a substrate to be processed, stacked in sequence from top to bottom. For etching with oxygen gas, hydrogen gas or ammonia gas, a high etching selectivity ratio is established between the silicon-containing intermediate film and the undercoat film, permitting the silicon-containing intermediate film to be made thin. The etching selectivity ratio between the single-layer resist and the silicon-containing intermediate film is relatively high, permitting the single-layer resist to be made thin. In this process, the undercoat film may be formed by a coating/baking method or a CVD method. The coating method uses novolac resins or resins obtained by polymerization of fused ring-bearing olefins. For film formation by CVD, butane, ethane, propane, ethylene, acetylene and analogous gases are used. The silicon-containing intermediate film may also be formed by either coating or CVD. The coating method uses silsesquioxane, cage oligo-silsesquioxane (POSS) or the like. For the CVD, various silane gases may be used as the source. The silicon-containing intermediate film may additionally have an antireflection function capable of light absorption, and thus may have incorporated therein light-absorbing groups such as phenyl groups or be a SiON film. An organic film may intervene between the silicon-containing intermediate film and the photoresist. The organic film used herein may be an antireflective coating. After the photoresist film is formed, deionized water rinsing or post-soaking may be carried out for extracting the photoacid generator or the like from the film surface or for washing away particles. A protective film may be coated instead.

Next, using a light source selected from UV, deep-UV, electron beam, X-ray, excimer laser, γ-ray, synchrotron radiation and the like, the resist film is exposed to radiation through a mask having the desired pattern. The exposure dose is preferably about 1 to 200 mJ/cm², and more preferably about 10 to 100 mJ/cm². The resist film is then post-exposure baked (PEB) on a hot plate at 60 to 150° C. for 1 to 5 minutes, and preferably at 80 to 120° C. for 1 to 3 minutes. Finally, development is carried out with a developer in the form of an aqueous alkali solution such as a 0.1 to 5 wt %, preferably 2 to 3 wt % aqueous solution of tetramethylammonium hydroxide (TMAH) by a conventional technique such as dip, puddle or spray development for a period of 0.1 to 3 minutes, and preferably 0.5 to 2 minutes. These steps result in the formation of the desired pattern on the substrate. Of the various types of high-energy radiation that may be used, the resist composition of the invention is best suited to fine pattern formation with deep-UV rays having a wavelength of 254 to 193 nm, vacuum-UV having a wavelength of 157 nm, electron beam, soft X-ray, X-ray, excimer laser, γ-ray, or synchrotron radiation, and in particular high-energy radiation in the wavelength range of 180 to 200 nm.

To the resist composition of the invention, the immersion lithography may be applicable. The immersion lithography involves prebaking a resist film and exposing the resist film to light through a projection lens, with deionized water or other liquid interposed between the resist film and the projection lens. Since this allows projection lenses to be designed to a numerical aperture (NA) of 1.0 or higher, formation of finer pattern features is possible. The immersion lithography is important for the ArF lithography to survive to the 45-nm node, with a further development thereof being accelerated. In the case of immersion lithography, deionized water rinsing (or post-soaking) may be carried out after exposure for removing water droplets left on the resist film, or a protective coating may be applied onto the resist film after pre-baking for preventing any dissolution from the resist and improving water slip on the film surface. The resist protective coating used in the immersion lithography is preferably formed from a solution of a polymer having 1,1,1,3,3,3-hexafluoro-2-propanol residues which is insoluble in water, but dissolvable in an alkaline developer liquid, in a solvent selected from alcohols of at least 4 carbon atoms, ethers of 8 to 12 carbon atoms, and mixtures thereof.

The technique enabling the ArF lithography to survive to the 32-nm node is a double patterning process. The double patterning process includes a trench process of processing an underlay to a 1:3 trench pattern by a first step of exposure and etching, shifting the position, and forming a 1:3 trench pattern by a second step of exposure for forming a 1:1 pattern; and a line process of processing a first underlay to a 1:3 isolated left pattern by a first step of exposure and etching, shifting the position, processing a second underlay formed below the first underlay by a second step of exposure through the 1:3 isolated left pattern, for forming a half-pitch 1:1 pattern.

### EXAMPLE

Examples and Comparative Examples are given below by way of illustration and not by way of limitation.

### [Preparation of Resist Compositions]

### Example 1 and Comparative Example 1

Resist compositions were prepared by combining a polymer, photoacid generator, acidic compound, basic compound, and solvents in accordance with the recipe shown in Table 1, dissolving them, and filtering through a Teflon® filter having a pore diameter 0.2 μm, thereby giving resist solutions. All the solvents contained 0.01 wt % of surfactant KH-20 (Asahi Glass Co., Ltd.). Similarly, resist compositions for comparison purposes were prepared in accordance with the recipe shown in Table 2.

TABLE 1

| | | Photoacid | Acidic | | | |
|---|---|---|---|---|---|---|
| Resist | Resin | generator | compound | Base | Solvent 1 | Solvent 2 |
| R-01 | P-01 (80) | PAG-1 (4.4) | Acid-1 (1.0) | Base-1 (0.94) | PGMEA (560) | CyHO (240) |
| R-02 | P-02 (80) | PAG-1 (4.4) | Acid-1 (1.0) | Base-1 (0.94) | PGMEA (560) | CyHO (240) |
| R-03 | P-03 (80) | PAG-1 (4.4) | Acid-1 (1.0) | Base-1 (0.94) | PGMEA (560) | CyHO (240) |
| R-04 | P-04 (80) | PAG-1 (4.4) | Acid-1 (1.0) | Base-1 (0.94) | PGMEA (560) | CyHO (240) |
| R-05 | P-05 (80) | PAG-1 (4.4) | Acid-1 (1.0) | Base-1 (0.94) | PGMEA (560) | CyHO (240) |
| R-06 | P-06 (80) | PAG-1 (4.4) | Acid-1 (1.0) | Base-1 (0.94) | PGMEA (560) | CyHO (240) |
| R-07 | P-07 (80) | PAG-1 (4.4) | Acid-1 (1.0) | Base-1 (0.94) | PGMEA (560) | CyHO (240) |
| R-08 | P-08 (80) | PAG-1 (4.4) | Acid-1 (1.0) | Base-1 (0.94) | PGMEA (560) | CyHO (240) |
| R-09 | P-09 (80) | PAG-1 (4.4) | Acid-1 (1.0) | Base-1 (0.94) | PGMEA (560) | CyHO (240) |
| R-10 | P-10 (80) | PAG-1 (4.4) | Acid-1 (1.0) | Base-1 (0.94) | PGMEA (560) | CyHO (240) |
| R-11 | P-11 (80) | PAG-1 (4.4) | Acid-1 (1.0) | Base-1 (0.94) | PGMEA (560) | CyHO (240) |
| R-12 | P-12 (80) | PAG-1 (4.4) | Acid-1 (1.0) | Base-1 (0.94) | PGMEA (560) | CyHO (240) |
| R-13 | P-13 (80) | PAG-1 (4.4) | Acid-1 (1.0) | Base-1 (0.94) | PGMEA (560) | CyHO (240) |
| R-14 | P-14 (80) | PAG-1 (4.4) | Acid-1 (1.0) | Base-1 (0.94) | PGMEA (560) | CyHO (240) |
| R-15 | P-15 (80) | PAG-1 (4.4) | Acid-1 (1.0) | Base-1 (0.94) | PGMEA (560) | CyHO (240) |
| R-16 | P-16 (80) | PAG-1 (4.4) | Acid-1 (1.0) | Base-1 (0.94) | PGMEA (560) | CyHO (240) |
| R-17 | P-17 (80) | PAG-1 (4.4) | Acid-1 (1.0) | Base-1 (0.94) | PGMEA (560) | CyHO (240) |
| R-18 | P-18 (80) | PAG-1 (4.4) | Acid-1 (1.0) | Base-1 (0.94) | PGMEA (560) | CyHO (240) |
| R-19 | P-19 (80) | PAG-1 (4.4) | Acid-1 (1.0) | Base-1 (0.94) | PGMEA (560) | CyHO (240) |
| R-20 | P-20 (80) | PAG-1 (4.4) | Acid-1 (1.0) | Base-1 (0.94) | PGMEA (560) | CyHO (240) |
| R-21 | P-21 (80) | PAG-1 (4.4) | Acid-1 (1.0) | Base-1 (0.94) | PGMEA (560) | CyHO (240) |
| R-22 | P-22 (80) | PAG-1 (4.4) | Acid-1 (1.0) | Base-1 (0.94) | PGMEA (560) | CyHO (240) |
| R-23 | P-23 (80) | PAG-1 (4.4) | Acid-1 (1.0) | Base-1 (0.94) | PGMEA (560) | CyHO (240) |
| R-24 | P-24 (80) | PAG-1 (4.4) | Acid-1 (1.0) | Base-1 (0.94) | PGMEA (560) | CyHO (240) |
| R-25 | P-25 (80) | PAG-1 (4.4) | Acid-1 (1.0) | Base-1 (0.94) | PGMEA (560) | CyHO (240) |
| R-26 | P-26 (80) | PAG-1 (4.4) | Acid-1 (1.0) | Base-1 (0.94) | PGMEA (560) | CyHO (240) |
| R-27 | P-27 (80) | PAG-1 (4.4) | Acid-1 (1.0) | Base-1 (0.94) | PGMEA (560) | CyHO (240) |
| R-28 | P-28 (80) | PAG-1 (4.4) | Acid-1 (1.0) | Base-1 (0.94) | PGMEA (560) | CyHO (240) |
| R-29 | P-29 (80) | PAG-1 (4.4) | Acid-1 (1.0) | Base-1 (0.94) | PGMEA (560) | CyHO (240) |
| R-30 | P-30 (80) | PAG-1 (4.4) | Acid-1 (1.0) | Base-1 (0.94) | PGMEA (560) | CyHO (240) |
| R-31 | P-31 (80) | PAG-1 (4.4) | Acid-1 (1.0) | Base-1 (0.94) | PGMEA (560) | CyHO (240) |
| R-32 | P-17 (80) | PAG-2 (4.9) | Acid-1 (1.0) | Base-1 (0.94) | PGMEA (560) | CyHO (240) |
| R-33 | P-17 (80) | PAG-3 (4.7) | Acid-1 (1.0) | Base-1 (0.94) | PGMEA (560) | CyHO (240) |
| R-34 | P-17 (80) | PAG-1 (2.2) | Acid-1 (1.0) | Base-1 (0.94) | PGMEA (560) | CyHO (240) |
| | | PAG-2 (2.5) | | | | |
| R-35 | P-17 (80) | PAG-1 (2.2) | Acid-1 (1.0) | Base-1 (0.94) | PGMEA (560) | CyHO (240) |
| | | PAG-3 (2.3) | | | | |
| R-36 | P-17 (80) | PAG-1 (4.4) | Acid-1 (1.0) | Base-2 (0.74) | PGMEA (560) | CyHO (240) |
| R-37 | P-17 (80) | PAG-1 (4.4) | Acid-1 (1.0) | Base-3 (0.64) | PGMEA (560) | CyHO (240) |
| R-38 | P-19 (80) | PAG-1 (4.4) | Acid-2 (1.0) | Base-1 (0.94) | PGMEA (560) | CyHO (240) |
| R-39 | P-19 (80) | PAG-1 (4.4) | Acid-3 (1.0) | Base-1 (0.94) | PGMEA (560) | CyHO (240) |
| R-40 | P-19 (80) | PAG-1 (4.4) | Acid-1 (0.5) | Base-1 (0.94) | PGMEA (560) | CyHO (240) |
| R-41 | P-19 (80) | PAG-1 (4.4) | Acid-1 (3.0) | Base-1 (0.94) | PGMEA (560) | CyHO (240) |
| R-42 | P-19 (80) | PAG-1 (4.4) | Acid-1 (5.0) | Base-1 (0.94) | PGMEA (560) | CyHO (240) |

TABLE 2

| | | Photoacid | Acidic | | | |
|---|---|---|---|---|---|---|
| Resist | Resin | generator | compound | Base | Solvent 1 | Solvent 2 |
| R-43 | P-01 (80) | PAG-1 (4.4) | | Base-1 (0.94) | PGMEA (560) | CyHO (240) |
| R-44 | P-02 (80) | PAG-1 (4.4) | | Base-1 (0.94) | PGMEA (560) | CyHO (240) |
| R-45 | P-03 (80) | PAG-1 (4.4) | | Base-1 (0.94) | PGMEA (560) | CyHO (240) |
| R-46 | P-04 (80) | PAG-1 (4.4) | | Base-1 (0.94) | PGMEA (560) | CyHO (240) |
| R-47 | P-05 (80) | PAG-1 (4.4) | | Base-1 (0.94) | PGMEA (560) | CyHO (240) |
| R-48 | P-06 (80) | PAG-1 (4.4) | | Base-1 (0.94) | PGMEA (560) | CyHO (240) |
| R-49 | P-07 (80) | PAG-1 (4.4) | | Base-1 (0.94) | PGMEA (560) | CyHO (240) |
| R-50 | P-08 (80) | PAG-1 (4.4) | | Base-1 (0.94) | PGMEA (560) | CyHO (240) |
| R-51 | P-09 (80) | PAG-1 (4.4) | | Base-1 (0.94) | PGMEA (560) | CyHO (240) |
| R-52 | P-10 (80) | PAG-1 (4.4) | | Base-1 (0.94) | PGMEA (560) | CyHO (240) |
| R-53 | P-11 (80) | PAG-1 (4.4) | | Base-1 (0.94) | PGMEA (560) | CyHO (240) |
| R-54 | P-12 (80) | PAG-1 (4.4) | | Base-1 (0.94) | PGMEA (560) | CyHO (240) |
| R-55 | P-13 (80) | PAG-1 (4.4) | | Base-1 (0.94) | PGMEA (560) | CyHO (240) |
| R-56 | P-14 (80) | PAG-1 (4.4) | | Base-1 (0.94) | PGMEA (560) | CyHO (240) |
| R-57 | P-15 (80) | PAG-1 (4.4) | | Base-1 (0.94) | PGMEA (560) | CyHO (240) |
| R-58 | P-16 (80) | PAG-1 (4.4) | | Base-1 (0.94) | PGMEA (560) | CyHO (240) |
| R-59 | P-17 (80) | PAG-1 (4.4) | | Base-1 (0.94) | PGMEA (560) | CyHO (240) |
| R-60 | P-18 (80) | PAG-1 (4.4) | | Base-1 (0.94) | PGMEA (560) | CyHO (240) |
| R-61 | P-19 (80) | PAG-1 (4.4) | | Base-1 (0.94) | PGMEA (560) | CyHO (240) |
| R-62 | P-20 (80) | PAG-1 (4.4) | | Base-1 (0.94) | PGMEA (560) | CyHO (240) |
| R-63 | P-21 (80) | PAG-1 (4.4) | | Base-1 (0.94) | PGMEA (560) | CyHO (240) |
| R-64 | P-22 (80) | PAG-1 (4.4) | | Base-1 (0.94) | PGMEA (560) | CyHO (240) |
| R-65 | P-23 (80) | PAG-1 (4.4) | | Base-1 (0.94) | PGMEA (560) | CyHO (240) |
| R-66 | P-24 (80) | PAG-1 (4.4) | | Base-1 (0.94) | PGMEA (560) | CyHO (240) |
| R-67 | P-25 (80) | PAG-1 (4.4) | | Base-1 (0.94) | PGMEA (560) | CyHO (240) |
| R-68 | P-26 (80) | PAG-1 (4.4) | | Base-1 (0.94) | PGMEA (560) | CyHO (240) |
| R-69 | P-27 (80) | PAG-1 (4.4) | | Base-1 (0.94) | PGMEA (560) | CyHO (240) |
| R-70 | P-28 (80) | PAG-1 (4.4) | | Base-1 (0.94) | PGMEA (560) | CyHO (240) |
| R-71 | P-29 (80) | PAG-1 (4.4) | | Base-1 (0.94) | PGMEA (560) | CyHO (240) |
| R-72 | P-30 (80) | PAG-1 (4.4) | | Base-1 (0.94) | PGMEA (560) | CyHO (240) |
| R-73 | P-31 (80) | PAG-1 (4.4) | | Base-1 (0.94) | PGMEA (560) | CyHO (240) |
| R-74 | P-19 (80) | PAG-1 (4.4) | Acid-0 (1.0) | Base-1 (0.94) | PGMEA (560) | CyHO (240) |
| R-75 | P-19 (80) | PAG-1 (4.4) | Acid-0 (0.5) | Base-1 (0.94) | PGMEA (560) | CyHO (240) |
| R-76 | P-19 (80) | PAG-1 (4.4) | Acid-0 (3.0) | Base-1 (0.94) | PGMEA (560) | CyHO (240) |
| R-77 | P-19 (80) | PAG-1 (4.4) | Acid-0 (5.0) | Base-1 (0.94) | PGMEA (560) | CyHO (240) |

In Tables 1 and 2, the values in parentheses are expressed in parts by weight. The abbreviations for photoacid generator, acidic compound, base, and solvent have the following meaning.
PAG-1: triphenylsulfonium nonafluorobutanesulfonate
PAG-2: 4-t-butoxyphenyldiphenylsulfonium nonafluorobutanesulfonate
PAG-3: triphenylsulfonium 1,1,3,3,3-pentafluoro-2-cyclohexylcarboxypropanesulfonate
Acid-O: CH₃OCH₂CH₂OCH₂COOH (molecular weight 134)
Acid-1: CH₃O(CH₂CH₂O)₂CH₂COOH (molecular weight 178)
Acid-2: CH₃O(CH₂CH₂O)₃CH₂COOH (molecular weight 222)
Acid-3: CH₃(CH₂)₁₆COOH (molecular weight 284)
Base-1: tri(2-methoxymethoxyethyl)amine
Base-2: 2-(2-methoxyethoxymethoxy)ethylmorpholine
Base-3: N-(2-acetoxyethyl)benzimidazole
PGMEA: 1-methoxyisopropyl acetate
CyHO: cyclohexanone

The resins designated by abbreviations are the polymers having the formulation shown in Tables 3 to 6. Mw is a weight average molecular weight as measured by GPC using polystyrene standards.

TABLE 3

| | Unit 1 | Unit 2 | Unit 3 | Unit 4 | |
|---|---|---|---|---|---|
| | (ratio | (ratio | (ratio | (ratio | |
| Resin | incorporated) | incorporated) | incorporated) | incorporated) | Mw |
| P-01 | A-2M (0.30) | B-1M (0.25) | B-2M (0.45) | | 7,200 |
| P-02 | A-2M (0.40) | B-1M (0.25) | B-2M (0.35) | | 7,600 |
| P-03 | A-3M (0.30) | B-1M (0.25) | B-2M (0.45) | | 6,500 |
| P-04 | A-1M (0.30) | B-1M (0.25) | B-2M (0.45) | | 7,800 |
| P-05 | A-4M (0.30) | B-1M (0.25) | B-2M (0.45) | | 7,500 |
| P-06 | A-5M (0.30) | B-1M (0.25) | B-2M (0.45) | | 6,600 |
| P-07 | A-6M (0.30) | B-1M (0.25) | B-2M (0.45) | | 6,800 |
| P-08 | A-7M (0.30) | B-1M (0.25) | B-2M (0.45) | | 6,300 |
| P-09 | A-7M (0.40) | B-1M (0.25) | B-2M (0.35) | | 6,200 |
| P-10 | A-8M (0.30) | B-1M (0.25) | B-2M (0.45) | | 6,500 |
| P-11 | A-2M (0.10) | A-1M (0.25) | B-1M (0.25) | B-2M (0.40) | 7,700 |
| P-12 | A-5M (0.10) | A-1M (0.25) | B-1M (0.25) | B-2M (0.40) | 6,400 |
| P-13 | A-6M (0.10) | A-1M (0.25) | B-1M (0.25) | B-2M (0.40) | 6,200 |
| P-14 | A-1M (0.30) | B-1M (0.25) | B-3M (0.45) | | 7,700 |
| P-15 | A-1M (0.30) | B-1M (0.25) | B-4M (0.45) | | 7,800 |
| P-16 | A-1M (0.30) | B-1M (0.25) | B-5M (0.45) | | 7,500 |
| P-17 | A-1M (0.25) | B-1M (0.25) | B-2M (0.40) | B-6M (0.10) | 6,000 |
| P-18 | A-3M (0.25) | B-1M (0.25) | B-2M (0.40) | B-6M (0.10) | 6,100 |
| P-19 | A-5M (0.30) | B-1M (0.25) | B-2M (0.35) | B-6M (0.10) | 6,300 |
| P-20 | A-1M (0.25) | B-1M (0.25) | B-2M (0.40) | F-1M (0.10) | 6,500 |
| P-21 | A-5M (0.30) | B-1M (0.25) | B-2M (0.35) | F-1M (0.10) | 6,200 |
| P-22 | A-1M (0.25) | B-1M (0.25) | B-2M (0.40) | F-2M (0.10) | 6,400 |
| P-23 | A-3M (0.25) | B-1M (0.25) | B-2M (0.40) | F-2M (0.10) | 6,000 |
| P-24 | A-6M (0.25) | B-1M (0.25) | B-2M (0.40) | F-2M (0.10) | 6,300 |
| P-25 | A-1M (0.25) | B-1M (0.25) | B-2M (0.40) | F-3M (0.10) | 6,500 |
| P-26 | A-1M (0.25) | B-1M (0.25) | B-2M (0.40) | F-4M (0.10) | 6,200 |
| P-27 | A-2M (0.30) | B-1A (0.25) | B-2M (0.45) | | 7,200 |
| P-28 | A-2M (0.30) | B-1M (0.25) | B-2A (0.45) | | 6,900 |
| P-29 | A-1M (0.30) | B-2M (0.40) | F-2M (0.30) | | 6,800 |
| P-30 | A-1M (0.30) | B-2M (0.40) | F-1M (0.30) | | 6,600 |
| P-31 | A-1M (0.30) | B-5M (0.30) | B-2M (0.40) | | 7,000 |

TABLE 4

| | | | |
|---|---|---|---|
| A-1M (R = CH₃) | A-2M (R = CH₃) | A-3M (R = CH₃) | A-4M (R = CH₃) |
| A-1A (R = H) | A-2A (R = H) | A-3A (R = H) | A-4A (R = H) |
| 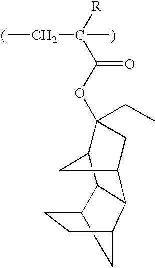 | 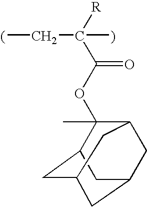 | 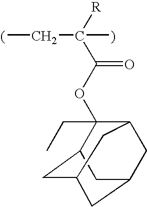 | 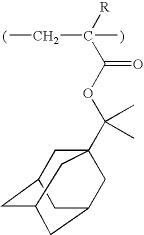 |
| A-5M (R = CH₃) | A-6M (R = CH₃) | A-7M (R = CH₃) | A-8M (R = CH₃) |
| A-5A (R = H) | A-6A (R = H) | A-7A (R = H) | A-8A (R = H) |
| 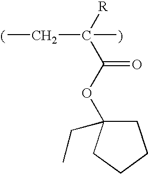 | 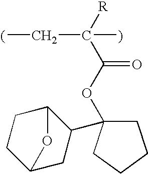 | 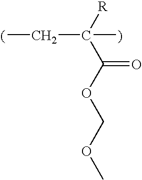 | 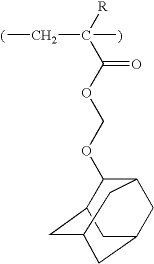 |

TABLE 5

| | | |
|---|---|---|
| B-1M (R = CH₃) | B-2M (R = CH₃) | B-3M (R = CH₃) |
| B-1A (R = H) | B-2A (R = H) | B-3A (R = H) |
| 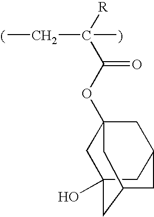 | 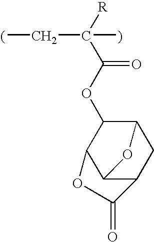 | 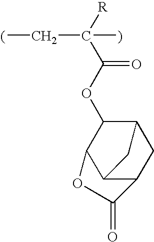 |
| B-4M (R = CH₃) | B-5M (R = CH₃) | B-6M (R = CH₃) |
| B-4A (R = H) | B-5A (R = H) | B-6A (R = H) |
| 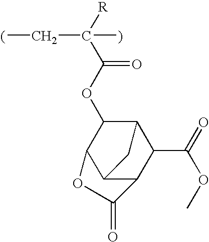 | 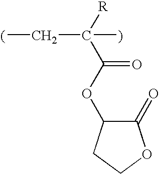 | 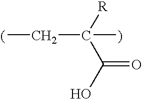 |

TABLE 6

| | | | |
|---|---|---|---|
| F-1M (R = CH₃) | F-2M (R = CH₃) | F-3M (R = CH₃) | F-4M (R = CH₃) |
| F-1A (R = H) | F-2A (R = H) | F-3A (R = H) | F-4A (R = H) |
| 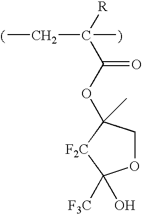 | 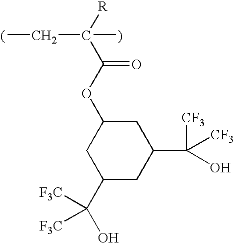 | 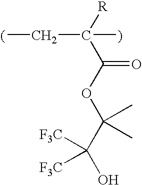 | 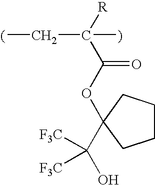 |

### [Evaluation of Defects on Substrate]

### Examples 2-1 to 2-42 and Comparative Examples 2-1 to 2-35

A resist solution (selected from inventive resist compositions R-01 to 42 and comparative resist compositions R-43 to 77) was spin coated onto an antireflective coating (AZ Electronic Materials, 1C5D, 44 nm) on a silicon wafer and baked at 110° C. for 60 seconds to form a resist film of 200 nm thick. The resist film was exposed in an exposure dose of 30 mJ/cm² using an ArF excimer laser stepper (Nikon Corporation; NA 0.68), then baked (PEB) for 60 seconds, and puddle developed with an aqueous solution of 2.38 wt % tetramethylammonium hydroxide for 30 seconds, thereby forming a pattern on the wafer. The pattern consisted of alternately arranged rectangular empty regions and remaining regions of 2.5 cm×3.3 cm. The PEB step was at an optimum temperature for a particular resist composition. The pattern-bearing wafer was observed under a flaw detector WIN-WIN50 1200L (Tokyo Seimitsu Co., Ltd.), counting the number of residues on the substrate.

The test results (number of defects on substrate) of the inventive resist compositions are shown in Table 7, and the results of the comparative compositions shown in Table 8.

TABLE 7

| | | PEB | Number of |
|---|---|---|---|
| Example | Resist | temperature | defects on substrate |
| 2-01 | R-01 | 125° C. | 0 |
| 2-02 | R-02 | 125° C. | 1 |
| 2-03 | R-03 | 115° C. | 1 |
| 2-04 | R-04 | 110° C. | 0 |
| 2-05 | R-05 | 120° C. | 1 |
| 2-06 | R-06 | 110° C. | 4 |
| 2-07 | R-07 | 110° C. | 5 |
| 2-08 | R-08 | 115° C. | 5 |
| 2-09 | R-09 | 115° C. | 4 |
| 2-10 | R-10 | 120° C. | 1 |
| 2-11 | R-11 | 110° C. | 1 |
| 2-12 | R-12 | 110° C. | 2 |
| 2-13 | R-13 | 110° C. | 2 |
| 2-14 | R-14 | 110° C. | 0 |
| 2-15 | R-15 | 110° C. | 0 |
| 2-16 | R-16 | 110° C. | 1 |
| 2-17 | R-17 | 110° C. | 8 |
| 2-18 | R-18 | 110° C. | 9 |
| 2-19 | R-19 | 105° C. | 49 |
| 2-20 | R-20 | 110° C. | 18 |
| 2-21 | R-21 | 105° C. | 44 |
| 2-22 | R-22 | 110° C. | 20 |
| 2-23 | R-23 | 110° C. | 19 |
| 2-24 | R-24 | 110° C. | 41 |
| 2-25 | R-25 | 110° C. | 20 |
| 2-26 | R-26 | 110° C. | 11 |
| 2-27 | R-27 | 120° C. | 1 |
| 2-28 | R-28 | 120° C. | 1 |
| 2-29 | R-29 | 90° C. | 10 |
| 2-30 | R-30 | 90° C. | 11 |
| 2-31 | R-31 | 90° C. | 1 |
| 2-32 | R-32 | 110° C. | 10 |
| 2-33 | R-33 | 110° C. | 7 |
| 2-34 | R-34 | 110° C. | 9 |
| 2-35 | R-35 | 110° C. | 8 |
| 2-36 | R-36 | 110° C. | 9 |
| 2-37 | R-37 | 110° C. | 7 |
| 2-38 | R-38 | 105° C. | 37 |
| 2-39 | R-39 | 105° C. | 35 |
| 2-40 | R-40 | 105° C. | 55 |
| 2-41 | R-41 | 105° C. | 41 |
| 2-42 | R-42 | 105° C. | 42 |

TABLE 8

| Comparative | | PEB | Number of |
|---|---|---|---|
| Example | Resist | temperature | defects on substrate |
| 2-01 | R-43 | 125° C. | 198 |
| 2-02 | R-44 | 125° C. | 212 |
| 2-03 | R-45 | 115° C. | 203 |
| 2-04 | R-46 | 110° C. | 188 |
| 2-05 | R-47 | 120° C. | 224 |
| 2-06 | R-48 | 110° C. | 988 |
| 2-07 | R-49 | 110° C. | 1021 |
| 2-08 | R-50 | 115° C. | 1078 |
| 2-09 | R-51 | 115° C. | 879 |
| 2-10 | R-52 | 120° C. | 375 |
| 2-11 | R-53 | 110° C. | 289 |
| 2-12 | R-54 | 110° C. | 477 |
| 2-13 | R-55 | 110° C. | 512 |
| 2-14 | R-56 | 110° C. | 178 |
| 2-15 | R-57 | 110° C. | 165 |
| 2-16 | R-58 | 110° C. | 279 |
| 2-17 | R-59 | 110° C. | 1750 |
| 2-18 | R-60 | 110° C. | 1803 |
| 2-19 | R-61 | 105° C. | >10,000 |
| 2-20 | R-62 | 110° C. | 3755 |
| 2-21 | R-63 | 105° C. | >10,000 |
| 2-22 | R-64 | 110° C. | 4021 |
| 2-23 | R-65 | 110° C. | 3957 |
| 2-24 | R-66 | 110° C. | >10,000 |
| 2-25 | R-67 | 110° C. | 4122 |
| 2-26 | R-68 | 110° C. | 2324 |
| 2-27 | R-69 | 120° C. | 267 |
| 2-28 | R-70 | 120° C. | 313 |
| 2-29 | R-71 | 90° C. | 2099 |
| 2-30 | R-72 | 90° C. | 2354 |
| 2-31 | R-73 | 90° C. | 242 |
| 2-32 | R-74 | 105° C. | >10,000 |
| 2-33 | R-75 | 105° C. | >10,000 |
| 2-34 | R-76 | 105° C. | >10,000 |
| 2-35 | R-77 | 105° C. | >10,000 |

As seen from the data of Tables 7 and 8, the inventive resist compositions produce minimal defects on the substrate.

### [Evaluation of Resolution]

### Examples 3-1 to 3-42

A resist solution (selected from inventive resist compositions R-01 to 42) was spin coated onto an antireflective coating (Nissan Chemical Industries Ltd., ARC29A, 78 nm) on a silicon wafer and baked at 110° C. for 60 seconds to form a resist film of 170 nm thick. The resist film was exposed using an ArF excimer laser stepper (Nikon Corporation; NA 0.68), then baked (PEB) for 60 seconds, and puddle developed with an aqueous solution of 2.38 wt % tetramethylammonium hydroxide for 30 seconds, thereby forming a 1:1 line-and-space pattern. The PEB step was at an optimum temperature for a particular resist composition. The pattern-bearing wafer was observed under a top-down scanning electron microscope (SEM). The optimal exposure (Eop, mJ/cm²) was defined as the exposure dose which provided a 1:1 resolution at the top and bottom of a 0.11-μm line-and-space pattern. The maximum resolution of the resist was defined as the minimum line width (in increments of 0.01 μm) of the lines and spaces that separated at the optimum exposure, with smaller values indicating better resolution.

The evaluation results (maximum resolution) of the resist compositions are shown in Table 9.

TABLE 9

| | | | | Maximum | Pattern |
|---|---|---|---|---|---|
| Example | Resist | PEB temp. | Eop | resolution | profile |
| 3-01 | R-01 | 125° C. | 42.0 mJ/cm² | 0.09 μm | rectangular |
| 3-02 | R-02 | 125° C. | 39.0 mJ/cm² | 0.09 μm | rectangular |
| 3-03 | R-03 | 115° C. | 41.0 mJ/cm² | 0.09 μm | rectangular |
| 3-04 | R-04 | 110° C. | 42.0 mJ/cm² | 0.09 μm | rectangular |
| 3-05 | R-05 | 120° C. | 44.0 mJ/cm² | 0.09 μm | rectangular |
| 3-06 | R-06 | 110° C. | 45.0 mJ/cm² | 0.09 μm | rectangular |
| 3-07 | R-07 | 110° C. | 45.0 mJ/cm² | 0.10 μm | rectangular |
| 3-08 | R-08 | 115° C. | 42.0 mJ/cm² | 0.09 μm | rectangular |
| 3-09 | R-09 | 115° C. | 39.0 mJ/cm² | 0.09 μm | rectangular |
| 3-10 | R-10 | 120° C. | 43.0 mJ/cm² | 0.09 μm | rectangular |
| 3-11 | R-11 | 110° C. | 40.0 mJ/cm² | 0.09 μm | rectangular |
| 3-12 | R-12 | 110° C. | 38.0 mJ/cm² | 0.09 μm | rectangular |
| 3-13 | R-13 | 110° C. | 44.0 mJ/cm² | 0.09 μm | rectangular |
| 3-14 | R-14 | 110° C. | 41.0 mJ/cm² | 0.09 μm | rectangular |
| 3-15 | R-15 | 110° C. | 42.0 mJ/cm² | 0.09 μm | rectangular |
| 3-16 | R-16 | 110° C. | 37.0 mJ/cm² | 0.10 μm | rectangular |
| 3-17 | R-17 | 110° C. | 45.0 mJ/cm² | 0.09 μm | rectangular |
| 3-18 | R-18 | 110° C. | 44.0 mJ/cm² | 0.09 μm | rectangular |
| 3-19 | R-19 | 105° C. | 40.0 mJ/cm² | 0.09 μm | rectangular |
| 3-20 | R-20 | 110° C. | 42.0 mJ/cm² | 0.09 μm | rectangular |
| 3-21 | R-21 | 105° C. | 40.0 mJ/cm² | 0.09 μm | rectangular |
| 3-22 | R-22 | 110° C. | 41.0 mJ/cm² | 0.09 μm | rectangular |
| 3-23 | R-23 | 110° C. | 44.0 mJ/cm² | 0.09 μm | rectangular |
| 3-24 | R-24 | 110° C. | 43.0 mJ/cm² | 0.09 μm | rectangular |
| 3-25 | R-25 | 110° C. | 40.0 mJ/cm² | 0.09 μm | rectangular |
| 3-26 | R-26 | 110° C. | 42.0 mJ/cm² | 0.09 μm | rectangular |
| 3-27 | R-27 | 120° C. | 38.0 mJ/cm² | 0.09 μm | rectangular |
| 3-28 | R-28 | 120° C. | 35.0 mJ/cm² | 0.10 μm | rectangular |
| 3-29 | R-29 | 90° C. | 36.0 mJ/cm² | 0.09 μm | rectangular |
| 3-30 | R-30 | 90° C. | 35.0 mJ/cm² | 0.10 μm | rectangular |
| 3-31 | R-31 | 90° C. | 38.0 mJ/cm² | 0.09 μm | rectangular |
| 3-32 | R-32 | 110° C. | 46.0 mJ/cm² | 0.09 μm | rectangular |
| 3-33 | R-33 | 110° C. | 47.0 mJ/cm² | 0.09 μm | rectangular |
| 3-34 | R-34 | 110° C. | 45.0 mJ/cm² | 0.09 μm | rectangular |
| 3-35 | R-35 | 110° C. | 45.0 mJ/cm² | 0.09 μm | rectangular |
| 3-36 | R-36 | 110° C. | 44.0 mJ/cm² | 0.09 μm | rectangular |
| 3-37 | R-37 | 110° C. | 42.0 mJ/cm² | 0.09 μm | rectangular |
| 3-38 | R-38 | 105° C. | 40.0 mJ/cm² | 0.09 μm | rectangular |
| 3-39 | R-39 | 105° C. | 39.0 mJ/cm² | 0.09 μm | rectangular |
| 3-40 | R-40 | 105° C. | 40.0 mJ/cm² | 0.09 μm | rectangular |
| 3-41 | R-41 | 105° C. | 39.0 mJ/cm² | 0.09 μm | somewhat |
| | | | | | rounded |
| | | | | | top |
| 3-42 | R-42 | 105° C. | 38.0 mJ/cm² | 0.09 μm | somewhat |
| | | | | | rounded |
| | | | | | top |

The data of Table 9 demonstrate that the resist compositions within the scope of the invention have a high resolution.

Japanese Patent Application No. 2006-103336 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A positive resist composition comprising
(A) a resin component having a solubility in an alkaline developer that increases under the action of an acid,
(B) a compound capable of generating an acid in response to actinic light or radiation, and
(C) at least one acidic organic compound having a molecular weight of at least 150.

2. The positive resist composition of claim 1, wherein said acidic organic compound (C) has the general formula (1):
R¹—X (1)
wherein R¹ is a straight or branched monovalent organic group which is free of double bonds and atoms other than carbon, hydrogen and oxygen in its structure, and X is —SO₃H or —CO₂H.

3. The positive resist composition of claim 1, wherein said acidic organic compound (C) has the general formula (2):
CH₃(A)ₙCH₂—X (2)
wherein A is a methylene group, some of the number “n” of methylene groups may be replaced by oxygen atoms, with the proviso that when some methylene groups are replaced by oxygen atoms, a structure in which two oxygen atoms adjoin is excluded, n is an integer from 3 to 100, and X is —SO₃H or —CO₂H.

4. The positive resist composition of claim 1, wherein the resin component (A) comprises acidic recurring units.

5. A process for forming a pattern, comprising the steps of applying the positive resist composition of claim 1 onto a substrate to form a resist coating; heat treating the resist coating and exposing it to high-energy radiation or electron beam through a photomask; and heat treating the exposed coating and developing it with a developer;
the exposing step being effected by the immersion lithography wherein a high refractive index liquid having a refractive index of at least 1.0 intervenes between the resist coating and a projection lens.

6. A process for forming a pattern, comprising the steps of applying the positive resist composition of claim 1 onto a substrate to form a resist coating; heat treating the resist coating and exposing it to high-energy radiation or electron beam through a photomask; and heat treating the exposed coating and developing it with a developer;
said process further comprising the step of coating a protective film on the resist coating,
the exposing step being effected by the immersion lithography wherein a high refractive index liquid having a refractive index of at least 1.0 intervenes between the protective film and a projection lens.
